(19) United States
(12) Patent Application Publication
(10) Pub. No.: US 2004/0111293 A1
(43) Pub. Date: Jun. 10, 2004

(54) System and a method for tracking patients undergoing treatment and/or therapy for renal disease

(76) Inventors: Catherine Firanek, Villa Park, IL (US); Salim Mujais, Northbrook, IL (US); Steven Antkowiak, Lake Zurich, IL (US); Ed Grohe, Largo, FL (US); Curtis Wiggins, Brandon, FL (US); Mark Hayward, Safety Harbor, FL (US); Larry McNally, Mundelein, IL (US); Rich DeLaCruz, Largo, FL (US); William Thomas, Safety Harbor, FL (US); Jennifer Anderson, Kenilworth, IL (US); Tom Schuh, Wheaton, IL (US); Kevin McCulloch, Wilmette, IL (US)

Correspondence Address: PATENTS+TMS, A Professional Corporation, 1914 North Milwaukee Avenue, Chicago, IL, 60647, US

(21) Appl. No.: 10/315,435

(22) Filed: Dec. 9, 2002

(51) Int. Cl. G06F 17/60

(52) U.S. Cl. 705/2

(57) ABSTRACT

A system and a method for tracking patients having renal disease, particularly Chronic Kidney Disease (CKD), are provided. The system and method track patients through a common system with multiple healthcare professionals, such as doctors, nurses and the like, having access to the system and updating the system based on information regarding the care, treatment, diagnosis, therapy, or the like provided to the patients. The system and method interface with remote machines and supply chains by a modem, via the internet or by wireless devices. The system and method provide a continuum of care for renal patients, i.e., CKD, peritoneal dialysis (PD), home hemodialyis (HHD), in-center hemodialysis and transplant within a single database associated with the system.

### BACKGROUND OF THE INVENTION

The present invention generally relates to a system and method for tracking a patient. More specifically, the present invention relates to a system and a method for tracking patients throughout their therapy lifetime. Specifically, the system and the method of the present invention is particularly applicable for patients whose care and/or treatment may vary in location or types of treatment which may result from the changing conditions of the patient. More specifically, the present invention relates to a system and method for tracking patient history for renal patients from the initial diagnosis of the patient of chronic kidney disease (CKD) through a therapy lifetime of a patient, i.e. CKD, peritoneal dialysis (PD), hemodialysis (HD) and/or transplant.

It is, of course, generally known to track the history of a patient treated for a specific disease, ailment, condition, therapy, or the like. Usually, information regarding the patient is recorded by a healthcare professional, such as, a doctor, a nurse, or the like. Typically, paper or a chart is used for the doctor or nurse to input information regarding the patient during treatment and/or therapy. More recently, computers are implemented to record and to store information regarding a patient. The information may be input during a patient's visit or subsequently by office personnel, for example.

Typically, in the case of a patient suffering from renal disease, often the various therapies required by the patient throughout the lifetime of the patient are separately tracked but not otherwise combined. Often, information from previous therapies are necessary to completely ascertain and/or to accurately evaluate the patient, the history of therapy to the patient and to diagnose and/or advise further treatment or the like for the patient. To do this, information recorded on paper or the separate software systems must be entered into other databases or other software tools and/or re-entered by viewing the appropriate history of interest of a particular patient. Further consideration in the treatment or therapy which the patient is seeking through an appropriate physician, facility, or other healthcare technician, professional, or the like may then be necessary.

Currently, a patient may be assigned to a nephrologist or physician to obtain a specific treatment or therapy as that treatment or therapy relates to the condition of the patient. To assign a new physician to a patient currently requires manual re-assignment of the patient and/or the records associated with that patient to the extent that any records have been previously recorded and/or exist. The new physician, therefore, has no access to any treatment history in electronic format and that information must be printed and entered manually by the new physician. Moreover, often various codes are created for a particular therapy for a given patient. As a result, the physician or other healthcare professional must manually enter data which may not be easily updated if a new set of codes had been created.

More and more, various therapies are conducted by a patient in the home of the patient. However, limitations exist regarding the types of therapy and the extent of particular therapies that may be administered to the patient at home. These limitations are often due to the inability to collect information regarding the patient and the machine that may be administering therapy to the patient as well as limitations that may be communicated to/from a dialysis center, for example, to the patient within the home. Moreover, certain patients may receive therapy at the home and subsequent therapy at another location due to changes in condition of the patient. However, as set forth above, the information regarding the therapy is not often readily available or transferable with the patient. As a result, necessary information regarding the particular stage or condition of the patient and/or the therapy of the patient is often misunderstood or inadequately assessed.

Still further, physicians often lack the understanding necessary to treat a patient. As a result, patients are not identified, characterized or channeled into care pathways by the physician due to a lack of necessary understanding of the patient by the physician to effectively and/or accurately direct the same. Chronic Kidney Disease (CKD) care pathways are not generally accurately tracked or evaluated particularly with respect to renal disease, hypertension, anemia, CKD education, dialysis initiation, lipid disorders, diabetes mellitus, morbidities planning, and the like. Moreover, software that provides a unified clinical and encounter summary screen is not available which often results in a failure to provide tracking of a continuum of care for renal patients within a single database.

Current existing renal-related clinical software used, for example, at dialysis centers by dialysis providers, are not simple to use, are not flexible in their reporting capabilities and are not integratable with other renal-related clinical software. As a result, use of existing software to treat dialysis patients fails to provide continuity of care and data capture relating to patient and/or the therapy of the patient. Moreover, data that is captured is not standardized making the captured data difficult to interpret and/or transferable to other healthcare providers. Non-standardized data results in inefficient data retrieval and often excess or unnecessary data that may be input or otherwise targeted. Further, the organization of the care of the patient is, therefore, sacrificed due to an inability to track consistent information regarding patient care and therapies undergone by the patient.

A need, therefore, exists for an improved integrated tool to manage patients. More specifically, a need, exists for a system and a method for managing renal patients from CKD through PD, HD to transplant throughout the different points of clinical encounter experienced by the patient.

### SUMMARY OF THE INVENTION

The present invention provides a system and a method for treating, tracking and/or evaluating a patient. More specifically, the present invention relates to a system and a method for electronically tracking the treatment or therapy associated with a patient, particularly a patient undergoing renal therapy and providing care pathways for Chronic Kidney Disease (CKD), PD, HD and transplant.

To this end, in an embodiment of the present invention, a method is provided for a user to integrally track a history of a patient undergoing therapy for a disease wherein the disease has a plurality of stages and a plurality of therapies to treat the disease throughout the plurality of stages. The method has the steps of: inputting information into a system regarding the patient; and inputting information into the system regarding each of the plurality of therapies during each of the plurality of stages for the patient wherein the information is displayed on a plurality of display screens associated with the system.

In an embodiment, the method further has the step of establishing a care team for the patient wherein the care team is associated with the patient throughout each of the plurality of stages.

In an embodiment, the disease is renal disease.

In an embodiment, the plurality of stages and the plurality of therapies correspond to at least one of chronic kidney disease, peritoneal dialysis, hemodialysis and transplant.

In an embodiment, the method further has the step of remotely receiving the information regarding the patient.

In an embodiment, the method further has the step of manipulating data on the plurality of display screens.

In an embodiment, the method further has the step of automatically importing data from one of the plurality screens to another one of the plurality of display screens without manual entry to the other one of the plurality of display screens.

In an embodiment, the method further has the step of defining a care pathway for the patient based on the information in the system.

In an embodiment, the method further has the step of identifying medications for the required patient.

In an embodiment, the method further has the step of identifying a history of medications of the patient.

In an embodiment, the method further has the step of linking the system to a supply chain.

In an embodiment, the method further has the step of linking the system to a prescription fulfillment center.

In an embodiment, the method further has the step of linking the system to a laboratory wherein information from the laboratory is automatically imported to any one of the plurality of screens where the information is required.

In an embodiment, the method further has the step of defining information regarding the plurality of stages and the plurality of therapies.

In an embodiment, the method further has the step of inputting information regarding a center at which the patient receives therapy regarding the disease.

In an embodiment, the method further has the step of identifying patient compliance with the plurality of therapies.

In an embodiment, the method further has the step of automatically generating a report regarding the patient with the plurality of therapies.

In an embodiment, the method further has the step of transferring the patient from a first medical professional to a second medical professional within the system where the history of the patient remains with the system for access by the second medical professional.

In an embodiment, the method further has the step of: receiving information into the system via wireless data transfer. The information includes clinical history of an event related to one of the plurality of stages of the disease.

In an embodiment, the method further has the step of providing educational tracking to the patient through the system.

In an embodiment, the method further has the step of standardizing a prescription with a template using a medication dictionary associated with the system.

In an embodiment, the method further has the step of providing sorting capabilities with the information on the plurality of display screens.

In an embodiment, the method further has the step of providing filtering capabilities with the information on the plurality of display screens.

In an embodiment, the method further has the step of providing searching capabilities for the information associated with the plurality of display screens in the system.

In an embodiment, the method further has the step of providing manipulating capabilities to move information on the display screen.

In an embodiment, the method further has the step of providing reporting capabilities to hide information on the display screens.

In an embodiment, the method further has the step of transferring information to the system via the internet.

In an embodiment, the method further has the step of encrypting the information prior to transferring the information via the internet.

In an embodiment, the method further has the step of transferring information to the system via a modem connection.

In an embodiment, the method further has the step of remotely monitoring the patient in real-time.

In an embodiment, the method further has the step of creating a prescription for the patient based on the therapy.

In an embodiment, the method further has the step of selecting a therapy mode, a fill mode and an ordering physician for the patient to effect ordering of a prescription.

In an embodiment, the method further has the step of importing information regarding a previous prescription before entry of a subsequent prescription.

In an embodiment, the method further has the step of remotely receiving prescription information for the patient.

In an embodiment, the method further has the step of remotely authorizing a prescription for the patient.

In an embodiment, the method further has the step of digitally executing authorization for a prescription to the patient.

In an embodiment, the method further has the step of remotely transferring a digitally authorized signature to a supply chain to effect a prescription for the patient.

In an embodiment, the method further has the step of receiving an order for a prescription via the internet wherein the prescription is authorized by a digital signature.

In an embodiment, the method further has the step of retrieving information via the internet regarding the patient and/or the medical professional at the supply chain.

In an embodiment, the method further has the step of enrolling the patient at a supply chain to provide an interface between the patient and the supply chain regarding a prescription.

In an embodiment, the method further has the step of defining care pathways for the patient wherein the care pathways relate to the stage of the disease. The care pathways may be presented on a screen related to each of the care pathways wherein information from other screens is automatically imported to the screens appropriate to each of the care pathways. Information in the care pathways includes lab values, medications and education as related to a specific care pathway.

In an embodiment, the method further has the step of automatically generating a list of items requiring completion after entry of information into the system.

In an embodiment, the method further has the step of automatically generating a list of items requiring completion during entry of information into the system.

In an embodiment, the method further has the step of identifying a list of items particular to the patient requiring the user to advise the patient.

In an embodiment, the method further has the step of identifying a list of items particular to the patient requiring the user to educate the patient based on the stage of the disease.

In an embodiment, the method further has the step of generating an encounter summary of the patient based on the information entered for a specific date.

In an embodiment, the method further has the step of generating an encounter summary of the patient based on information obtained at a patient visit.

In an embodiment, the method further has the step of generating an encounter summary that is input into the system and automatically into the system in any of the other screens that require information related to information in the encounter summary.

In an embodiment, the method further has the step of generating a renal disease pathway that includes information imported from the system which relates to renal disease.

In an embodiment, the method further has the step of providing a hyperlink associated with the renal disease pathway.

In an embodiment, the method further has the step of remotely receiving information to the renal disease pathway.

In an embodiment, the method further has the step of generating a diabetes mellitus pathway that includes information imported from the system which relates to diagnosis and/or treatment of diabetes mellitus.

In an embodiment, the method further has the step of entering information into the diabetes mellitus pathway relating to at least one of glucose monitoring, exercise, diet and foot care.

In an embodiment, the method further has the step of generating a mineral metabolism pathway that includes information imported from the system which relates to diagnosis and/or treatment of bone disease.

In an embodiment, the method further has the step of remotely receiving lab data including at least one of calcium level, phosphorus level and parathyroid level.

In an embodiment, the method further has the step of tracking education of the patient in the system wherein information is imported from system to an education screen as the education relates to any of the plurality of stages of the diseases and/or the plurality of therapies. The education includes information related to at least one of time spent, type of session, location, participants and material distribution. The education provides tracking of at least one of pre-learning assessment and post-learning assessment.

In an embodiment, the method further has the step of tailoring education based on an educational assessment input into the system. The educational assessment requires input of at least one of grade level of the patient, disease state, interests of the patient and physical deficiencies of the patient. The educational assessment requires input of at least one of hobbies, interests, social and religious information about the patient.

In an embodiment, the method further has the step of evaluating eligibility of the patient for one of the plurality of therapies.

In an embodiment, the method further has the step of providing a display screen to assist the user regarding modality eligibility of the patient. The plurality of therapies include peritoneal dialysis, hemodialysis and transplantation.

In an embodiment, the method further has the step of evaluating modality eligibility of the patient from at least one of a medical perspective and a psychosocial perspective.

In an embodiment, the method further has the step of monitoring the patient to identify whether the patient is eligible for one of the plurality of therapies.

In an embodiment, the method further has the step of identifying a discrepancy between the therapy for which the patient is eligible and the therapy which the patient is undergoing.

In an embodiment, the method further has the step of automatically identifying a bias after identifying a discrepancy in the therapy of the patient.

In an embodiment, the method further has the step of identifying access of the patient to the therapy.

In an embodiment, the method further has the step of identifying access of the patient based on at least one of the referral date to the surgeon, when the access is placed, and when a follow-up appointment is made.

In an embodiment, the method further has the step of tracking dialysis initiation in the system. The dialysis initiation is based on at least one of the types of access. The dialysis initiation is tracked based on whether the access is inpatient or outpatient.

In an embodiment, the method further has the step of identifying laboratory field pathways from laboratory results imported into screens related to care pathways assignments. The laboratory results are remotely imported into the appropriate laboratory field pathways for a patient.

In an embodiment, the method further has the step of generating a preventative pathway for the patient identifying at least one of vaccinations and clinical screenings of the patient.

In an embodiment, the method further has the step of generating a nutrition pathway for the patient relating to nutritional requirements for the patient as the requirements relate to one of the plurality of therapies.

In an embodiment, the method further has the step of generating a lipid disorder pathway for the patient wherein the lipid disorder pathway includes information related to cholesterol levels of the patient.

In an embodiment, the method further has the step of generating a hypertension pathway for the patient wherein the hypertension pathway includes information related to hypertension characteristics of the patient.

In an embodiment, the method further has the step of generating an anemia pathway with information imported from the system related to diagnosis and/or treatment of anemia.

In an embodiment, the method further has the step of importing information from a laboratory wherein the information includes at least one of hematology, iron studies and medication used to treat anemia.

In an embodiment, the system receives input regarding a plurality of patients.

In an embodiment, the system receives input regarding a plurality of healthcare providers.

In an embodiment, the system receives input regarding a plurality of healthcare centers.

In an embodiment, the method further has the step of transferring the information from the system to an authorized user.

In an embodiment, the method further has the step of providing access to the information from the system by an authorized user.

In an embodiment, the method further has the step of providing remote access to the information from the system.

In an embodiment, the method further has the step of remotely identifying device connectivity for components of the system.

In an embodiment, the method further has the step of standardizing codes between the types of therapies.

In an embodiment, the method further has the step of transferring the patient from the system based on at least one of the type of therapy and the stage of the disease.

In an embodiment, the method further has the step of categorizing the laboratory results to identify routine laboratory tests and comparison of laboratory results.

In another embodiment of the present invention, an integrated system is provided for providing information related to a patient having renal disease wherein the information is accessible by a user and further wherein the information is used to evaluate the patient. The system has input means for receiving the information about the patient and a clinical history of events related to the renal disease of the patient wherein the information is accessible by the user to evaluate the patient. The integrated system also has disease modality means for identifying types of therapy available to the patient for treating the disease.

In an embodiment, the input means receives information about the user.

In an embodiment, the input means receives information about a center that treats the patient.

In an embodiment, information regarding a plurality of patients is input. The information regarding the patient is received from a remote location.

In an embodiment, the system has an output device for displaying a screen with the information. The information may be received via the internet. The information may be encrypted. The information may be transmitted via a wireless device. The information may be transmitted from a machine located remotely from the input means.

In an embodiment, the information on the screen is manipulated to a desired format by the user.

In an embodiment, the system has multiple screens for display on the output device.

In an embodiment, information from the multiple screens is automatically imported.

In an embodiment, the system has an interface receiving the information from the input means to link the information to a supply chain. The supply chain is a prescription fulfillment center.

In an embodiment, the system has a laboratory for transmitting results from a remote location via the interface.

In an embodiment, the types of therapy include at least one of hemodialysis, peritoneal dialysis and transplantation.

In an embodiment, the system has output means having screens unique to each one of a plurality of care pathways wherein the care pathways relate to conditions to evaluate the disease. The plurality of care pathways may include at least one of renal disease, educational assessment, transplant workup, hypertension, CKD education, dialysis initiation, lipid disorders, diabetes mellitus, modality planning, nutrition and mineral metabolism.

In an embodiment, the system has output means having screens to summarize a plurality of events at a clinical encounter. The events include at least one of renal disease history, medications and allergies.

In an embodiment, the system has a medication dictionary associated with the input means to automatically create a medication.

In an embodiment, the system has list generating means to identify incomplete items requiring attention by the user.

In another embodiment of the present invention, a renal disease tracking system is provided for patients undergoing treatment for renal disease and for users administering treatment to the patients. The system has information display means including information relating to the patients and to the users wherein the information is displayed on a plurality of screens. The system also has means for inputting additional information related to the types of treatment for the patients wherein the patients are tracked through stages of care for the renal disease.

In an embodiment, the system has a clinical encounter screen associated with the information display means wherein the clinical encounter screen receives information input by the user about the patient.

In an embodiment, the system has care pathway screens associated with the information display screen wherein the care pathway screens include information about the patients pertaining to chronic kidney disease. The care pathway screens track information related to renal disease, hypertension, anemia, chronic kidney disease education, educational assessments, dialysis initiation, transplants, lipid disorders, diabetes mellitus, nutrition, mineral metabolism, modality planning, or hospitalization.

In an embodiment, the system has an interface for receiving and transmitting information and importing information into the plurality of screens.

In an embodiment, the system has a supply chain connected to the interface.

In an embodiment, the system has a prescription fulfillment means in communication with the interface to electronically receive a prescription order remote from the system.

In an embodiment, the system has laboratory results input through the interface into the system.

In an embodiment, the system has a machine remote from the system that transmits information via the interface to the system.

In an embodiment, the machine is a home hemodialysis machine.

In an embodiment, information is transferred to the system via the interface over the internet.

In an embodiment, information is wirelessly transmitted to the system via the interface.

In an embodiment, the plurality of screens include a screen to effect patient transfer, a screen to effect physician transfer, and/or a screen to define a care team for the patient.

In an embodiment, information from the plurality of screens is automatically imported between the screens without requiring separate entry.

In an embodiment, the plurality of screens include a screen that initiates an automatically generated to-do list.

In an embodiment, the plurality of screens includes an entry screen identifying access to components of the system

In an embodiment, the system has diagnosis codes for import to the screens for each of the stages of care for the renal disease.

In an embodiment, the system has multiple centers providing care to the patients wherein the multiple centers are provided access to the information display means and the means for inputting.

In an embodiment, the users have customized viewing and access rights to the system.

It is, therefore, an advantage of the present invention to provide a system and a method for providing care to a patient.

Another advantage of the present invention is to provide a system and a method for tracking care or therapy to a patient.

And, another advantage of the present invention is to provide a system and a method for determining care pathways for Chronic Kidney Disease.

Yet another advantage of the present invention is to provide a system and a method for accurately summarizing care, treatment and/or therapy provided to a patient.

A still further advantage of the present invention is to provide a system and a method to evaluate and/or to capture PD, HD and transplant eligibility.

Yet another advantage of the present invention is to provide a system and a method for treating a patient implementing a comprehensive integrated software that covers a continuum of care for the renal patient within a single database.

Moreover, an advantage of the present invention is to provide a system and a method for standardizing dosage templates using a medication dictionary to automatically create a medication resulting in reduced time and/or keystrokes necessary to effect creation of the medication and to improve standardization of the same.

Moreover, an advantage of the present invention is to provide a system and a method for sending a description and/or supply order electronically and securely.

A further advantage of the present invention is to provide a system and a method for creating reports regarding a patient where the reports are dynamic and are able to be modified via sorting and row and/or column placement.

A still further advantage of the present invention is to provide a system and a method for identifying a reason for discordance between patient choice and final choice through dialysis modality.

Yet another advantage of the present invention is to provide an integrated access management program for PD and HD patients.

A still further advantage of the present invention is to provide a system and a method for monitoring a patient via the Internet or a modem.

And, another advantage of the present invention is to provide a system and a method that allows customization and access to components of the dialysis software with respect to a patient.

A further advantage of the present invention is to provide a system and a method for transferring a patient from one physician to another physician or other healthcare provider.

Yet another advantage of the present invention is to provide a system and a method for transferring a patient from one database to another database without losing or otherwise requiring separate input of information regarding the patient.

Yet another advantage of the present invention is to provide a system and a method for identifying routine laboratory tests and/or simplified comparison of pre-treatment results and/or post-treatment results.

A still further advantage of the present invention is to provide a system and a method for identifying care givers associated with a particular patient to enhance the assignment of a patient care team.

Moreover, an advantage of the present invention is to provide a system and a method that allows multiple facilities to use one database with different security profiles.

Yet another advantage of the present invention is to provide a system and a method that provides customized viewing and/or access rights for each member of a renal care team.

Additional features and advantages of the present invention are described in, and will be apparent from, the detailed description of the presently preferred embodiments and from the drawings.

### BRIEF DESCRIPTION OF THE DRAWINGS

FIG. 1 illustrates a block diagram of a system in an embodiment of the present invention.

FIG. 2 illustrates a black box diagram associated with treatment of a patient in an embodiment of the present invention.

FIG. 3 illustrates a diagram of modules for tracking and/or monitoring a patient throughout the various stages of renal disease in an embodiment of the present invention.

FIG. 4 illustrates a flowchart for identifying care pathways in an embodiment of the present invention.

FIG. 5 illustrates a flowchart for identifying care pathways in an embodiment of the present invention.

FIG. 6 illustrates a flowchart for identifying care pathways in an embodiment of the present invention.

FIG. 7 illustrates a center and patient demographic screen in an embodiment of the present invention.

FIG. 8 illustrates a screen that prompts input or information regarding a clinical encounter in an embodiment of the present invention.

FIG. 9 illustrates a screen relating to a CKD care pathway in an embodiment of the present invention.

FIG. 10 illustrates a screen relating to a CKD care pathway in an embodiment of the present invention.

FIG. 11 illustrates a block diagram of a method for tracking patient activity in an embodiment of the present invention.

FIG. 12 illustrates a new entry screen in an embodiment of the present invention.

FIG. 13 illustrates a patient re-assignment screen in an embodiment of the present invention.

FIG. 14 illustrates a patient transfer screen in an embodiment of the present invention.

FIG. 15 illustrates a patient transfer screen in an embodiment of the present invention.

FIG. 16 illustrates an information import screen in an embodiment of the present invention.

FIG. 17 illustrates an import and maintenance screen in an embodiment of the present invention.

FIG. 18 illustrates an import and maintenance screen in an embodiment of the present invention.

FIG. 19 illustrates an import and maintenance screen in an embodiment of the present invention.

FIG. 20 illustrates a clinical history screen in an embodiment of the present invention.

FIG. 21 illustrates a patient demographic screen in an embodiment of the present invention.

FIG. 22 illustrates a clinical history screen in an embodiment of the present invention.

FIG. 23 illustrates a medications maintenance screen in an embodiment of the present invention.

FIG. 24 illustrates a screen which prompts a user to add information to a patient file in an embodiment of the present invention.

FIG. 25 illustrates a screen which prompts a user to add information to a patient file in an embodiment of the present invention.

FIG. 26 illustrates a screen which prompts a user to select a font in an embodiment of the present invention.

FIG. 27 illustrates a screen which prompts a user to select a mode related to filling of a prescription in an embodiment of the present invention.

FIG. 28 illustrates a screen which provides therapy parameters in an embodiment of the present invention.

FIG. 29 illustrates a screen which contains nurse information in an embodiment of the present invention.

FIG. 30 illustrates a screen which provides therapy solutions and manual exchanges in an embodiment of the present invention.

FIG. 31 illustrates a screen which enables a user to adjust information within the system in an embodiment of the present invention.

FIG. 32 illustrates a screen which provides prompts and special fields to a user in an embodiment of the present invention.

FIG. 33 illustrates a screen which contains prescription information in an embodiment of the present invention.

FIG. 34 illustrates a screen which contains supply chain information in an embodiment of the present invention.

FIG. 35 illustrates a screen which enables a user to select a mode of therapy in an embodiment of the present invention.

FIG. 36 illustrates a block diagram of supply chain integration in an embodiment of the present invention.

FIG. 37 illustrates user requirement specifications for effecting delivery of prescriptions and prescription information via a supply chain in an embodiment of the present invention.

FIG. 38 illustrates user requirement specifications for effecting delivery of prescriptions and prescription information via a supply chain in an embodiment of the present invention.

FIG. 39 illustrates a block diagram of a method for capturing a clinical encounter in an embodiment of the present invention.

FIG. 40 illustrates a block diagram of a method for monitoring care pathways in an embodiment of the present invention.

FIGS. 41-49 illustrate block diagrams of tracking that occurs through the clinical and care pathways for the dialysis patient in an embodiment of the present invention.

FIG. 50 illustrates a screen that pops up as a reminder regarding specific items that must be completed in a “to-do list” format in an embodiment of the present invention.

FIG. 51 illustrates a screen containing clinical encounter information in an embodiment of the present invention.

FIG. 52 illustrates a screen containing clinical pathway information in an embodiment of the present invention.

FIG. 53 illustrates a screen containing a diabetes mellitus pathway in an embodiment of the present invention.

FIG. 54 illustrates a screen containing a mineral metabolism pathway in an embodiment of the present invention.

FIG. 55 illustrates a screen containing education tracking in an embodiment of the present invention.

FIG. 56 illustrates a screen containing education assessment in an embodiment of the present invention.

FIGS. 57(a) and 57(b) illustrate a screen containing care pathway information for modality eligibility and/or planning in an embodiment of the present invention.

FIGS. 58(a) and 58(b) illustrate a screen relating to modality choice which indicates a caregiver's opinion for which therapy should be chosen for the patient based on eligibility criteria or patient discussion in an embodiment of the present invention.

FIG. 59 illustrates a screen for access planning to note a type of dialysis access chosen in an embodiment of the present invention.

FIGS. 60(a) and 60(b) illustrate dialysis initiation screens which track a type of dialysis access in an embodiment of the present invention.

FIGS. 61(a) through 61(f) illustrate charts defining various care pathway assignments based on various laboratory results in an embodiment of the present invention.

FIG. 62 illustrates a clinical pathway screen relating to preventative measures in an embodiment of the present invention.

FIG. 63 illustrates a nutrition pathway screen in an embodiment of the present invention.

FIG. 64 illustrates a clinical pathway screen for lipid disorders in an embodiment of the present invention.

FIG. 65 illustrates a hypertension pathway screen in an embodiment of the present invention.

FIG. 66 illustrates an anemia pathway screen in an embodiment of the present invention.

### DETAILED DESCRIPTION OF THE PRESENTLY PREFERRED EMBODIMENTS

The present invention relates to a system and a method for providing care and or therapy to a patient. Moreover, the present invention provides a system and a method for tracking care or therapy to a patient, particularly a patient with renal disease. More specifically, the present invention relates to a system and a method for tracking therapies and/or care to a patient throughout the various stages of renal disease, particularly Chronic Kidney Disease (CKD).

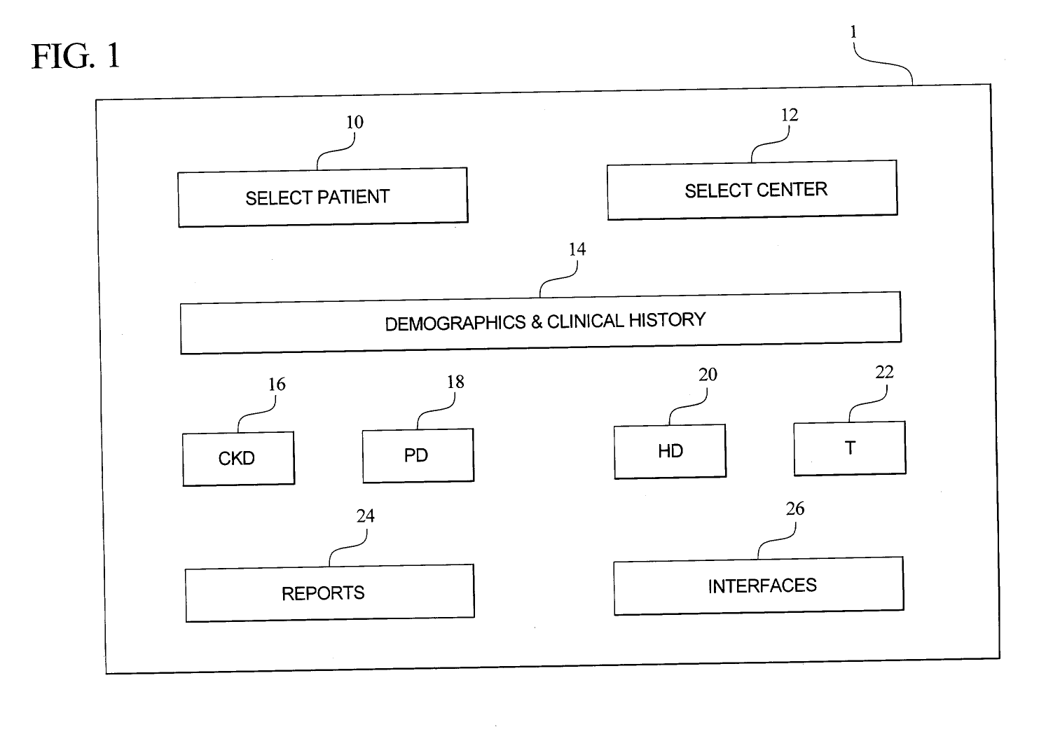

The present invention generally relates to a system 1 that may be integrated such that a patient undergoing therapy has a history that tracks the patient during any stage of that therapy using the system 1. As illustrated in FIG. 1, the system 1 is integrated such that a patient 10 or a group of patients 10 or a center 12, such has a hemodialysis center, are integrated within the system 1. The demographics and clinical history of each of the patients 10 and each of the centers 12 are included within the integrated system 1 such that the patient 10 is tracked throughout any stage of renal disease, particularly chronic kidney dialysis (CKD module)16, peritoneal dialysis (PD module) 18, hemodialysis (HD module) 20, and/or transplant (T module) 22. The integrated system 1 also generates reports 24 and has multiple interfaces 26 with external resources or other processes relevant to the care of the patient 10. Demographics 14a of the patient 10 may be input into the system 1 such that the patient 10 may be identified at least by name, birth date, age, gender and/or other identifiers. The clinical history 14b within the integrated system 1 is capable of tracking history of the patient 10 from the onset of care. The clinical history 14b may include events, descriptions and/or dates. In addition, descriptions and/or dates of the following may be included: co-morbidities, hospitalizations, medications, surgeries and/or labs.

Within the CKD module 16 of the system 1, the status of renal function, related complications, co-morbidities profiling, medications/lab tracking and the like may be identified. Within the PD module 18, access, prescription, complications or infections or other information, patient status, compliance, summary reports as well as other functions and other information may be provided. Within the hemodialysis module 20, similar information, namely, description, complications, infections, catheter information, patient status, compliance, reports and other functions and information may be tracked. Within the transplant module 22, a transplant patient identifier, a history of treatment, as well as medication/lab tracking and/or co-morbidities tracking may be provided. The reports 24 with any portion of the system 1 may include physician, nurse, administrative and/or ad hoc reports. An interface 26 may be provided within the system 1 to link with other clinical systems, laboratories, supply chains, and/or other service requirements.

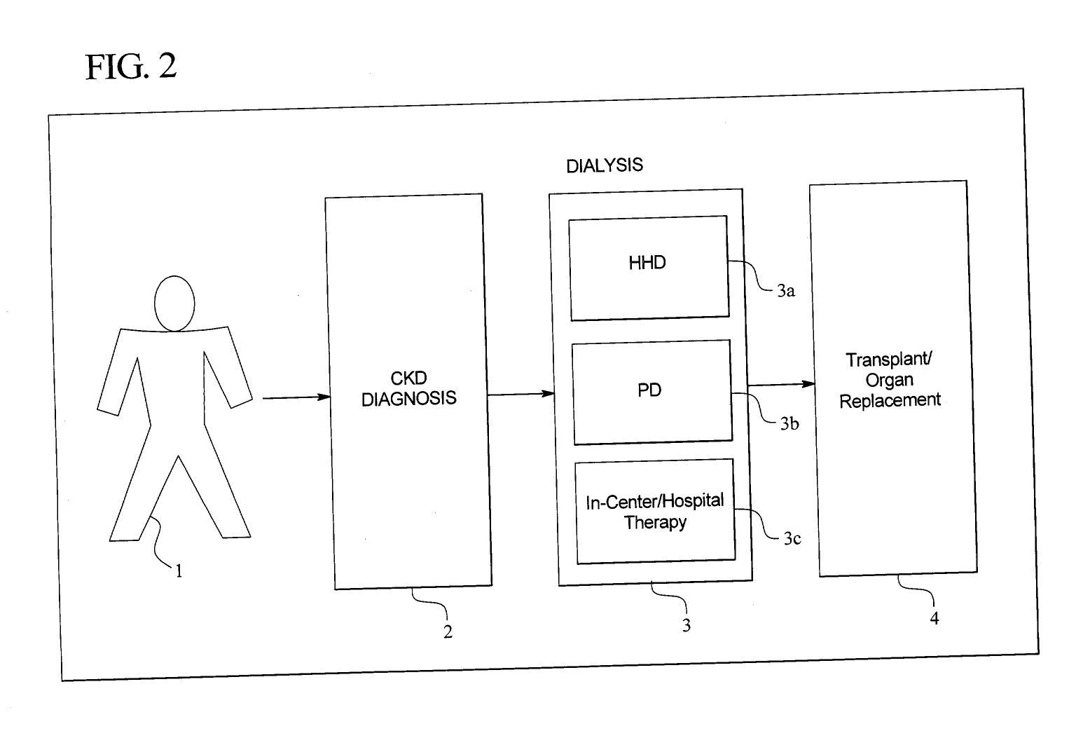

FIG. 2 generally illustrates the cycle of a patient. An at-risk patient 10 may be diagnosed at step 2 as a patient with chronic kidney disease (CKD). Step 3 is a dialysis section wherein the patient undergoes one of home hemodialysis as shown within Step 3 at 3a, peritoneal dialysis (PD) at 3b, or in-center or hospital therapy as shown at 3c. At step 4, some patients may be identified as requiring organ replacement or transplant. As shown in FIG. 2, at the diagnosis step, CKD may be identified, characterized and/or patients may be channeled into care pathways utilizing educational and medical guidelines. To this end, physicians may gain an understanding of the patient and patient adjustment may be enhanced through education. As a result, dialysis may be initiated in a timely manner and/or clinical outcomes may be improved.

If PD is suggested and/or required for the patient, a link is provided resulting in continuity of care for the patient and monitoring of the patient through continuous monitoring of the patient and automated transfer of the information regarding the patient into the system 1. A patient may also be monitored for compliance to prescribed versus delivered therapy during PD. As a result, enhanced problem identification and/or simplified patient training may be provided. In addition, home hemodialysis monitoring may be provided resulting in real-time monitoring of the patient during dialysis. A physician or other medical or clinical staff may link to the home of a patient via the internet or modem.

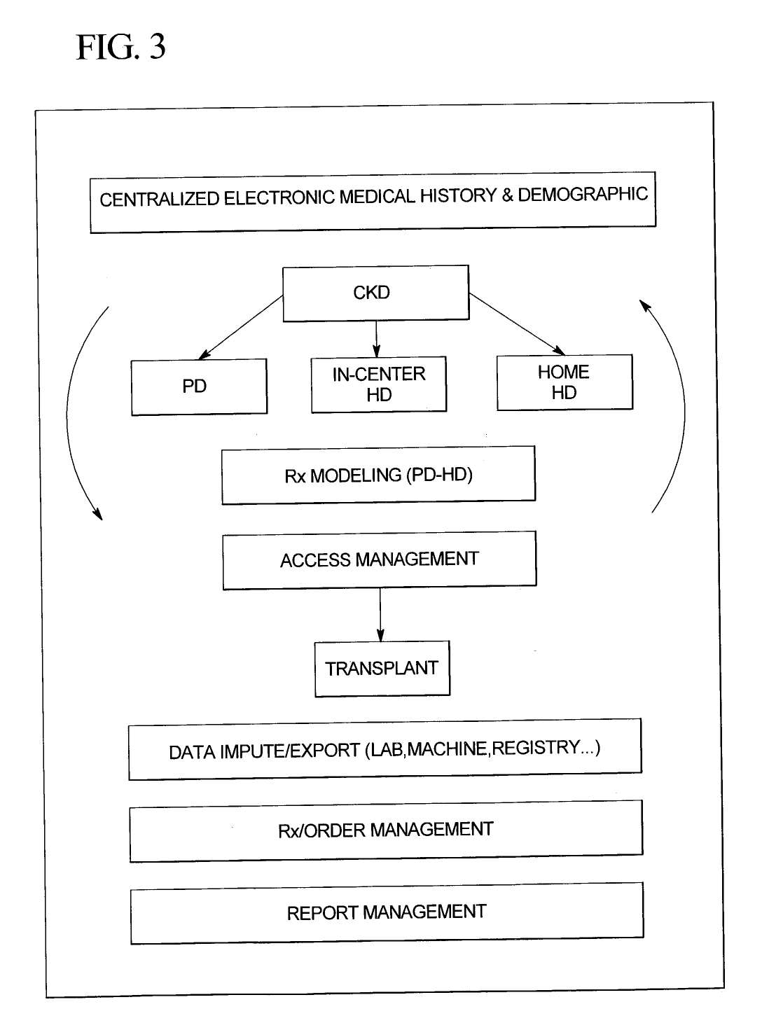

As shown in FIG. 3, the system 1 of the present invention provides centralized electronic medical history and demographic information that is integrally installed on a single platform with data import, data input, and data export capabilities with a laboratory and/or registries and the like. Prescription and order management may also be provided as well as report management.

Within the system 1, certain functions may be activated or deactivated depending on the particular patient. First, the patient may be identified as a patient with chronic kidney disease and may require peritoneal dialysis, in-center hemodialysis, and/or home hemodialysis. Prescription modeling and/or access management may be provided as required depending on the type or types of therapy which the patient may be undergoing. Further, a transplant module may also be activated or deactivated based on the particular patient.

The system 1 of the present invention may be implemented to provide a single system and method for tracking and/or monitoring a patient throughout the various stages of renal disease and to identify the appropriate pathways for each patient and organizing the care standardization of data capture resulting in the continuity of care and data capture for each patient, as well as efficient data retrieval and targeted data exploration for the patient.

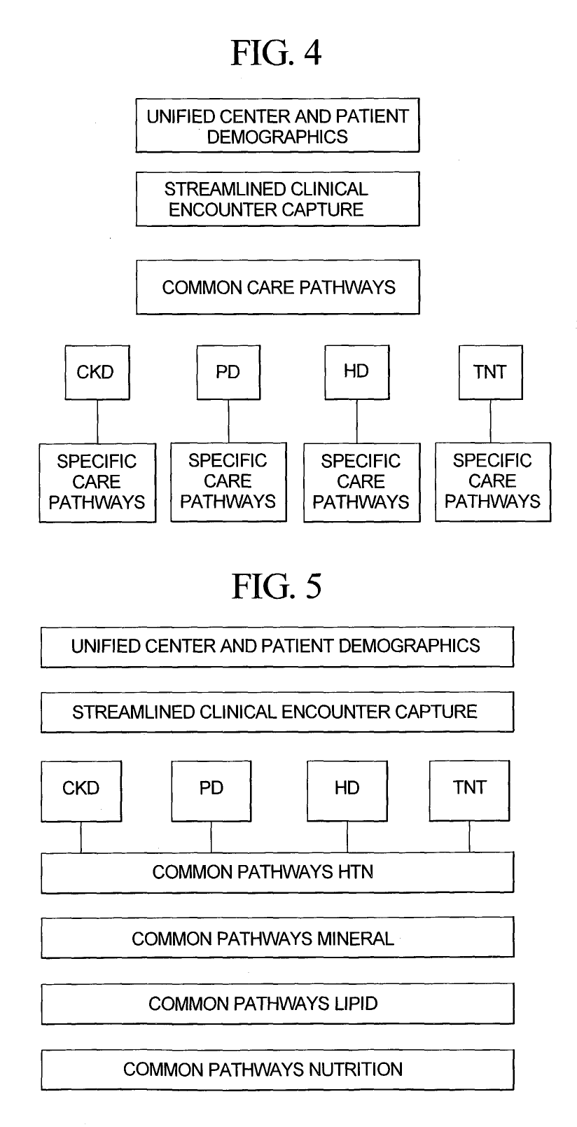

As shown in FIG. 4, an approach or method using the system 1 and method of the present invention results from unified center and patient demographics input into the system and streamlining the clinical encounter captured as a result of use of the system and method of the present invention. FIG. 4 shows common care pathways identified for each of CKD, PD, HD and transplant. As a result of those particular identifications, specific care pathways may then be identified for each patient within each category of treatment, namely, CKD, PD, HD and transplant.

FIG. 5 illustrates an alternate approach in which unified center and patient demographics are obtained through streamlining clinical encounter capture for each of CKD, PD, HD and transplant therapies and common pathways for various data identified, tracked and/or otherwise addressed, such as hypertension, mineral, lipid and/or nutrition.

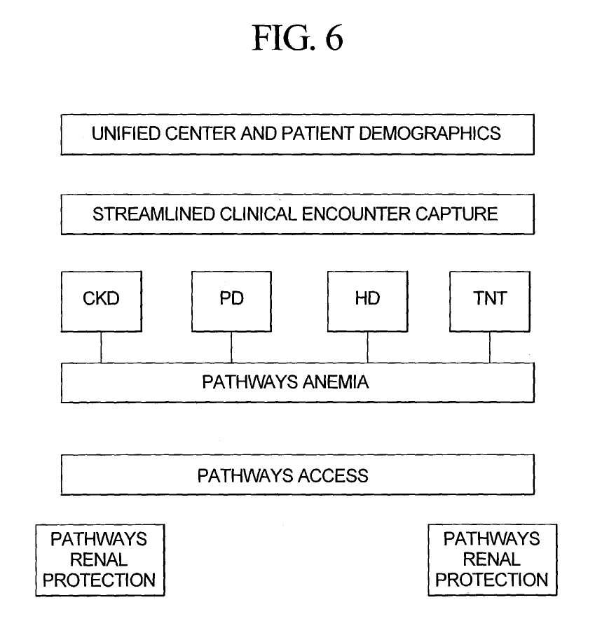

As shown in FIG. 6, another approach through unified center and patient demographic input through streamlined clinical encounter capture for each of CKD, PD, HD and transplant treatments, various pathways are identified such as, for example, anemia, providing pathway access to subsequent pathways for renal protection.

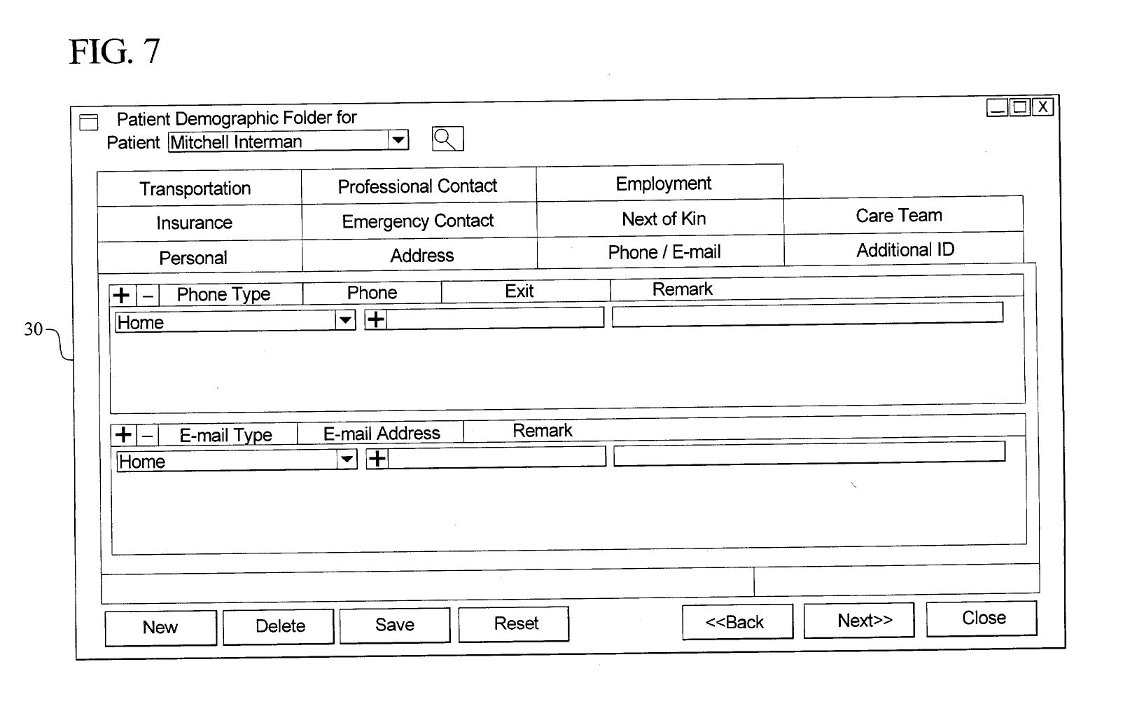

FIG. 7 illustrates an embodiment of a center and patient demographic screen for a particular patient. The screen provides for input via tabs 30 for various demographic information for a particular patient such as professional contact information and emergency contact information, employment information, insurance information, personal information, address information, telephone or e-mail information, and the like.

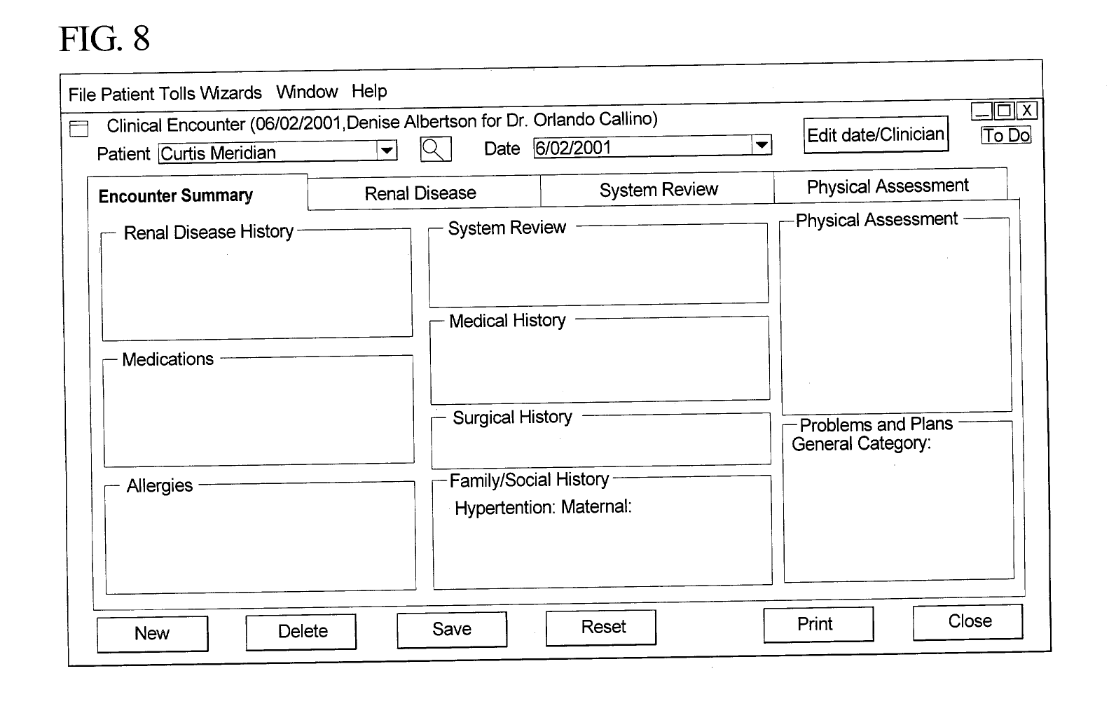

FIG. 8 illustrates a screen that prompts input or information regarding clinical encounter. Various tabs are provided, such as the encounter summary tab 32 which identifies various information regarding the specific encounter of the particular patient by the physician or other medical professional treating the patient. The tabs may include information regarding summarizing the encounter, information regarding renal disease, system review and/or physical assessment of the patient.

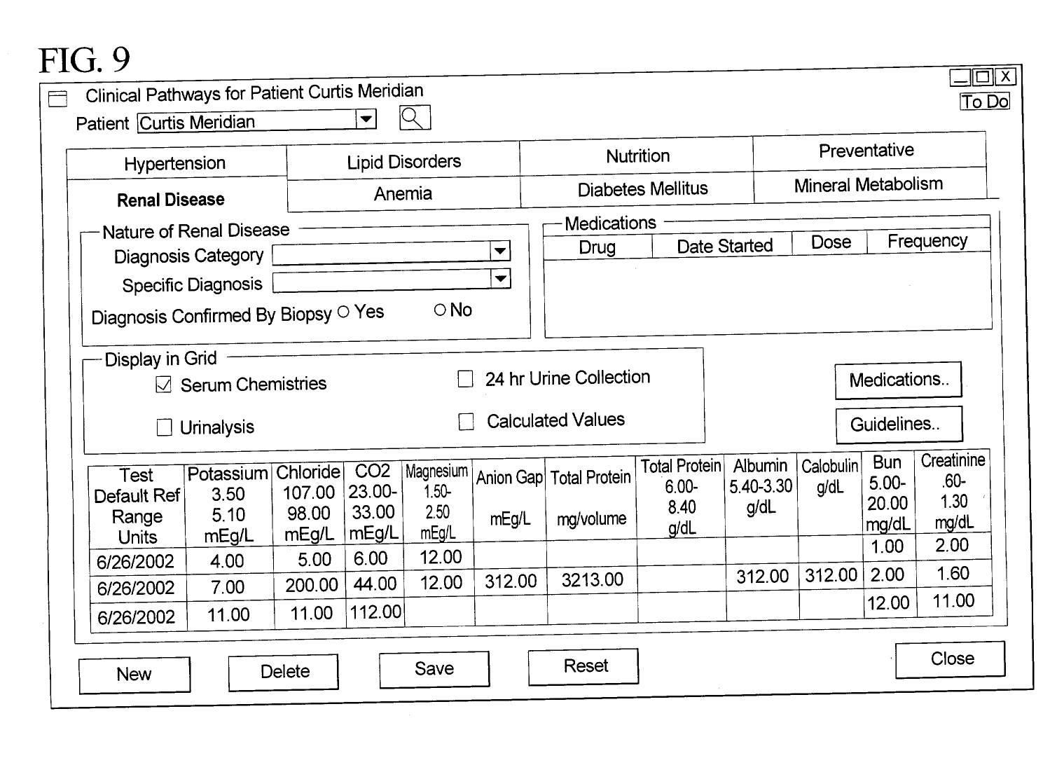

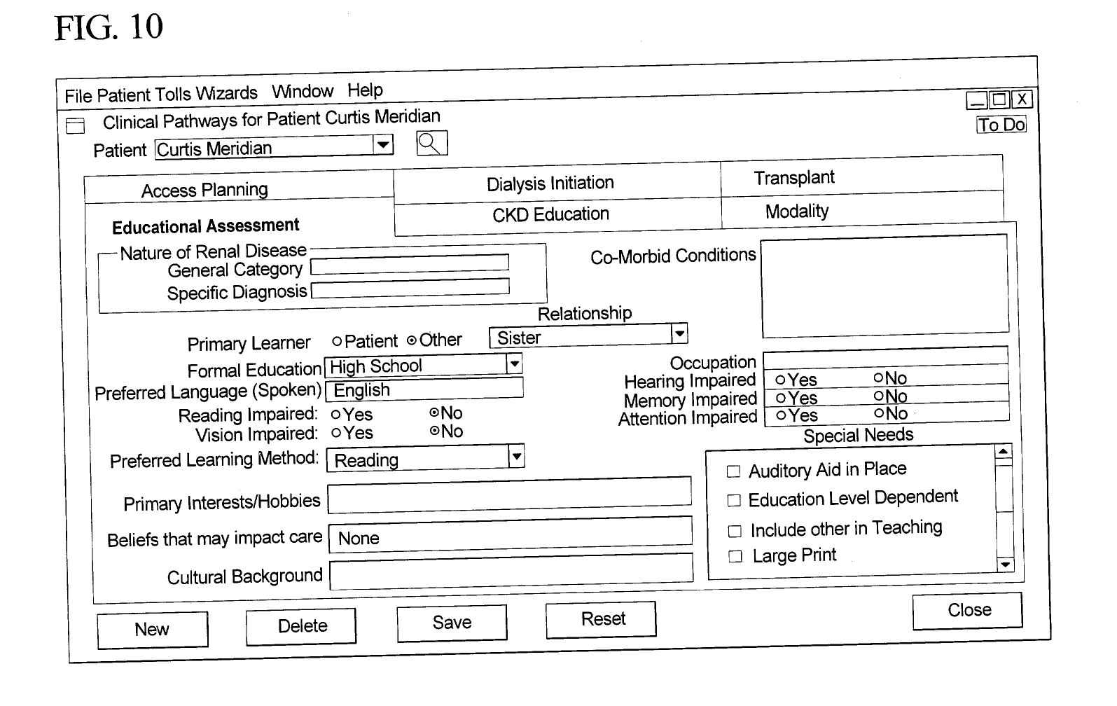

A care pathway may then be identified for the particular patient identified by various tabs or, for example, hypertension (HPT), lipid disorders, nutrition, preventative, renal disease, anemia, diabetes mellitus and/or mineral metabolism, and the like as shown in FIG. 9. Additional care pathways may also be provided for a patient, such as tabs for access planning, dialysis initiation, transplant, educational assessment, CKD education, and modality as shown in FIG. 10.

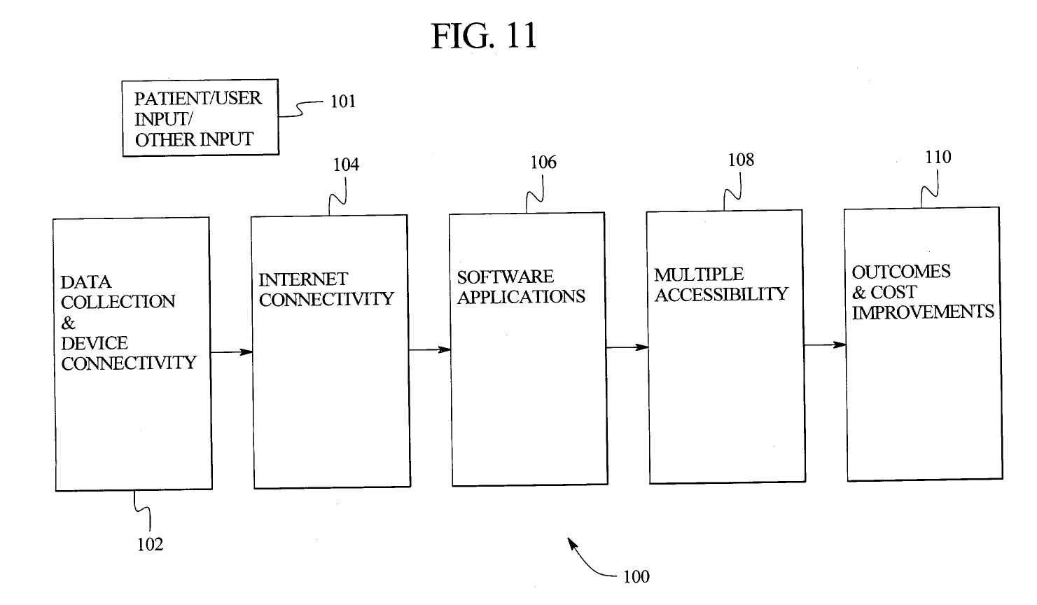

FIG. 11 illustrates a method 100 for using the system 1 of the present invention. A first step is identified at step 102 where data collection and device connectivity are provided. Data may be collected through manual input via, for example, the integrated software of the system 1 requiring patient input or center input or other user input as shown at step 101. The input may also be provided via, for example, a personal digital assistant or other wireless input device. Alternatively or in addition, machine input may be provided by direct monitoring, for example, of a patient within a center. Or, for example, if home hemodialysis is taking place, the information may be transferred, data may be collected and/or moved to and/or from multiple patients without regard to the type of therapy which the patient may be undergoing during any stage of the renal disease of the patient.

Internet connectivity with a consolidated database may be provided as shown at step 104. The internet connectivity may be provided at a data hub providing information to the internet via a browser. Or, a server database may be provided that may provide the necessary legal, privacy, security and/or regulatory issues for the monitoring of the patient through the various stages of renal disease. Connected to the internet are various software applications as shown at step 106 wherein information may be downloaded to and/or from the software to provide the necessary processing of the data for any type of renal disease that the patient may be experiencing. The method provides multiple accessibility as shown at step 108 or multiple users and multiple tools. Among the users may be the patient, a clinician or other medical or technical professional. A provider, a supplier, a laboratory or other corporate or professional resource may also be defined as a “user.”

Multiple tools may also be provided to assist with the administration of care to the patient throughout each stage of the renal disease that may be experienced by the patient. For example, tools that may be used to assist the patient or any other users include a computer, e-mail, telephone, telefax, or the like.

The final step 110 of the method 100 results in various outcomes that may be provided as a result of the method of the present invention as illustrated in FIG. 11. The patient may be tracked through his/her therapy lifetime. In addition, the system and method of the present invention tracks multiple patients through their therapy lifetimes. The history of patients is not lost as the patient is transferred from one therapy option to another option. In addition, all history from the CKD phase may be transferred with the patient or patients to the dialysis and/or transplant care professionals, or medical care clinicians or other professionals. The system and the method provides a comprehensive integrated software tool that allows renal patient data to be transferred from the CKD phase to the patient's first therapy option to ensure continuity in treatment history.

All therapy options may be recorded within the software so patients may be transferred to and from PD, HD, and/or transplant therapies without losing previous treatment history. Clinical and therapeutic features include the managing and/or monitoring of CKD patients to track renal disease progression and/or complications. Data may be recorded for therapy option education, modality selection, and/or access placement preparation. In addition, clinical patient management may be provided to track medications and/or monitor compliance. Further, complications and/or infections may be tracked. Further, co-morbidities may be managed; and clinical assessment and/or history of the patient may be monitored. As a result, the organization of the delivery of care may be enhanced by creating a single source for all clinical information. Timely initiation of dialysis may also be provided that may reduce urgent start of the particular dialysis therapy, improved clearances, as well as saved medical professional time for physicians, nurses, or other medical professionals.

From an operational and administrative standpoint, data may be captured from machines and other sources. Captured data may be accessed and/or exchanged remotely. Remote access and/or exchange include clinical data and/or machine parameters via two-way communication. Moreover, data may also be automatically imported, and the data may also be exported. Dialysis product supply management may be enabled resulting in electronically presenting new patients and/or creating initial orders. Further, prescriptions may be automatically submitted to, for example, suppliers. Still further, remote diagnostics of dialysis devices may be provided through the system and method of the present invention to determine and/or solve problems associated with, for example, showing which patient may be connected. Problems may be determined and/or fixed with, for example, a modem and/or the internet. As a result, a single source for clinical data and/or machine data may be created. Patients visits may be reduced and annual data entry may be eliminated. Administrative time and paperwork, as well as human errors, may also be reduced and/or saved. From a patient's standpoint, anxiety or hassle that a patient may experience may be lessened or eliminated. Moreover, missed exchanges required by the patient may be reduced and/or eliminated.

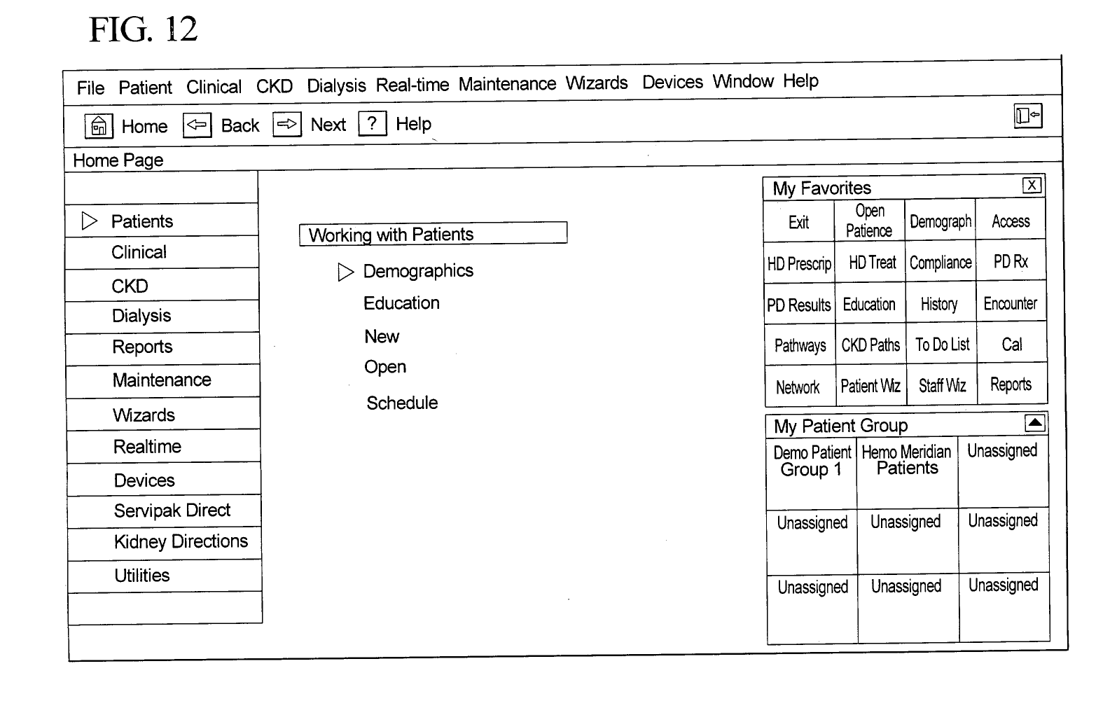

To initiate use of the system and method of the present invention, an entry screen, as illustrated in FIG. 12, may be provided. The patient entry screen provides customization as well as access to all components of the system and method of the present invention.

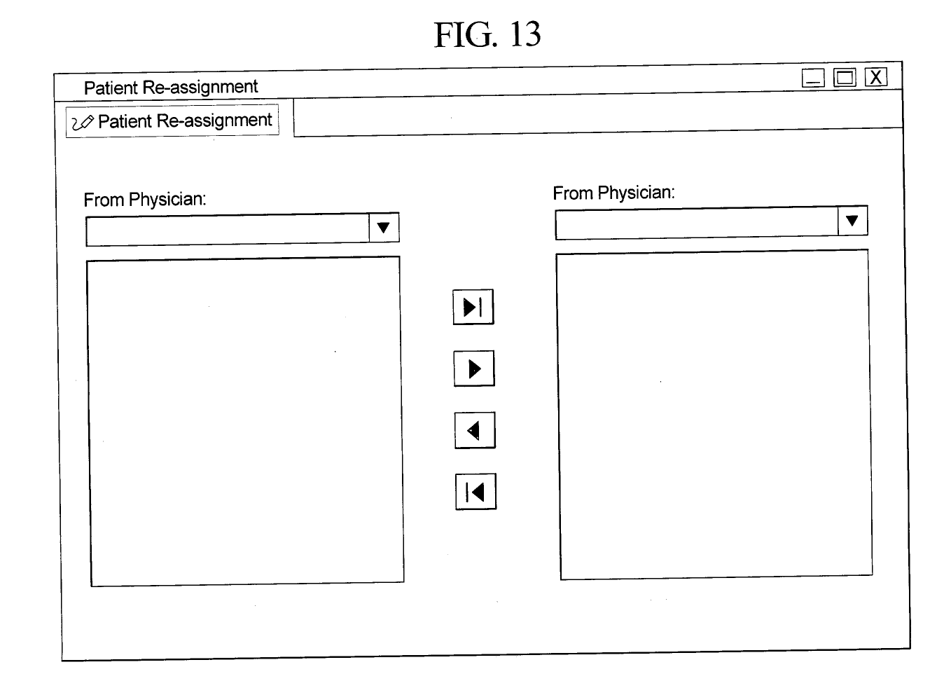

FIGS. 13-15 illustrate screens for transferring or re-assigning patients from one physician to another physician. As a result, patients may be transferred between physicians in a simplified fashion. The records of the patient are also transferred to the new physician and access may be provided through the records or the patient from the previous physician.

First, as illustrated in FIG. 13, the patient re-assignment is performed by identifying the current physician of the patient. The physician's name may be identified as part of a drop down menu of physicians already input to the system of the present invention. The new physician may be identified in a second area of the screen which may also be provided in a drop down menu of physicians already input into the system.

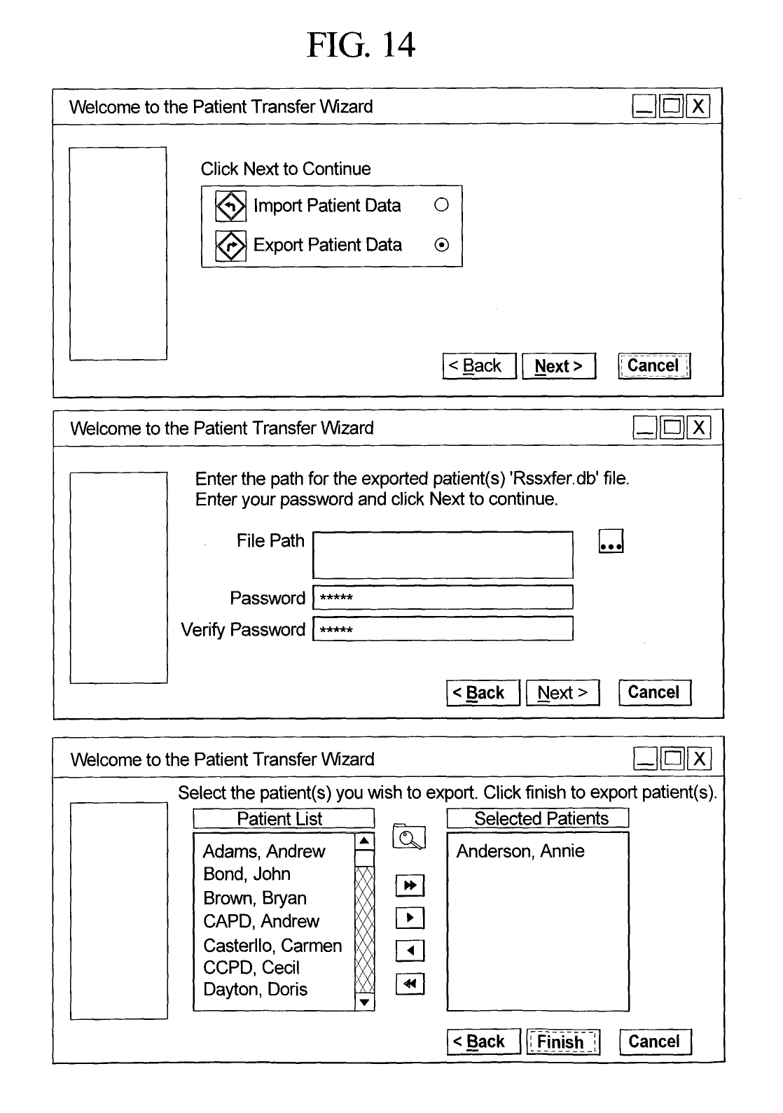

As shown in FIG. 14, the patient transfer may be affected by importing and/or exporting patient data which may be password protected as shown in FIG. 14. One or more patients may be exported by the user by identifying patient name, a patient list, and transferring information from the patient list to the selected patient list for transfer of the patient.

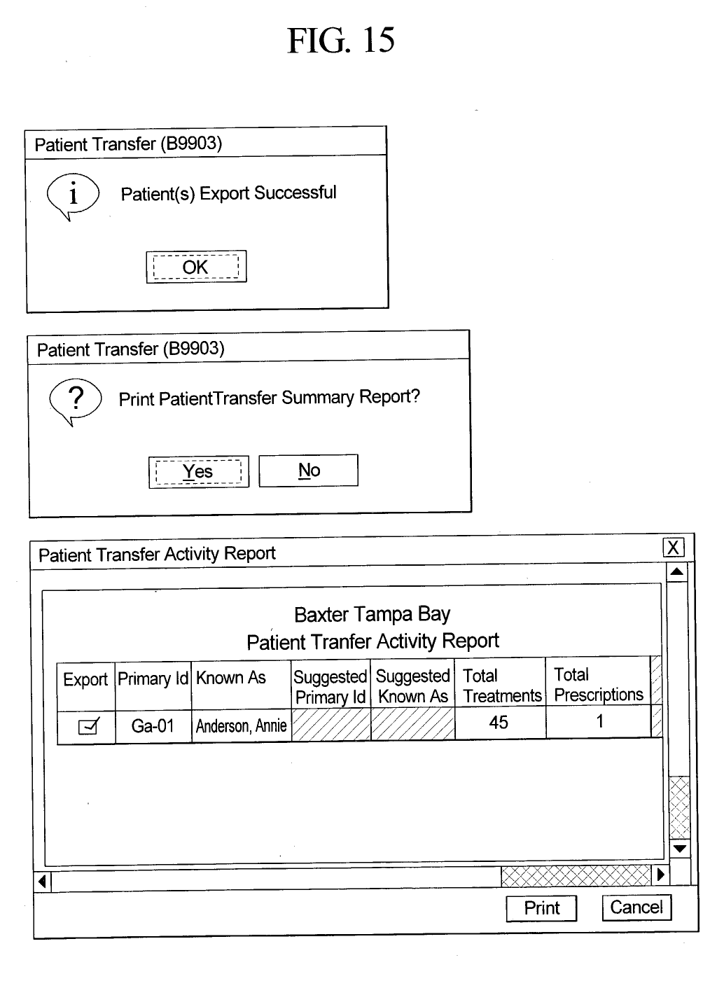

Following transfer of the patient, as illustrated in FIG. 15, the user is notified that the export of the patient has been successful. The user may print a patient transfer summary report which may include various customized pieces of information. The report information for a particular patient may be customized as will be discussed hereinafter. It should be understood and appreciated that any report or function of the system may be customized as desired for the particular patient and/or the center and/or the medical professional or other user.

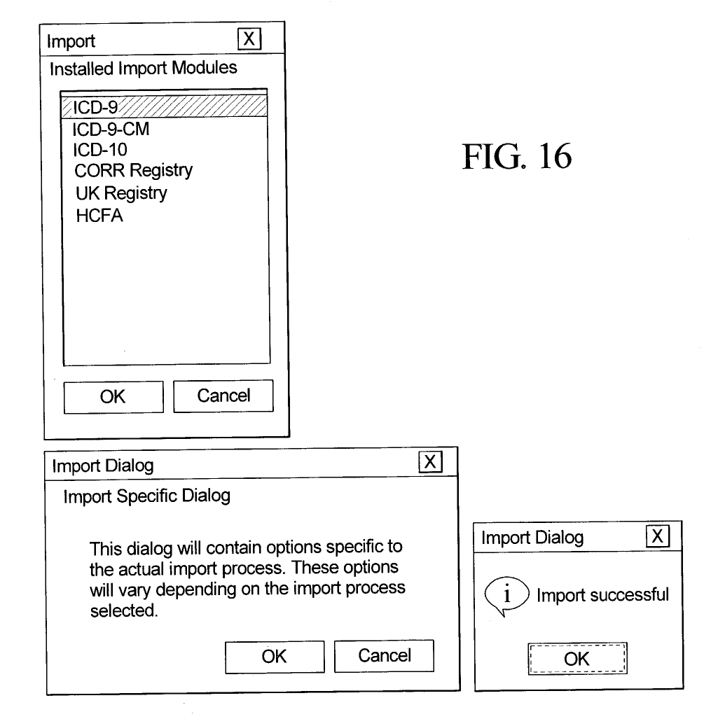

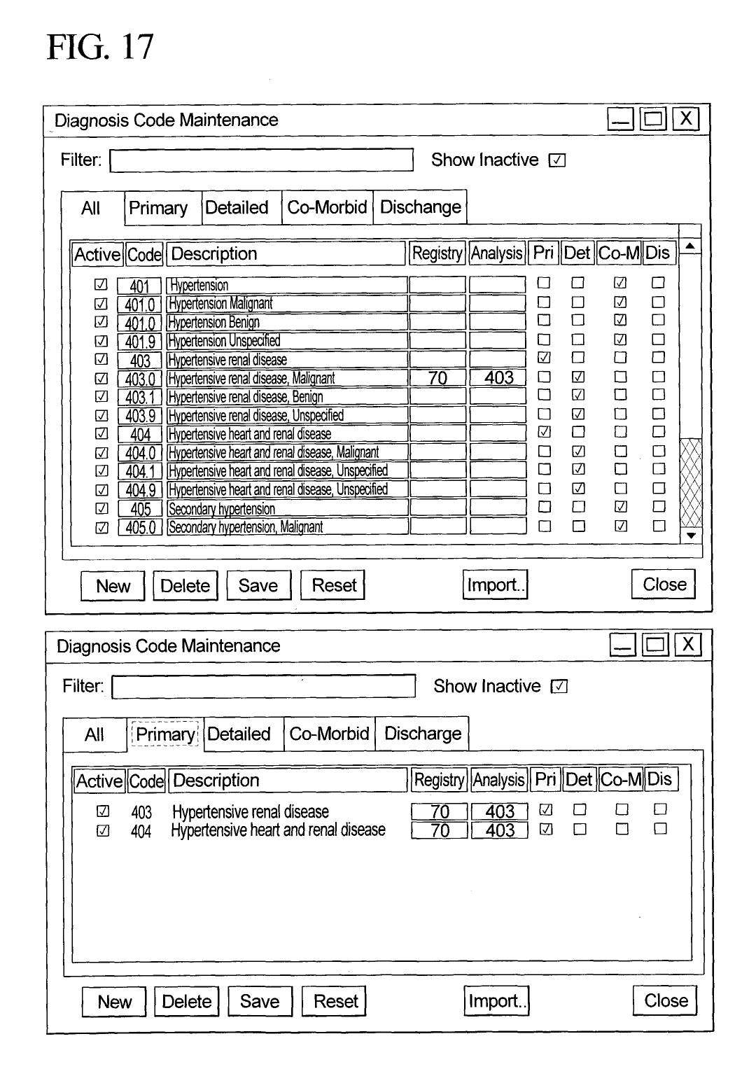

Another feature of the present invention is generally illustrated with respect to FIGS. 16-19 which provides for import and/or maintenance capabilities for diagnosis codes (ICD or registries) which may differ by module, i.e., CKD, PD, HD and transplant.

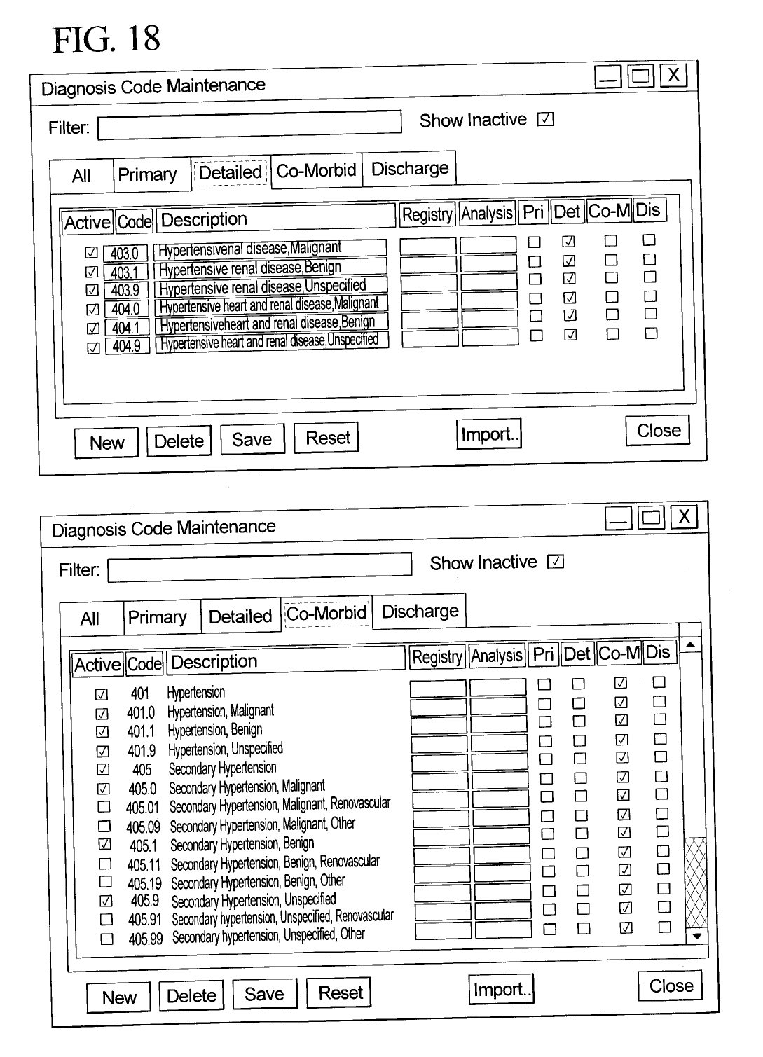

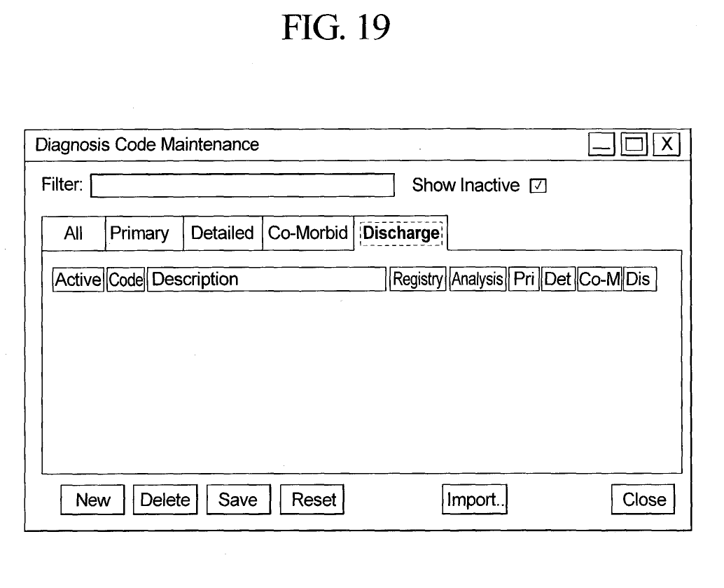

As shown in FIG. 16, the installed import modules can be identified and imported. Diagnosis code maintenance may be provided to identify, for example, various codes associated with, for example, hypertension, as illustrated in FIG. 18. FIG. 19 illustrates, for example, existing diagnosis codes within the renal link which may be used to identify the particular code for word and/or maintenance. The diagnosis codes maintenance window adds fields for “active”, “registry”, and “internal system code”. In addition, fields may be added for code type association as well as validation rules. The validation rules may include active codes that are unique, active descriptions that are unique and may not delete particular rows. Ability to filter by code and/or description may be provided a checkbox for display.

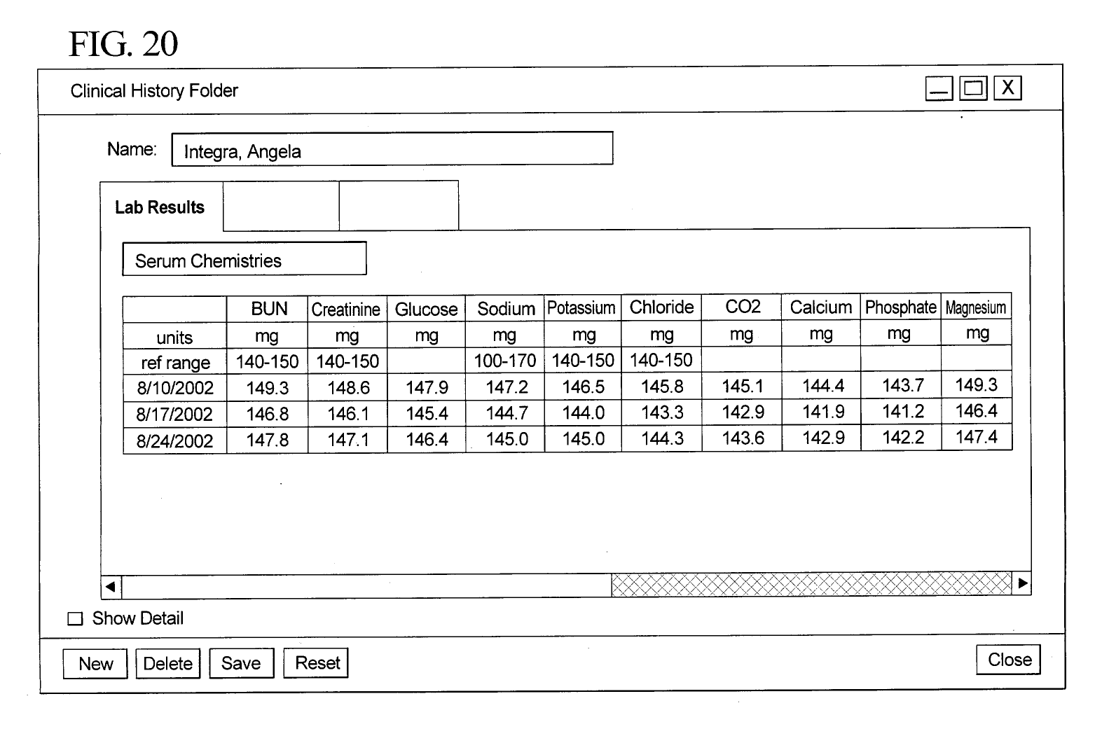

FIG. 20 generally illustrates screens for identifying routine lab tests for renal patients and/or to provide for analysis of pre-treatment results as well as post-treatment results. The lab results category screens illustrated in FIG. 20 provide a database linking category and source columns headed to test results table. Display groups may be selected by category. The results may be provided any column and display may be filtered to show any test results within a specific acceptable range. Moreover, test results may be displayed by filtering outside an acceptable range.

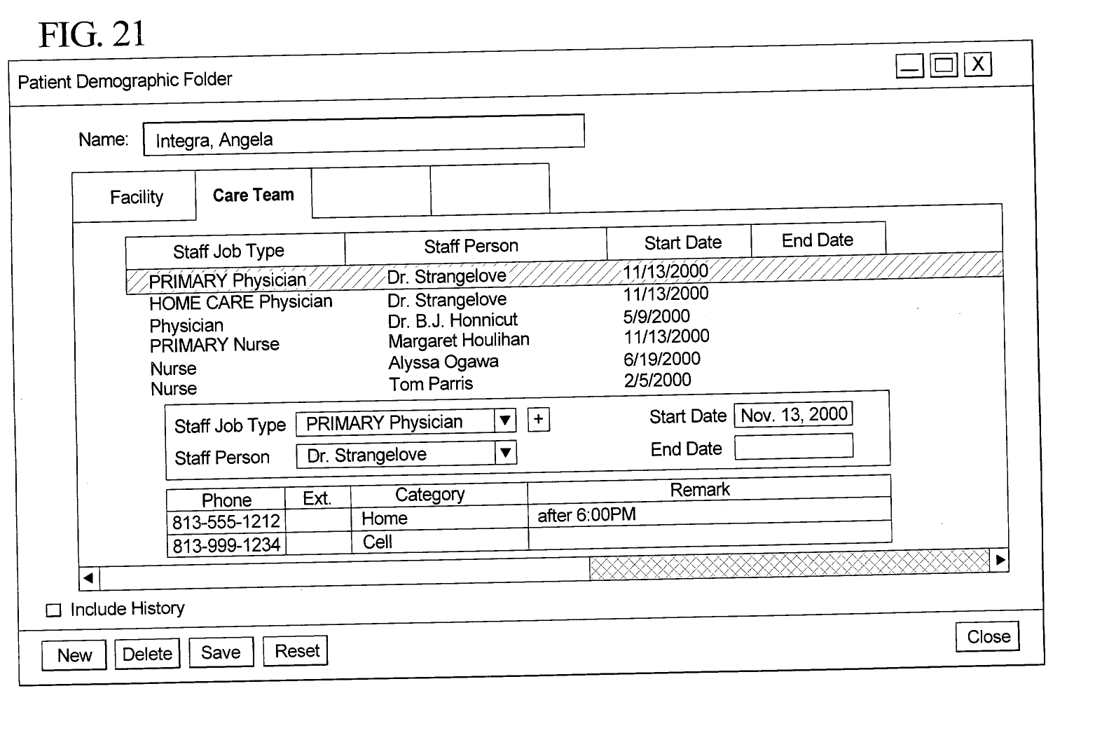

In addition to the foregoing, as illustrated in FIG. 21, enhanced renal patient care team assignment maintenance may be identified by displaying associated caregivers with each renal patient. To this end, a patient name may be identified and the entire care team may be illustrated on the screen. As a result, each caregiver, physician, or the like, may be immediately provided and accessed through this link.

The patient re-assignment feature, discussed above with reference to FIGS. 14 and 15, transfers renal patient data from one physician to another without manually re-assigning each patient to a new nephrologist, physician or other medical professional. The patient transfer feature transfers a CKD patient from one database to a dialysis-transplant facility database in the integrated system and method of the present invention. As a result, a new nephrologist or physician may be provided with access to treatment history in an electronic format and that history would not require printing and/or separate manual entry by the new physician. The import maintenance capabilities for diagnosis codes prevents manual entry of data by the user and provides simplified updating if a new set of codes are created.

The lab result category described with reference to FIG. 20 assists with simplified identification of routine lab tests of renal patients and simplified comparison of pre-treatment and post-treatment results. As a result, users may easily group routine lab tests.

The patient care team assignment maintenance location described with reference to FIG. 21 identifies all caregivers associated to each renal patient. As a result, one central location provides a comprehensive function to track the team members from CKD, dialysis, and transplant. All of the above functions described with reference to FIGS. 12-21 are performed automatically and replace manual processes that previously were performed by a user that resulted in mistakes, or mis-entries or the like.

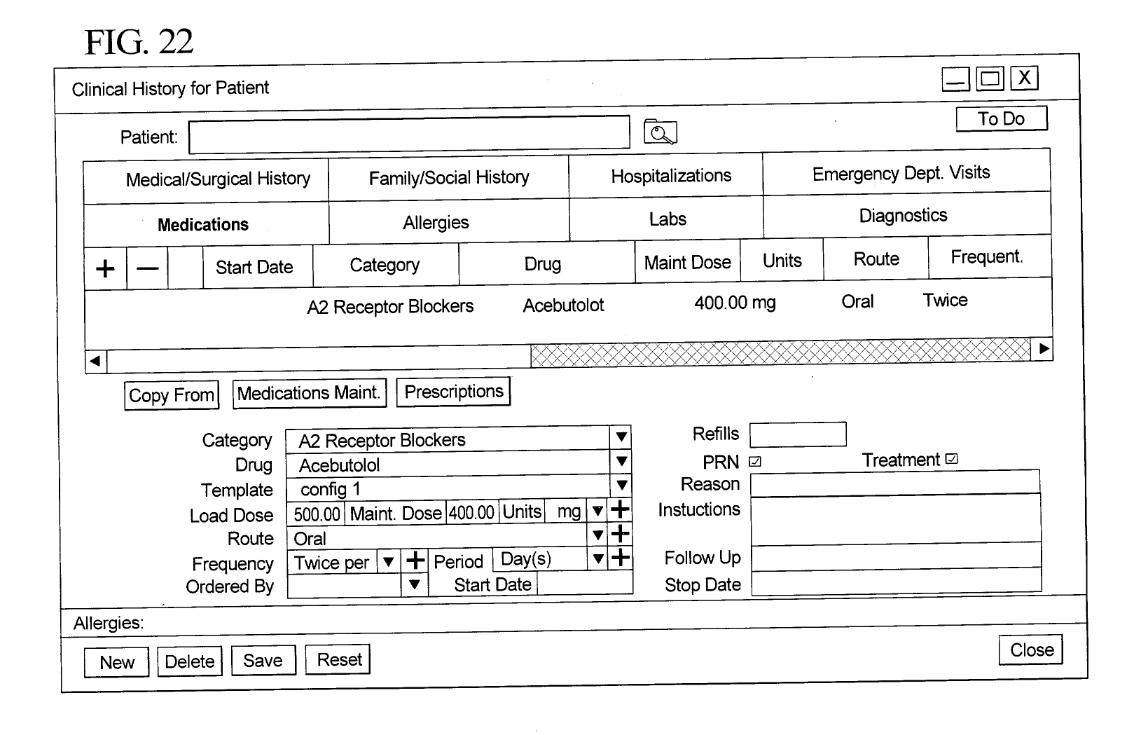

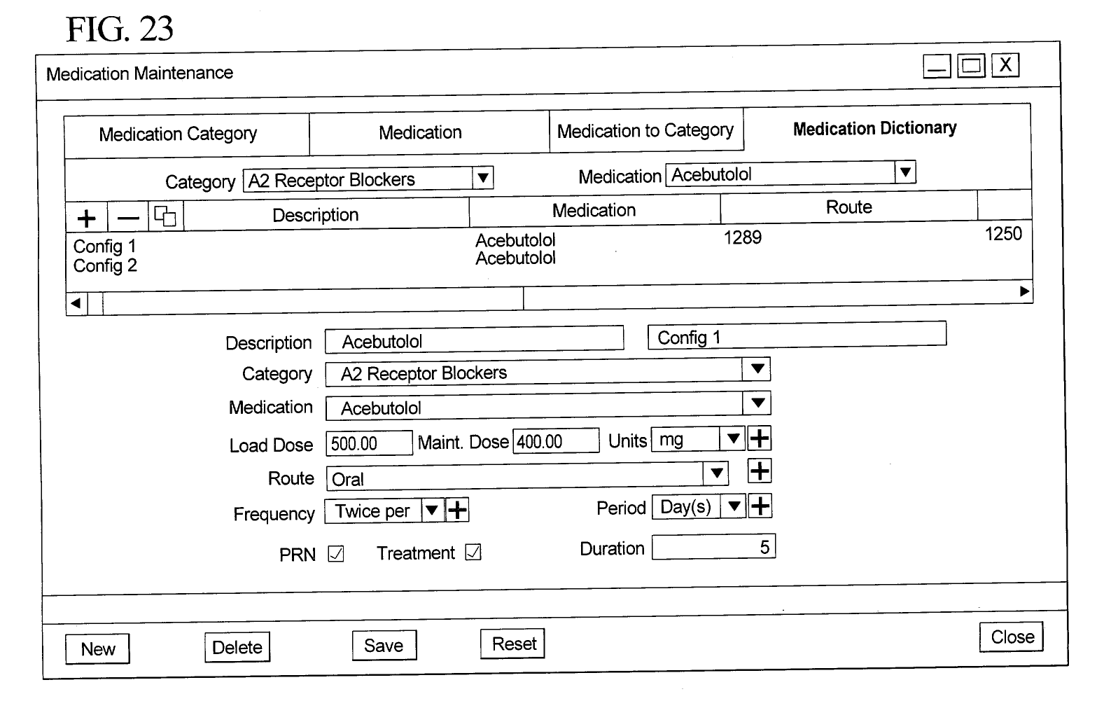

Another feature of the system and method of the present invention includes a medication dictionary which enables a user to create and/or save medication or prescription templates for subsequent use and/or recording and/or for prescribing treatment to a patient. FIGS. 22 and 23 illustrate a medication screen for entry of information in a template format. As a result, various components of a prescription may be standardized and saved as a “standard prescription”. A series of computer dialogues are provided by the medication dictionary to enter a configuration name, medication, medication category, load dose, maintenance dose, dose unit of measure, route, frequency, frequency period, PRN (Y/N), treatment related PRN in dialysis (y/N), PRN and/or duration. In addition to those input categories, units of measure, route, frequency and frequency period may be presented as select lists to assist with the standardization of configurations and/or selections of medications for prescriptions.

FIGS. 22 and 23 illustrate screens providing medication templates for a patient resulting in a standard prescription for a particular patient. Fields within the medication configuration maintenance window may be pre-populated when a configuration is selected. Drop-down lists may be implemented to identify and assist with completing the necessary field or fields within the prescription window and/or medication tab. After a medication is selected, available configurations populate the window using the medication dictionary. The field and/or reports associated with the medication and prescription may be manipulated like any other report within the system 1 of the present invention as will be described hereinafter.

The medication dictionary creates a group of standard medication configurations for frequently prescribed medications which may be customized for a particular patient throughout the stages of renal disease. The medication dictionary contains configurations for frequently prescribed medications that may be transferred from patient to patient within each stage of renal disease.

To effect or implement a medication dictionary, a medication maintenance may first be selected by a system administrator wherein the system displays a medication configuration dialogue. The system administrator selects one of a plurality of medications, and configurations for that medication are automatically input by the system. The system administrator may select or identify desired components of the medication or the particular therapy and/or the particular patient. The system administrator may enter values for dosage, maintenance dosage, and/or duration period. Values may be further selected for units, frequency, frequency time period and routes from drop-down lists for each category. In addition, the system administrator may indicate whether medication may be given during treatment. The medication information may then be saved, and the system may store the same in the application database.

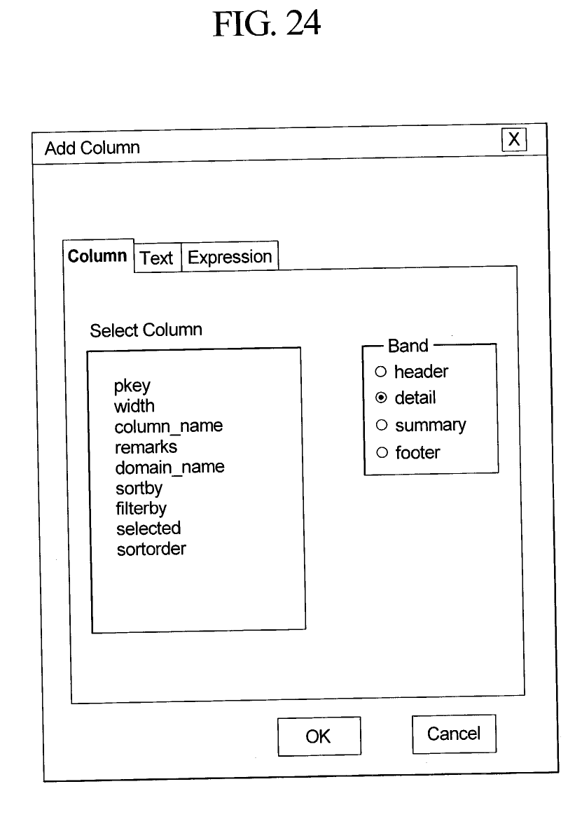

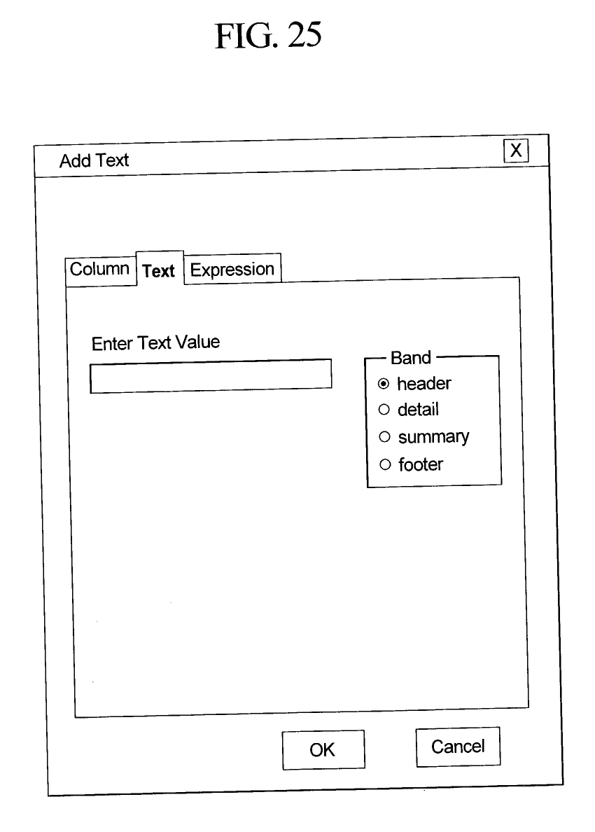

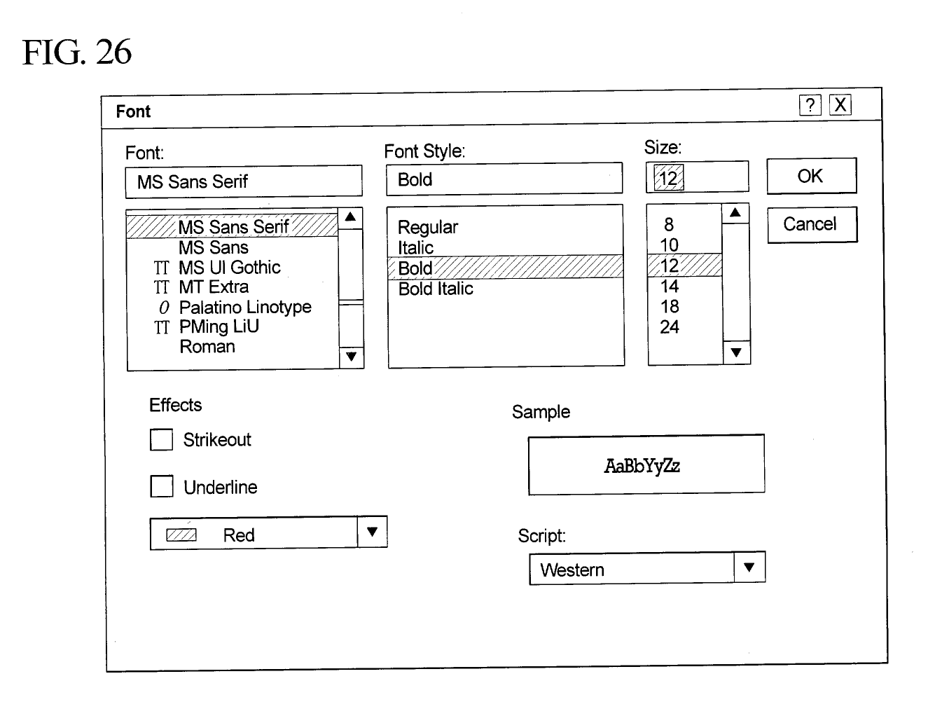

Moreover, medication history may be maintained with use of the system and method of the present invention. The history and/or medication selected by the user and current medications for the selected patient may be displayed. The system and method of the present invention further provides a report engine that provides the ability to sort on any column; the ability to filter on any column; the ability to search for text strings within a remark field; the ability to move, hide, and/or re-arrange column; and the ability to hide a reports sections. FIG. 24 illustrates a screen that may prompt a user to identify the ability to add a column and prompts for making a column by word specific “bands.” After a report is selected, sorts, additions or deletions may be affected. In addition, text may be added as illustrated by FIG. 25 within specific bands. Similarly, expressions may be added through a series of prompts within the screen. Fonts within any report may also be adjusted and modified through a font prompting screen as generally illustrated in FIG. 26. Font may be adjusted by font type, font style and/or font size for any report within the system.

As previously described, the system and method of the present invention may be executed on a computer within the home of a patient. The PC may be connected to an instrument via a serial connection. Alternatively, the PC may be connected to a modem and is capable of connecting to the internet or intranet. After a PC in the home of the patient is turned on, the system and method of the present invention awaits a connection signal from the system operating within, for example, a clinic. The application automatically establishes a connection with the PC within the home of the patient via modem or TCP/IP protocol. An approved security algorithm communicates and receives the application through the system. The system and method of the present invention includes the ability to securely monitor home dialysis patients via a modem and/or the internet. The internet may be used to eliminate long distance charges and also add encryption on all data sent and received on the communication pathways.

The system of the present invention uses software to communicate with dialysis instruments within the home of the patient. The system via the software retrieves data from the instrument within the home. The system provides a secure way of communicating with the instruments in patient's home via modem and TCP/IP protocols. In addition, appropriate security is provided at the patient's side of the system. After the connection is established, the information from the patient's side may be transferred and may be received via the selected communication protocol from, for example, the clinic. The PC in the home of the patient may be connected to the instrument via a serial connection. For modem connections, however, a modem is attached to the PC. For TCP/IP connections, the PC is attached to a cable modem that is capable of reaching the internet/intranet.

The server for the system has two modules: one module for service and the other module for the controller. The service module provides low level communications with a network of instruments. The collected information may be made available via an interface for use by the system and method of the present invention. The service module also provides automatic collection of treatment data wherein the controller provides a graphic interface to monitor the functionality of the system. The controller may also provide for configuration management.

A third module may be used to provide security for the packets sent and received in the home of the patient. The third module may run on the PC in the home to manage the modem and TCP/IP connections between the instrument and the clinic. The software used at both ends of the connection adhere to Advanced Encryption Standard (AES) for packets sent and received in the home of the patient.

The system provides control and/or security for modem connections to the patient. Commands may be provided for a modem port to be assigned to a particular telephone number, status of the connection may be queried, and the connection may be terminated. The system may further provide control for TCP/IP connections to the system of the patient. Commands provide for a TCP/IP resource to be assigned to the connection, status of the connection to be queried, and the connection to be terminated. The interfaces for the control of the connections may be available via screens provided by the system and method of the present invention.

The controller further provides configuration of the machine resources for the system. The controller may write to the registry with the appropriate resource type: modem, in-center, or TCP/IP. As a result, the server may be configured for any of the three resource types. Source maps may store this configuration information, and interfaces may expose information to the system and method of the present invention. The demographics window of the system and method of the present invention allow a user to configure a home patient for a modem or TCP/IP connection. A modem checkbox in the screen of the demographics window populates a listbox control with “modem” and/or “TCP/IP” in the checkbox. The control is automatically enabled when the user selects “home hemo connection” within the category list of types of treatment.

The system and method of the present invention allows a user to assign a home patient to a modem or TCP/IP station. The menu and the window may be changed from real time-connect/disconnect modem to a full time, home hemo connection. After a connection is made to the system within the home of the patient, real time monitoring of the home system may be provided in the same manner as a machine used at a dialysis center. If a connection is lost, the network window may indicate the same to the user. A home station that loses a connection may be sorted to the top of a list beneath any other stations which may have alarms associated with the home station.

To establish modem connections, serial connection is made between the instrument and the PC in the home of the patient. The modem may be set to auto answer and may be connected to the PC. The patient's system may be started on the PC, and a port may be opened to the modem to await a call from the clinic.

Within the clinic, the system 1 may wait for the user to begin the call to the home of the patient. Using a home hemo connection window, a call from the clinic may be made using the modem connection to the PC in the clinic via telephone lines directly to the patient's home. The modem in the home then answers the call, and the client's system is connected to the clinic system. Packets that may be transferred between the connection are encrypted using AES.

After the call has ended using the connection window, the modem in the home returns to auto-answer with a port open. At this point, the patient's system is ready for another incoming call. The modem in the clinic may then establish another outgoing call to another patient.

Similarly, TCP/IP connections to the home of the patient are established by the serial connection made between the instrument and the PC in the home of the patient. The setup of the client's system in the home includes the static IP address and port number of the TCP/IP server system that runs within the clinic. The patient's system automatically attempts to connect to the clinic using the static IP address and port number via the cable modem across the internet. A number of times for each attempt may be configurable, and a default may be established for the number of times.

Within the clinic, the system waits for the user to begin the connection to the specific home of the patient. Using the connection window of the system 1 and method 100 of the present invention, a connection attempt from the clinic is made to the system within the clinic. In the system, a switch may respond to the connection being established from the patient's home. Through this connection, a new thread is spawned in the system at the clinic to continue the connection. As a result, the main connection thread is made available to respond to other connection attempts made by other home patient TCP/IP clients. Circuits that may be passed between this connection may also be encrypted using AES.

After the connection is terminated, the patient's system resets its connection thread and begins attempts to connect to the clinic's TCP/IP server within a specific time frame, i.e. every thirty seconds, which may be configurable and set for the patient. The system may reset its switch preventing attempts to connect the same from the patient's system, and all subthreads used in the terminated connection may be dropped.

The system 1 and the method 100 of the present invention may further guide a user to create PD prescription and/or supply chain orders. To this end, navigation and streamline processes create patient prescriptions based on the patient's therapy mode may be provided. The system may step a user through logical groups of data elements to create the new PD prescription. This example is based on the presumption that the patient received a previous prescription. The previous prescription data may be used as a default, and the user may navigate among the various steps and save a new record at any time. If this prescription is the first prescription for the patient, the first prescription for a different therapy mode fill mode combination and the appropriate machine default values may be set. The user may complete each step sequentially and save the record after completing the final step.

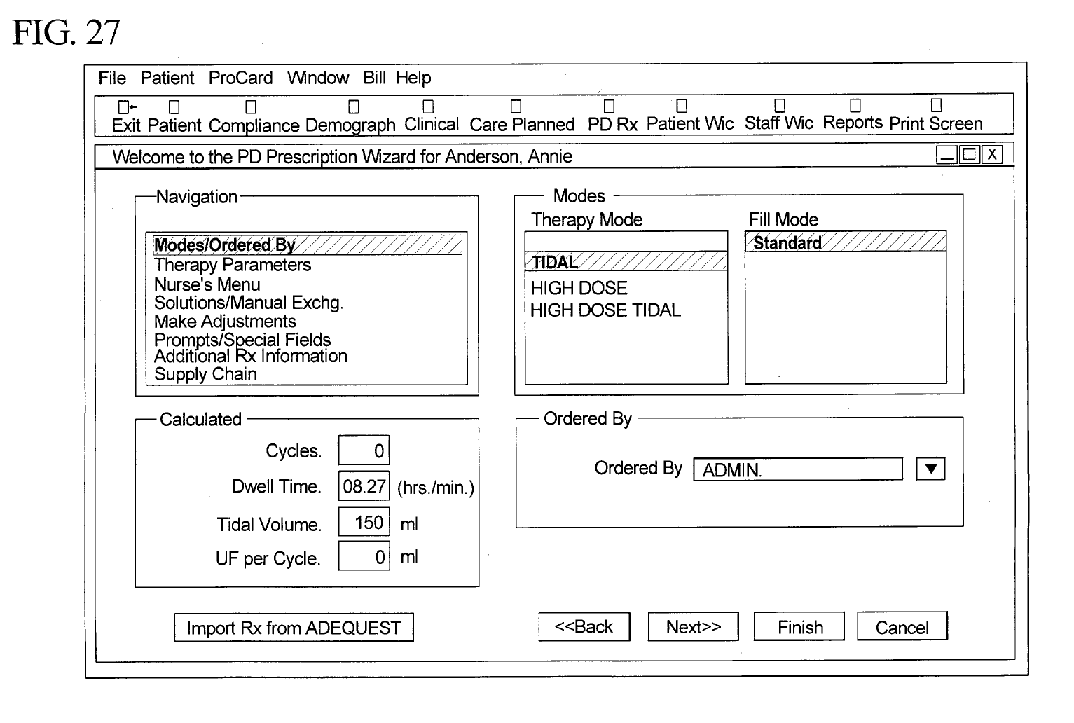

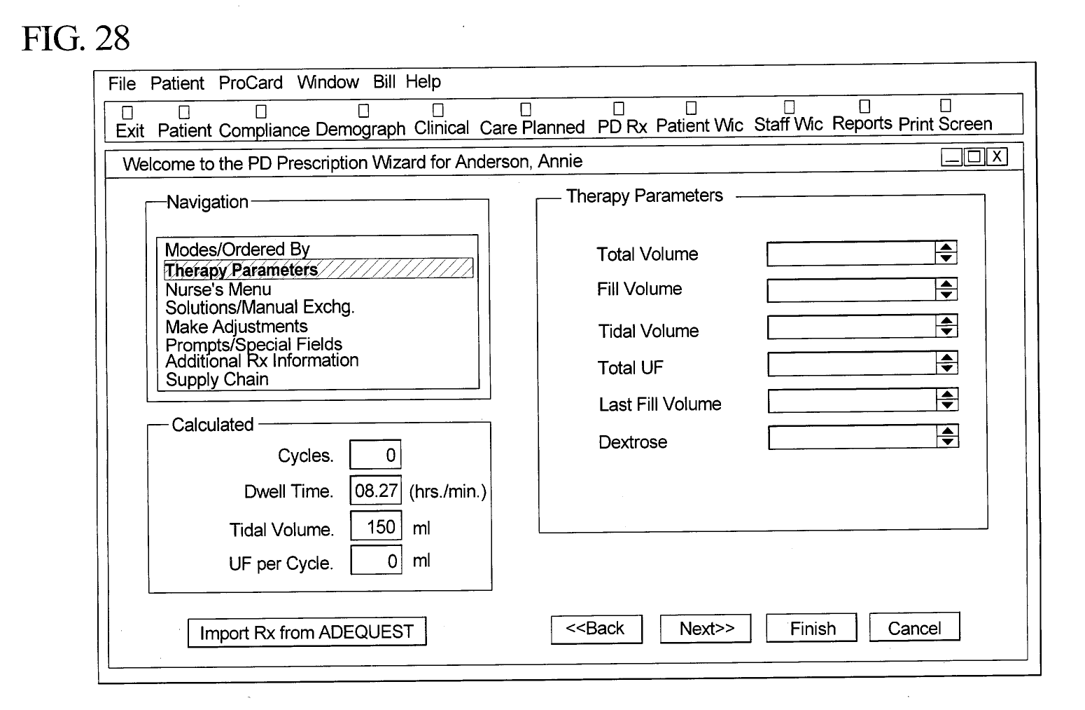

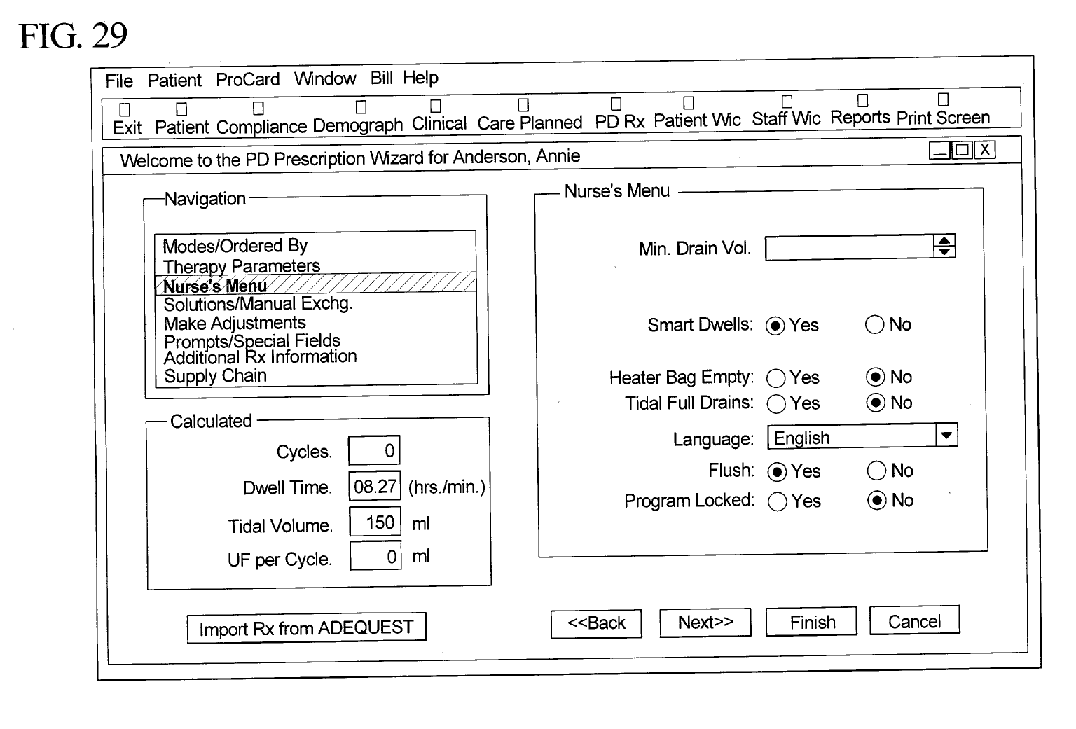

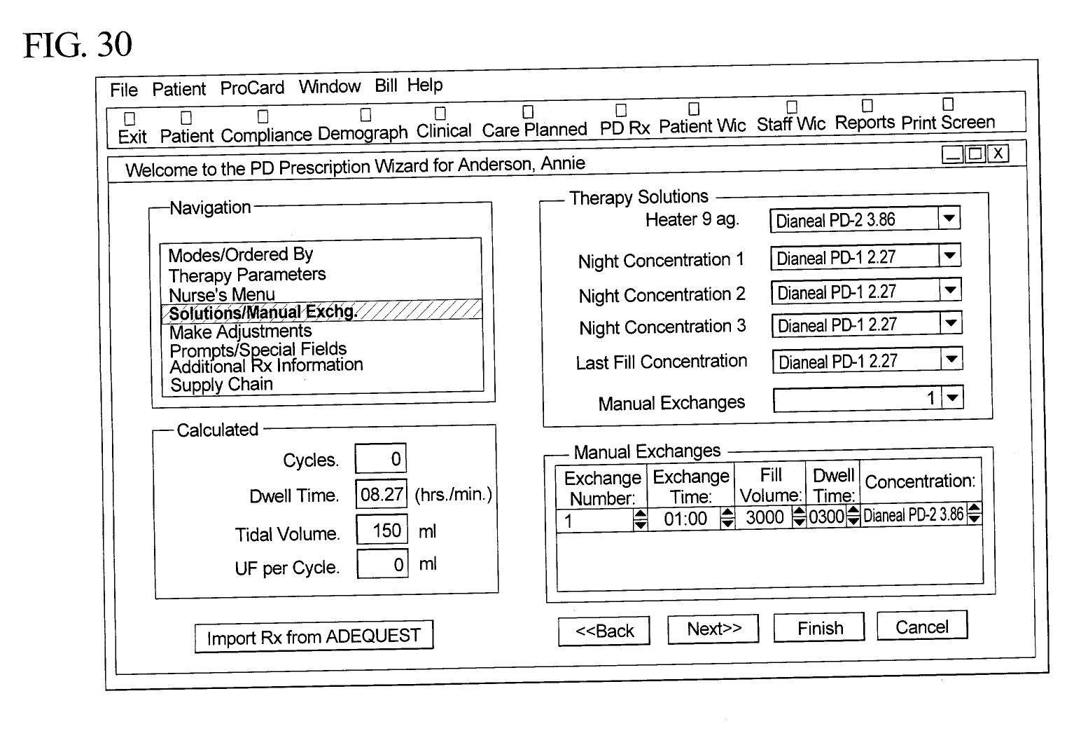

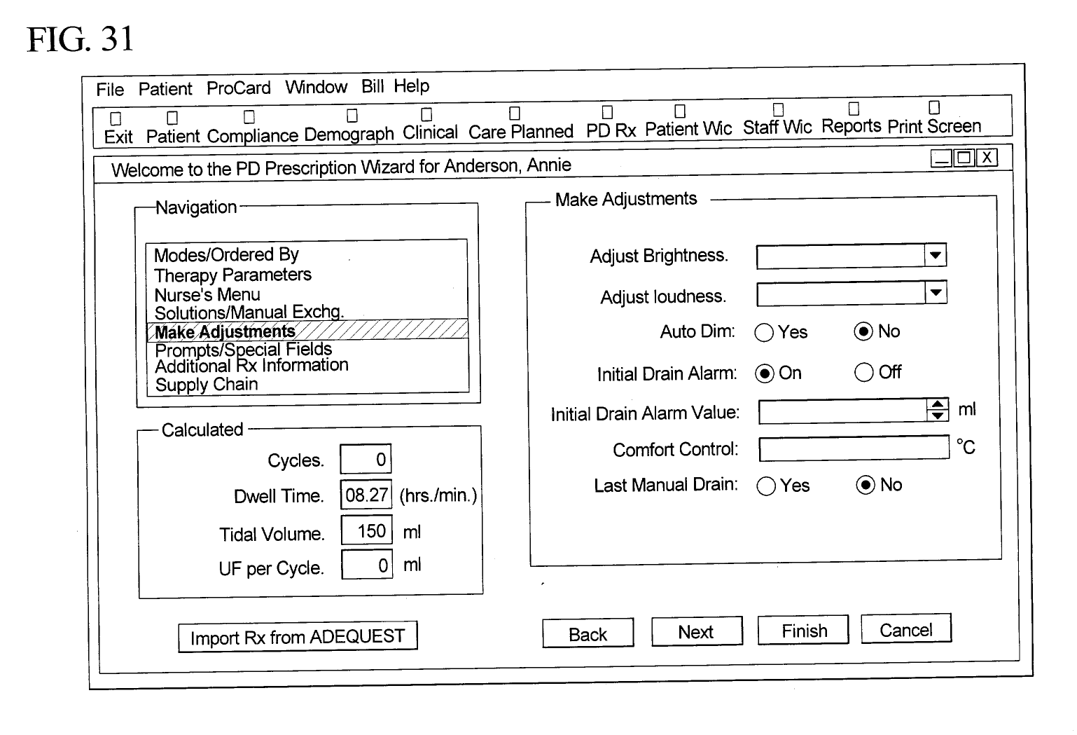

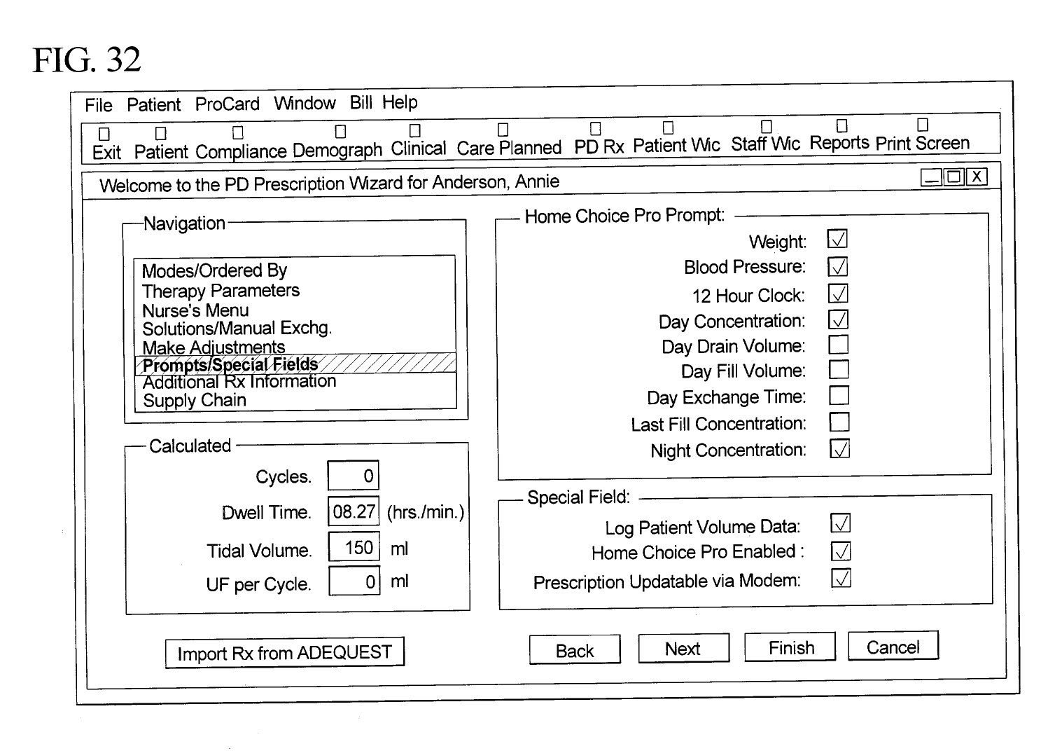

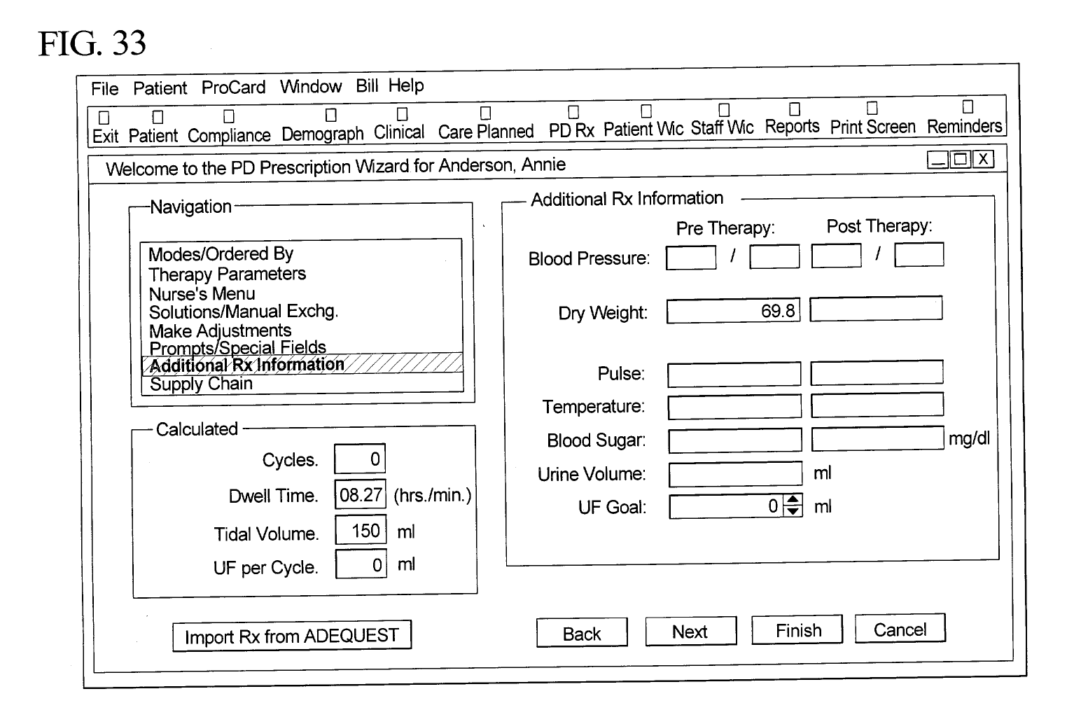

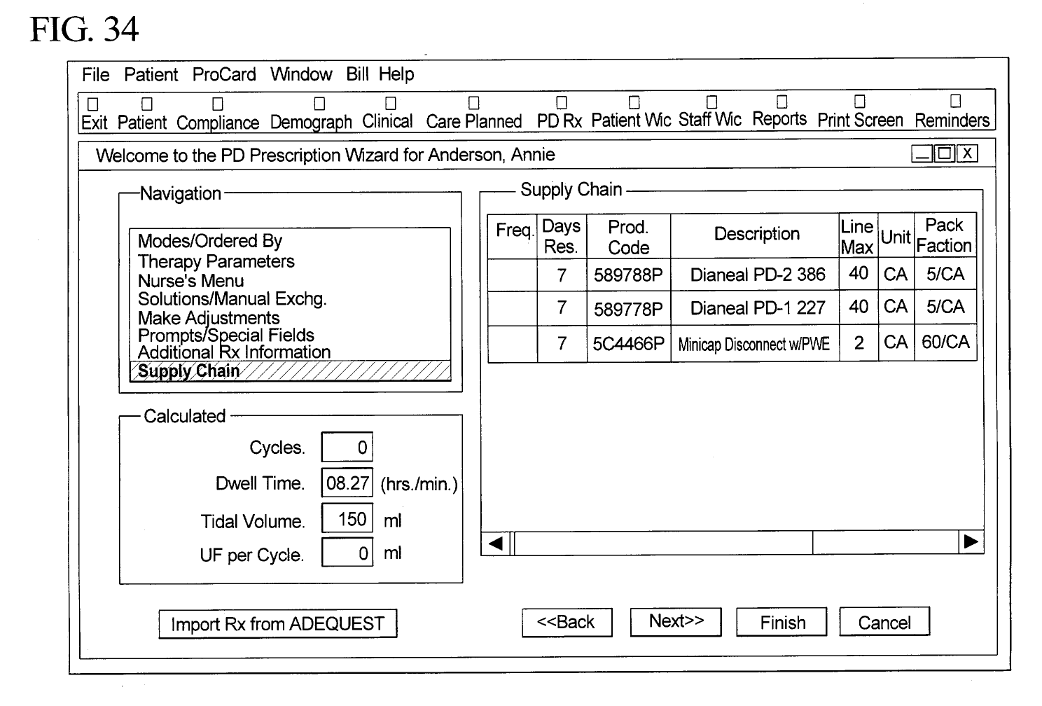

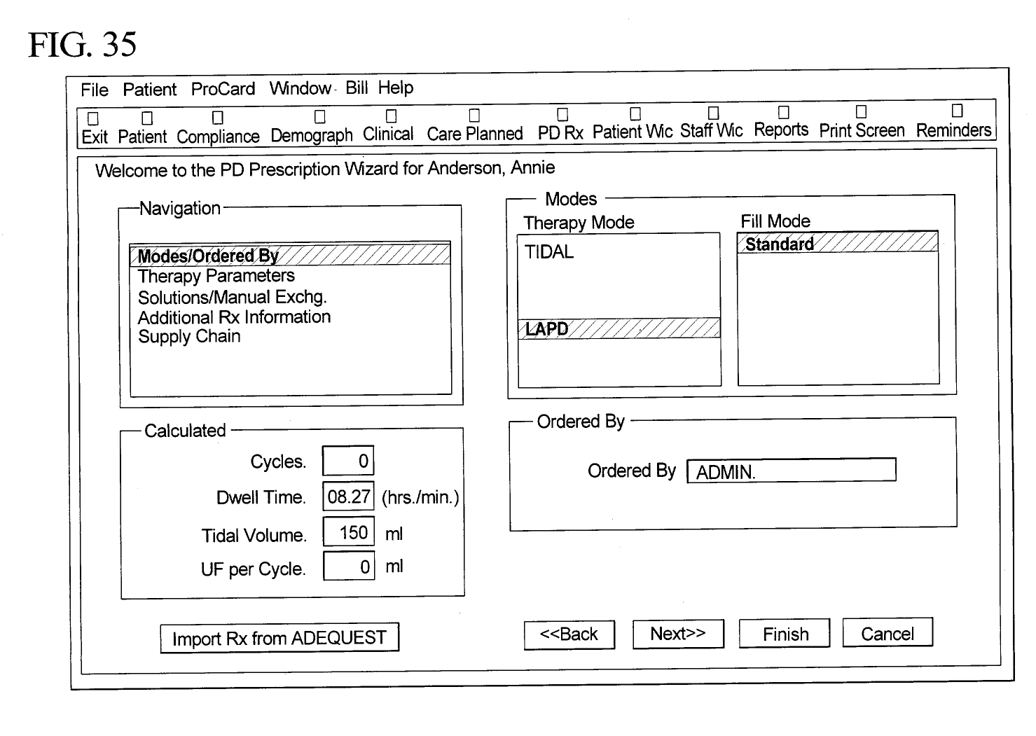

In a first step, the user selects a therapy mode, fill mode, and an ordering physician. Selection of modes at this point establishes defaults limits for subsequent steps. As a result, work flow inconvenience may be eliminated when the user defines the fill mode changes. As a result, previously entered data may be reset to the machine default for the new fill mode. The user may then be required to return to the first tab and start over. FIGS. 27-35 illustrate the steps that the system 1 and the method 100 of the present invention implement to prompt a user to effect the prescription fill and recording of the prescription within the system 1 and method 100 of the present invention.

As will be further described, the system 1 and the method 100 of the present invention enables a user to digitally assign a patient's prescription and supply chain components and/or send to the supply chain website or otherwise received at the supply chain. As a result, a physician's digital certificate acting as an actual signature is provided for the prescription. To this end, an interface may be provided between the system 1 of the present invention and various supply chain systems to effect home patient ordering and delivering of prescriptions. Each system may include a variety of applications and/or interfaces. First, country specific rules may be provided in an application to enter and maintain rules specific to each country at which a supply chain may be used to effect completion and/or delivery of a prescription. Data maintained in the application may include a country identifier, whether a prescription is required for an order to be generated, whether a digital signature is required on a prescription, a level at which a digital signature may be required, and whether a physician identification exists.

Another application may include unit registration and may allow a dialysis center or a supply chain to register and maintain information unique to their business. To this end, a web-based front end may be provided to register and manage unit specific data. Data entry may be used for initial sign-up to the supply chain. The front end may also prompt the user to set up the information and download a list of patients associated with the unit. An interface may be provided through the supply chain systems to retrieve a list of valid entities associated with the system. Further, an interface with the supply chain systems may be provided to retrieve a list of positions associated with the center. In addition, an interface with the supply chain systems to retrieve a list of patients associated with the center may also be provided with the unit registration application.

A patient enrollment interface may be provided that allows for the automated initiation of new patient enrollment subsequent to update of the supply chain systems. A patient enrollment interface may include updating supply chain address book information regarding patient enrollment. A module may add new patient name and address information to the supply chain database. Further, the patient enrollment interface may include update supply chain patient activity information that may add information to the supply chain database that may be necessary to complete a transaction. In addition, the patient enrollment interface may update supply chain patient demographic information available at the time of enrollment and maintained in the supply chain system. Further, initial supply chain prescriptions may be created within a supply chain system. Initial orders may be generated and acknowledged using predefined distribution methods and recipient lists that acknowledge that the order was created.

A product prescription management interface may also be provided. The automated processing of updates to patient's product prescriptions in the supply chain system may be performed from initiated events. An inventory management and replenishment order generation interface may be provided for the automated updating of patient inventory in the supply chain system from transactions previously initiated or from, for example, an external hand-held device. A replenishment order and order acknowledgment may be automatically triggered, at least upon defined inventory levels.

Still further, a patient management interface may be provided to update patient information in the supply chain system from previous transactions. Patient address book information, patient gain/loss information and patient demographic information may be updated and the interface may be built upon the patient enrollment interface. Synchronization between the supply chain and previous systems may be ongoing and allow changes initiated in the supply chain system to be communicated. The interfaces, patient name and address changes, mode of treatment changes, patient and activation and product prescription changes may also be provided.

The system of the present invention may download formatted transactions to a transmission layer for eventual processing in a system at the supply chain. Formatted transactions may be imported from the transmission layer for updating of the database. The transmission layer may facilitate processing of transactions between the supply chain system. An application server and associated code for the web application is built as a front end to the transmission layer. A database facilitates the storage of data as the data is passed through the transmission layer. Procedures may be stored and/or activated to initialize, extract, format and transmit data in and out of the transmission layer. A standardized method for formatting data passed to and from the transmission layer may be provided, i.e. SNTP, ASCII, or the like.

The supply chain system provides back-end processes to receive and send data to and from the transmission layer. In the supply chain system, file formats may be used in the transmission of data back and forth to the transmission layer; to schedule jobs that may invoke programs that store procedures to receive data from the transmission layer; to apply supply chain business rules and update supply chain databases provided; and to schedule jobs that may invoke programs and stored procedures to extract data transactions from the supply chain databases and send them to the transmission layer.

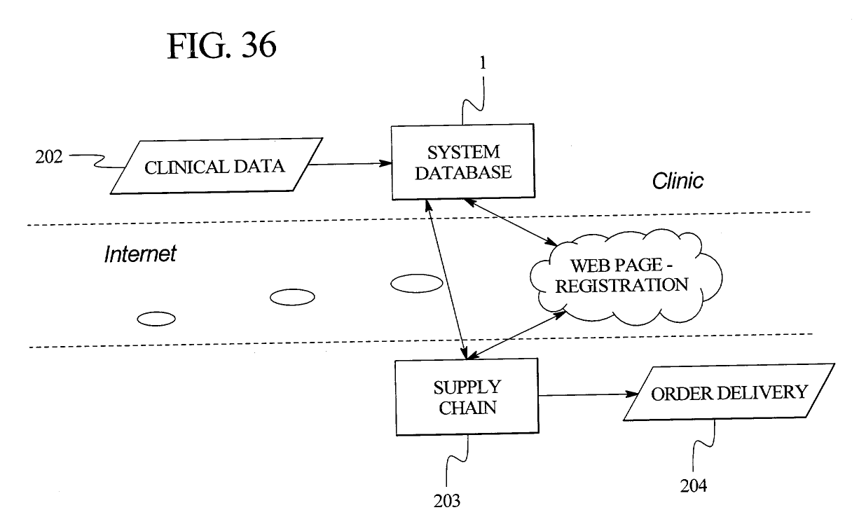

FIG. 36 generally illustrates the supply chain integration between the system 1 via the internet to the point at which supplies are provided and/or sent for delivery. To this end, the system 1 includes clinical data entry 202 to the system 1 of the present invention via the internet or directly to the supply chain 23 to provide information necessary to effect order delivery, as shown at 204. To enroll a patient to the supply chain, such as a home hemodialysis patient, a healthcare professional, a doctor, or the like enters patient treatment information into the system 1 as well as patient and demographic information. Further, a prescribing physician is assigned to the account including “bill to” information. The patient prescription is input which may include capture of an electronic signature. A patient account number may then be assigned, and information regarding the patient may be recorded including the prescription information, or the demographic information of the patient. Then, the patient initial order may be generated. The supply chain patient enrollment and prescription transaction may then be submitted to the supply chain via the Internet or via infrastructure supported at the location of the supply chain.

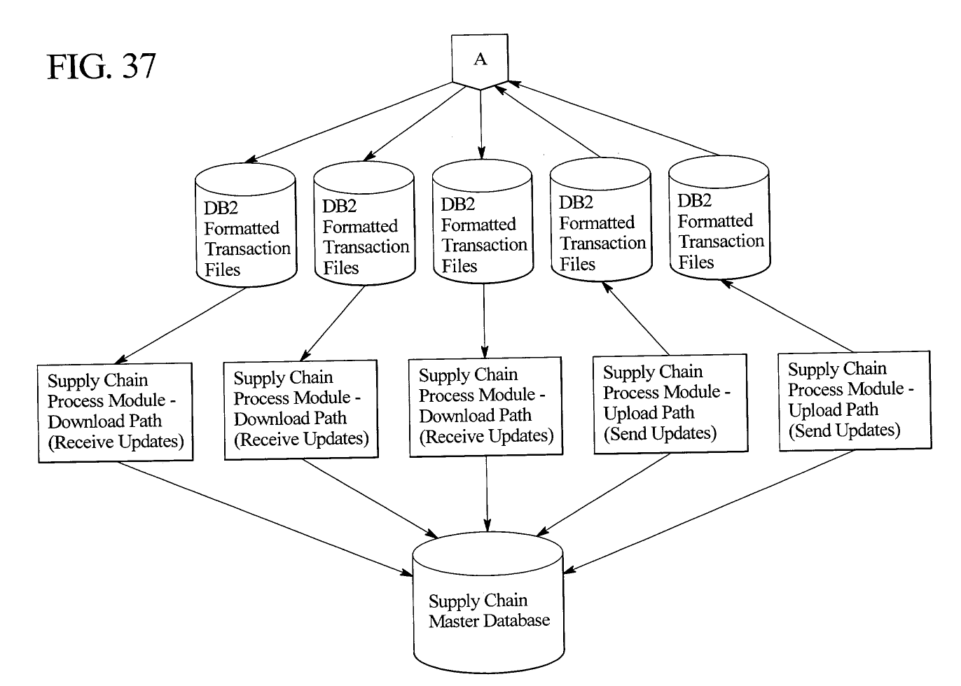

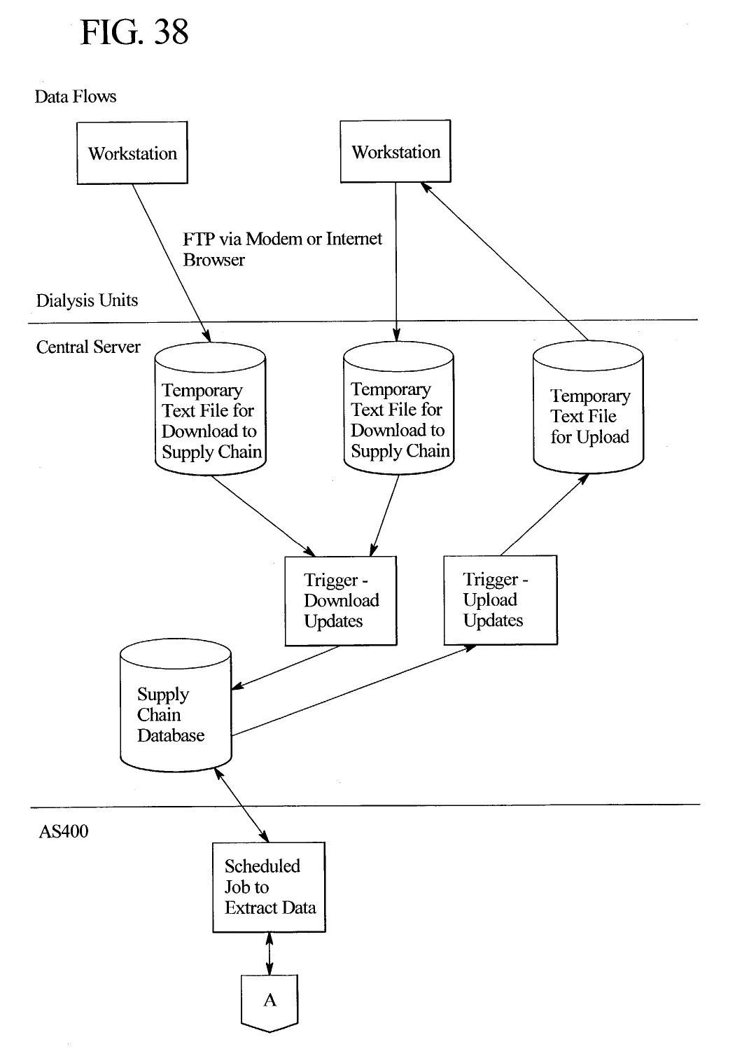

FIGS. 37 and 38 generally illustrate user requirement specifications for effecting delivery of prescription and prescription information via a supply chain.

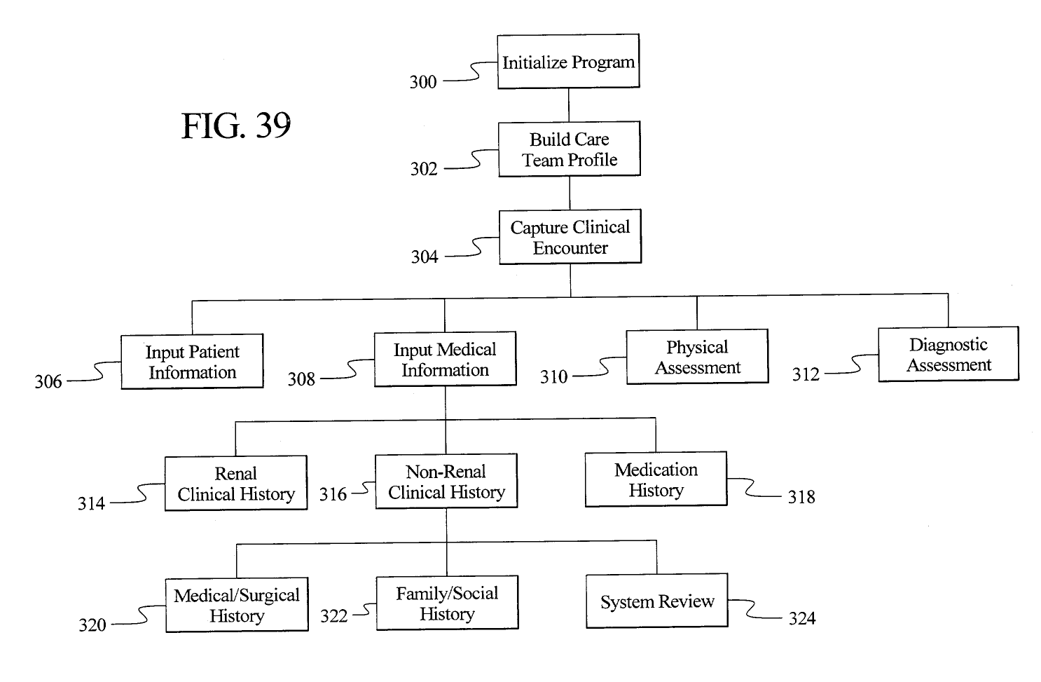

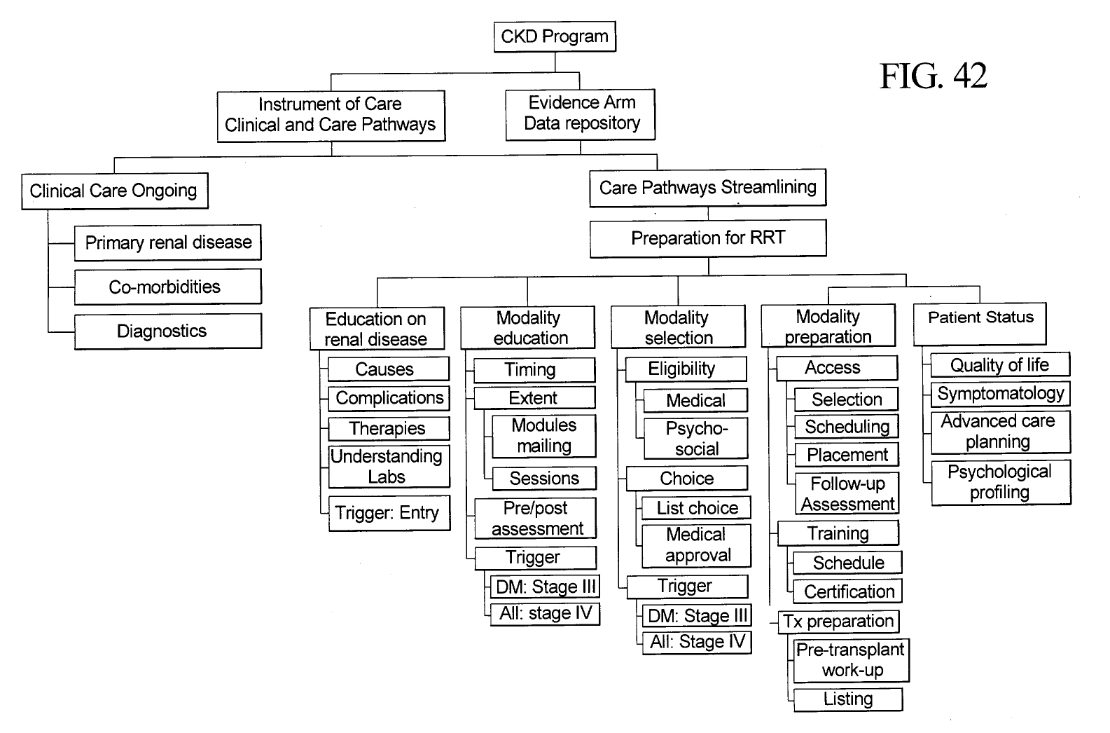

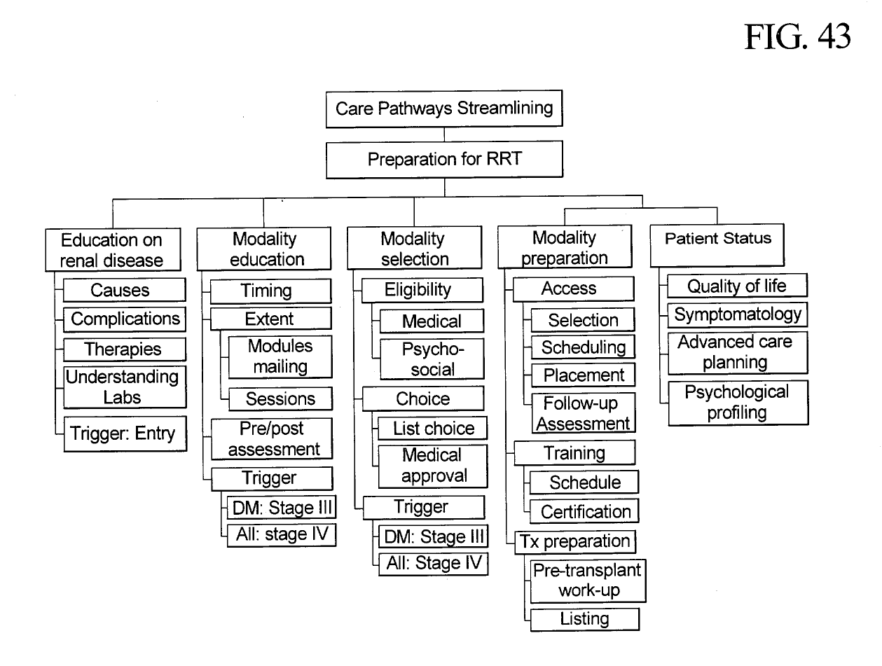

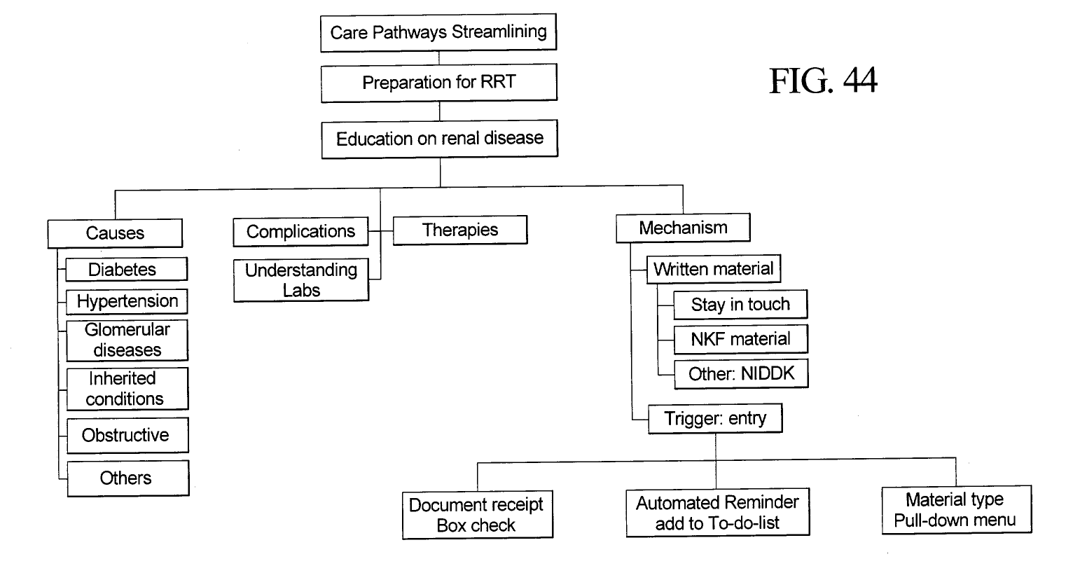

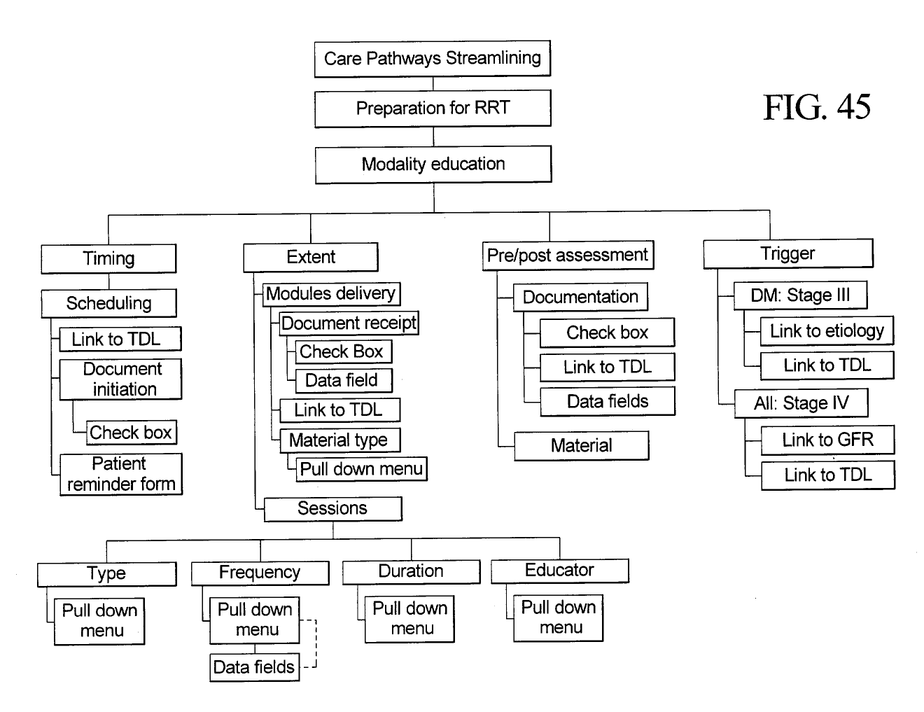

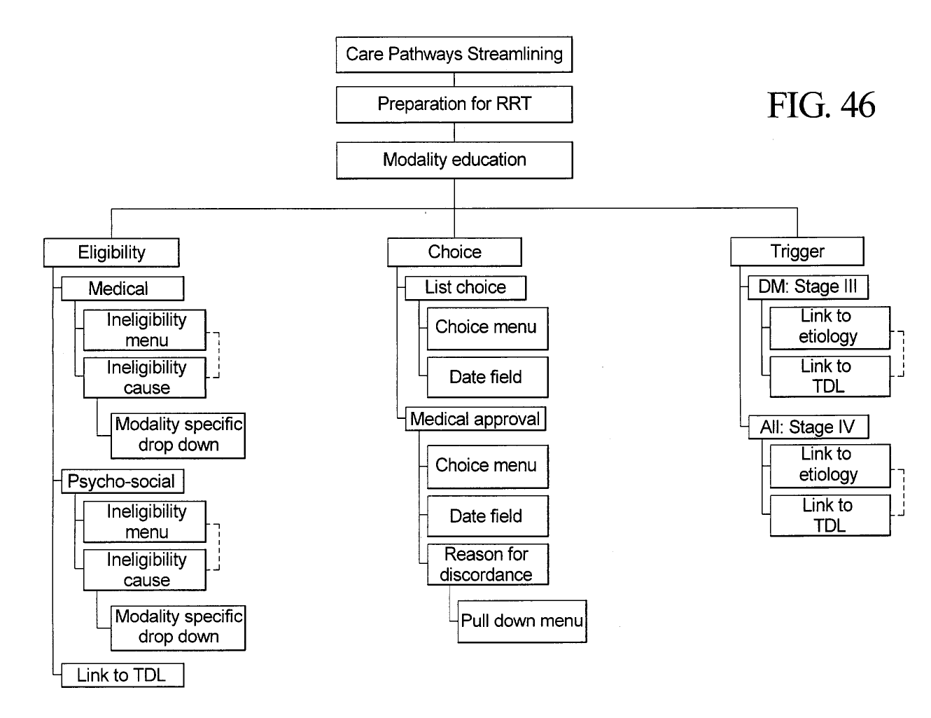

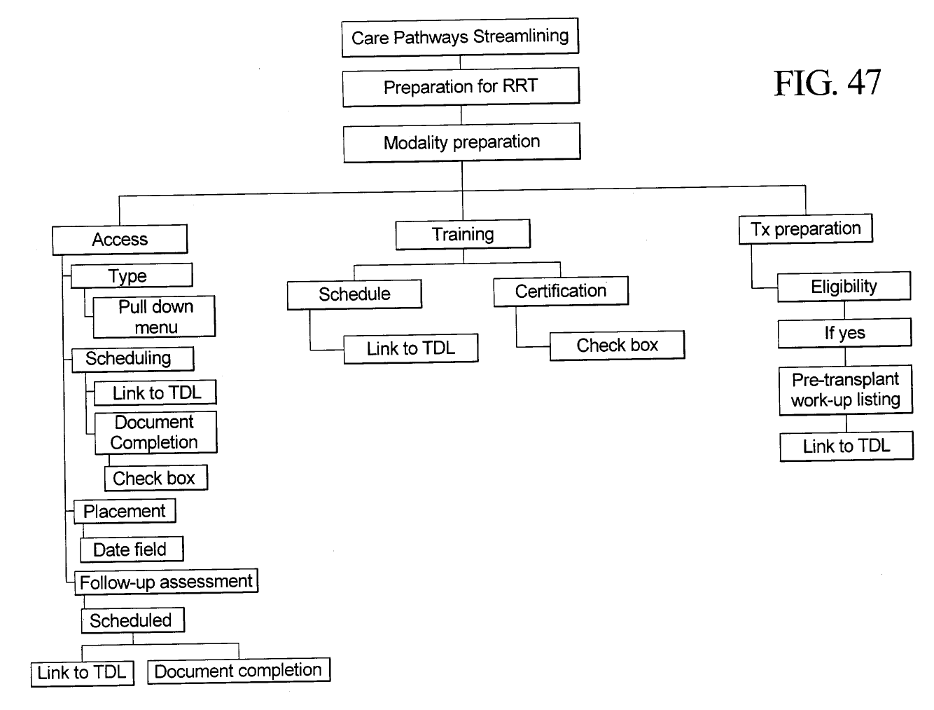

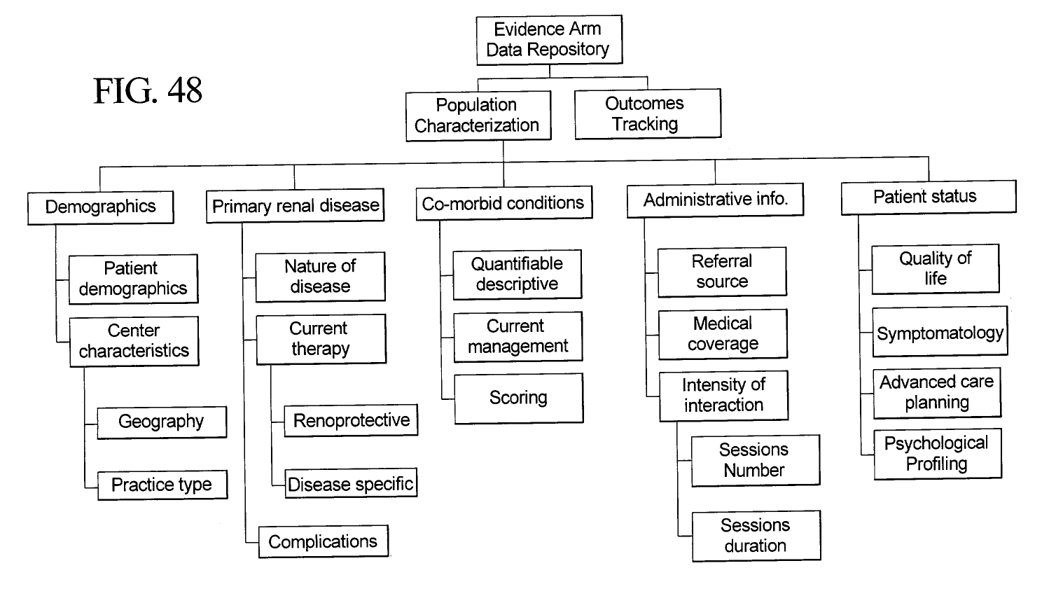

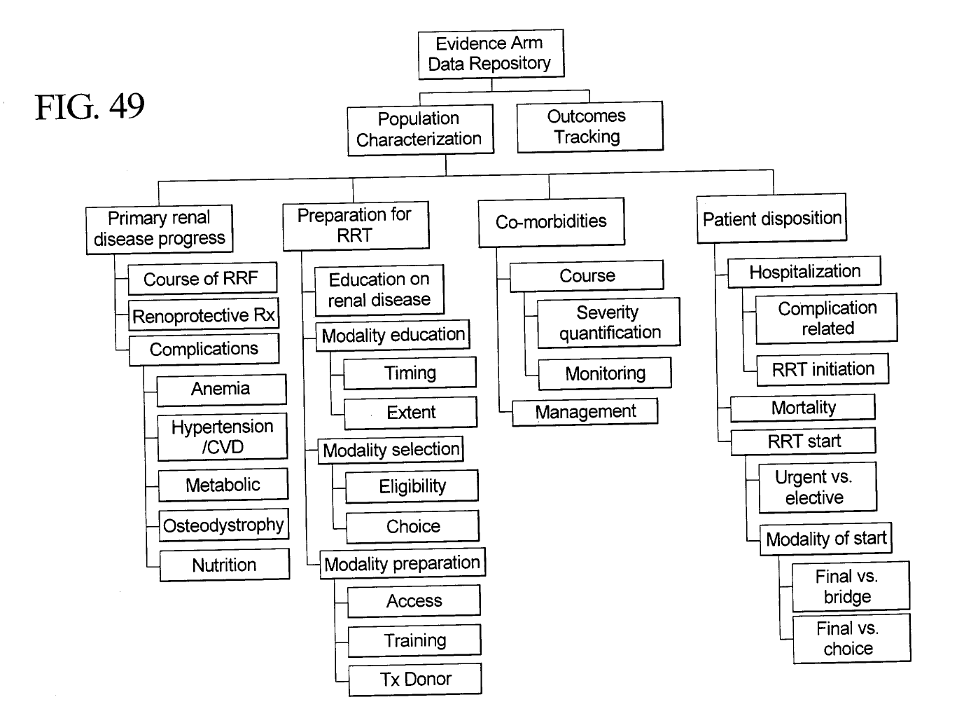

FIGS. 39 to 49 generally illustrate the program architecture for the system 1 and method 100 of the present invention. The architecture shown and described with reference to FIGS. 39 to 49 shows a process from which Chronic Kidney Disease (CKD) patient may be evaluated by a multi-disciplinary team providing care to the patient.

To this end, as illustrated in FIG. 39, a program may be initialized at step 300 to allow the team at a renal facility to be entered to identify the individuals who may provide care to the patient. Individuals become part of a selected care team as identified at step 302. At that time, a clinical encounter, as shown at step 304, follows patient assignment to a physician. The clinical encounter includes the input of patient information as shown at step 306, the input of medical information as shown at 308, a physical assessment as shown at step 310, and a diagnostic assessment as shown at step 312. The input medical information may include a renal clinical history as shown at step 314, a non-renal clinical history as shown at step 316, and a medication history as shown at step 318. In addition to the non-renal history, that information may be further subdivided into medical surgical history as shown at step 320, family/social history as shown in step 322, and a system review as shown at step 324.

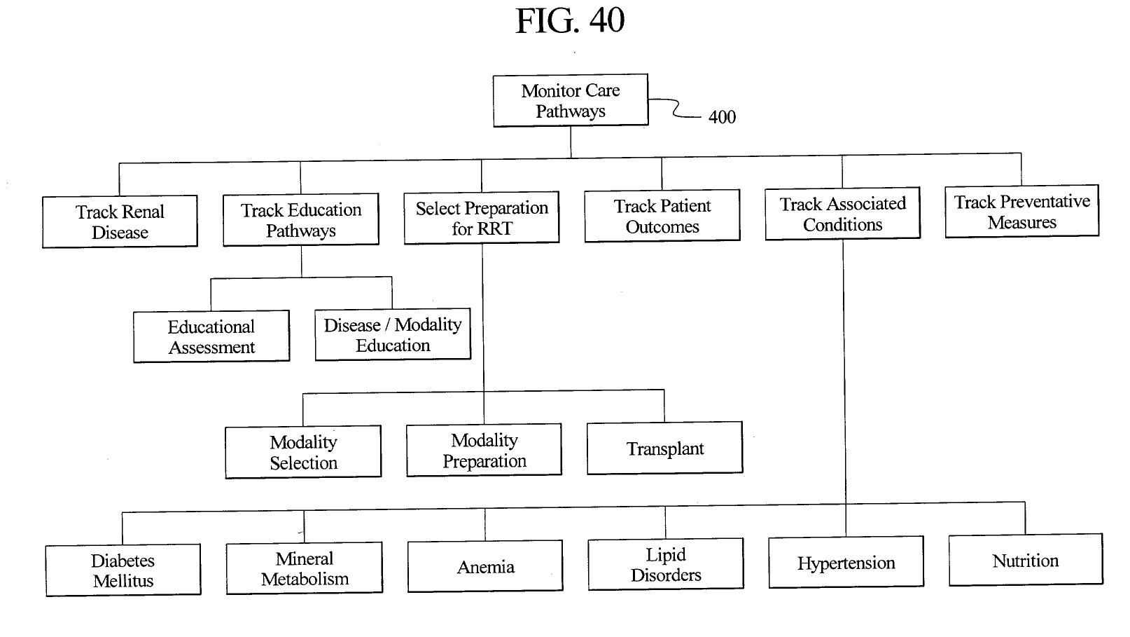

Monitoring of care pathways occurs as shown in FIG. 40 at step 400. Monitoring of care pathways takes pertinent aspects of clinical care of a renal patient into consideration. Each aspect may be reviewed and the needs and/or care of the patients as pertaining to a particular disease state, i.e. anemia, mineral metabolism, and the like may be evaluated. Data may be imported from other areas in the system that apply specifically to the problem addressed. For example, to evaluate anemia, lab values and/or medications which pertain to the doctor or physician or other healthcare decision relating to anemia are imported to a screen directed to anemia. Aspects of patient education may also be included to enhance delivery of education and patient choices as a result of the education.

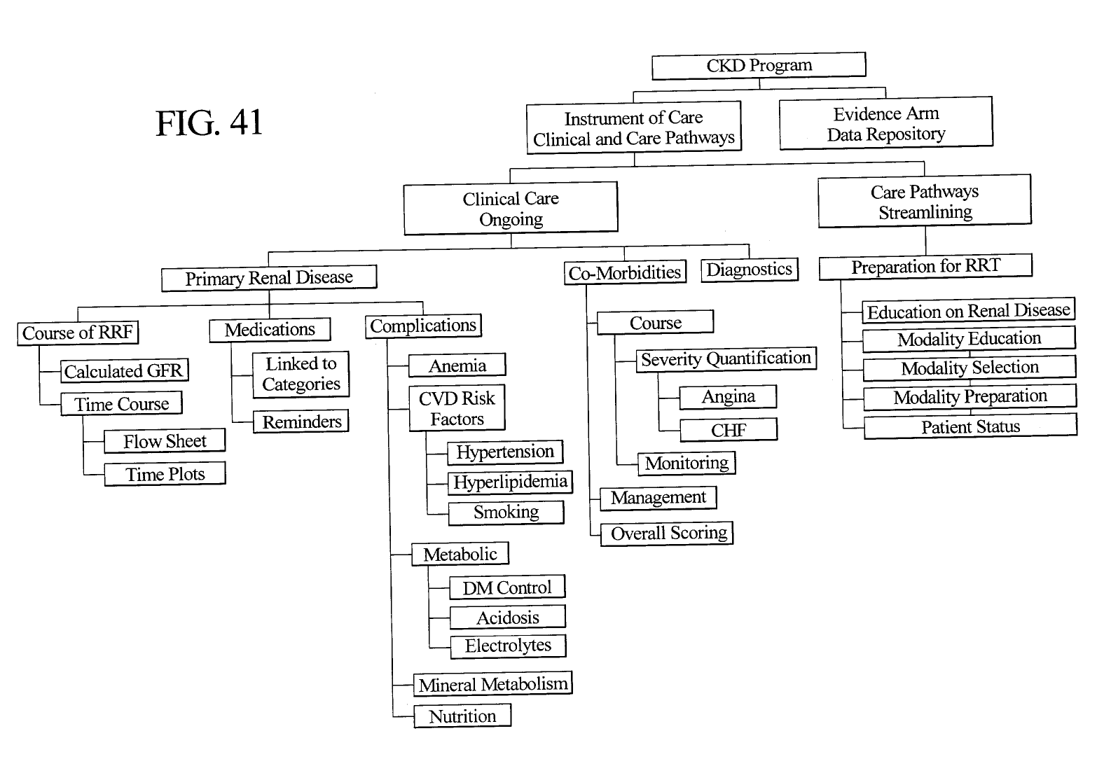

FIGS. 41 to 49 illustrate the specific tracking that occurs through the clinical and care pathways for the dialysis patient. Each of the clinical and care pathways and their respective program descriptions as generally illustrated in FIGS. 41 to 49 will be more clearly described with reference to the subsequent description regarding each of the pathways.

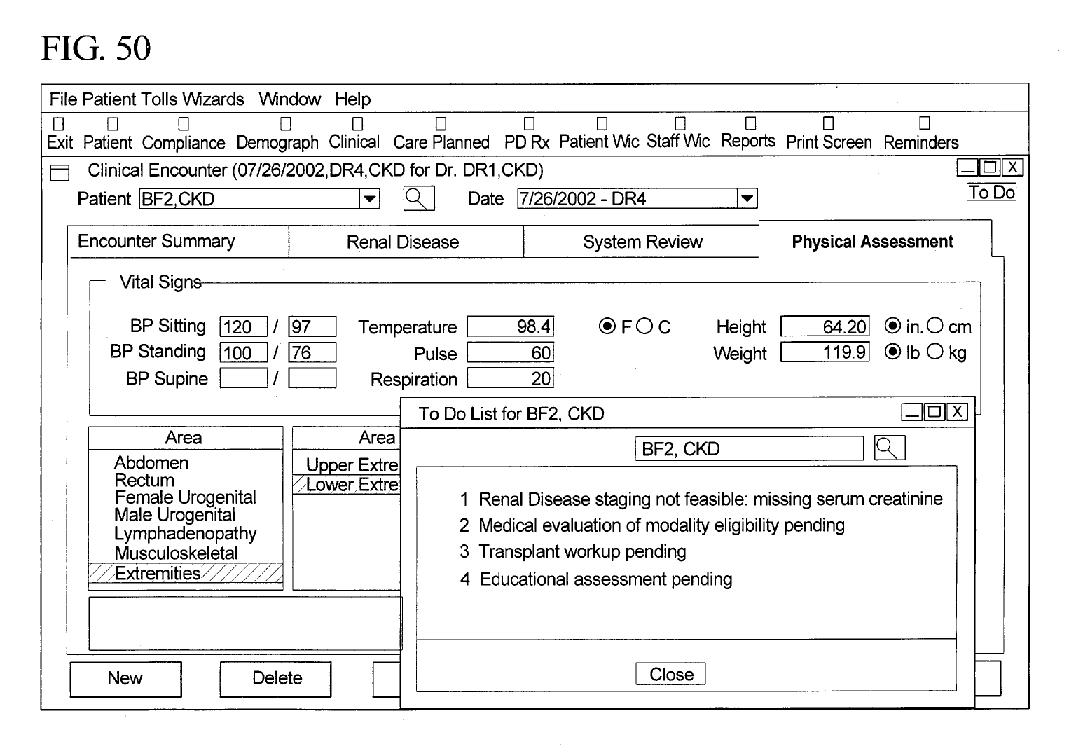

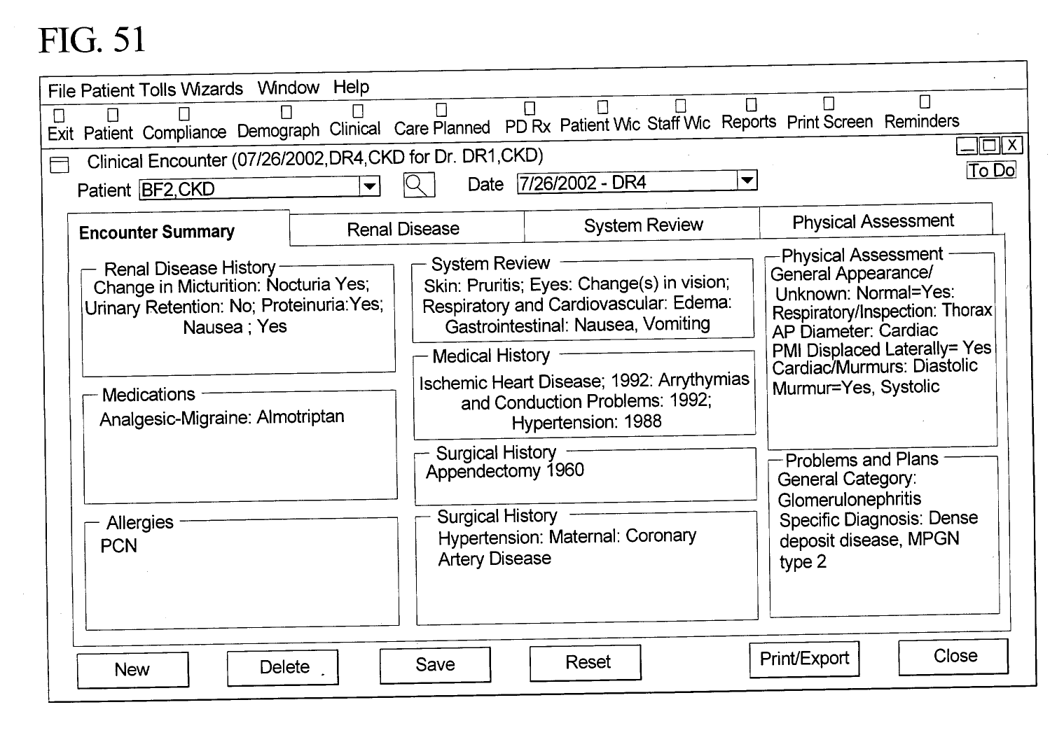

The system 1 and the method 100 of the present invention may also create a “to-do list” indicative of any areas have not been completed. The “to-do list” at a center may be created which may identify a patient or patients that may not have received one or more aspects of care at a particular level or levels of renal function. For example, a list of patients who have reached stage 4 of renal failure and who have not been educated on dialysis and transplantion options may be generated on a “to-do list”. FIG. 50 generally illustrates a screen that pops up as a reminder regarding specific items that must be completed in a “to-do list” format.

An encounter summary screen may also be provided as a summary of medical history and current assessment and data on a patient on a particular date. The encounter summary represents a “snap shot” of a visit of the patient with a particular doctor or medical professional on a specific date and time. The encounter summary may include categories of information relating to renal disease history, medications, allergies and physical assessment. These categories of information may be entered in subsequent pages and may then be printed on the encounter summary page as a summary. The information is historical in nature and may be saved for each visit of each patient. In addition, while previous dates may be chosen in the field after a selection, a summary for the date may be shown. The remaining figures should be considered in conjunction with the architecture shown and described with reference to FIGS. 41 through 49.

A renal disease pathway screen is shown which provides a summary for imported information including renal diagnosis, performed biopsy, lab values and medications pertinent to renal disease treatment or prevention or that which delays the progression of renal disease. The renal disease pathway brings the renal disease related information to a single screen which a physician may review to treat or otherwise evaluate renal disease. The medication list may be viewed by selecting medications on tabs available with the screen. A hyperlink may be provided to link to published guideline sites for treatment of renal disease which may be obtained by selecting the guidelines prompt. The information provided on the clinical pathway for renal disease may include information imported from other parts of the system collected that may be appropriate for the renal disease clinical pathways page. The lab information may be input into the system through a lab interface as previously described and grouped according to the appropriate pathways, such as the renal pathway. The medications associated with the clinical pathway for renal disease may display a medications window and may provide access to the functionality set forth to describe the medications/allergies tabs for a clinical encounter. A guidelines button launches a pop-up dialogue with guidelines for this pathway and links to specified guideline documents. Further, tabs may be provided for renal disease, anemia, diabetes mellitus, mineral metabolism, hypertension, lipid disorders, nutrition and preventative. CKD stage calculations are provided with stage 1 for GFR≧90 wherein the GFR calculations are provided in the renal disease tab. Stage 2 is calculated with 60≦GFR<90; stage 3 has 30≦GFR or <60; stage 4 has 15≦GFR or <30; stage 5 has GFR<15. Calculated fields are present on the renal pathways window, such as, serum chemistries which may display an ion gap, corrected calcium or creatinine clearance. The system 1 and the method 100 of the present invention verify that all units are using the same measure, or the units are converted. Preferably, the nature of the renal disease may be displayed as information from the most recent clinical encounter, and any information from the previous encounter is automatically re-worded to the current encounter.

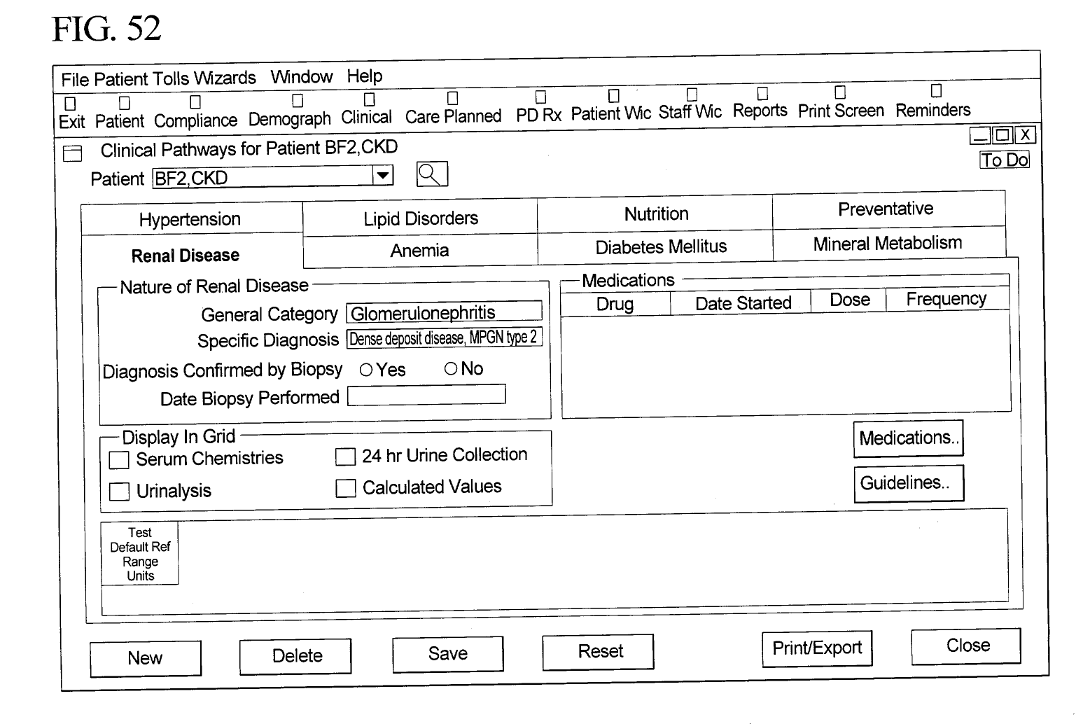

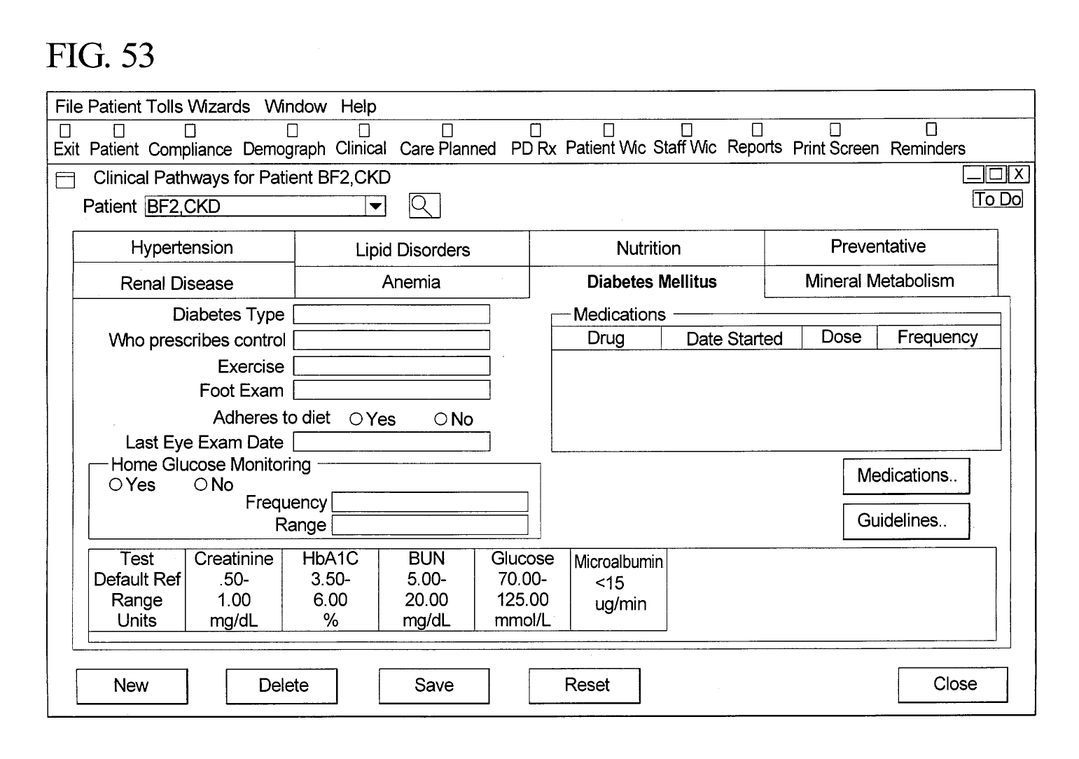

Referring now to FIG. 53, the diabetes mellitus pathway is generally shown with the screen illustrated in FIG. 53. The pathway is a page of imported information and/or manually entered information pertaining to diagnosis and treatment of diabetes mellitus (DM). The imported information may include lab values and medications used to diagnose or treat DM. Manually entered information may be provided to assist with information related to the prescription of DM treatment. In addition, information regarding the patient in treatment, such as glucose monitoring, exercise, diet and other DM related issues including foot care may be provided. The same functionality exists with the tabs in the screen of FIG. 53 as that described with respect to the renal disease clinical pathway in FIG. 52.

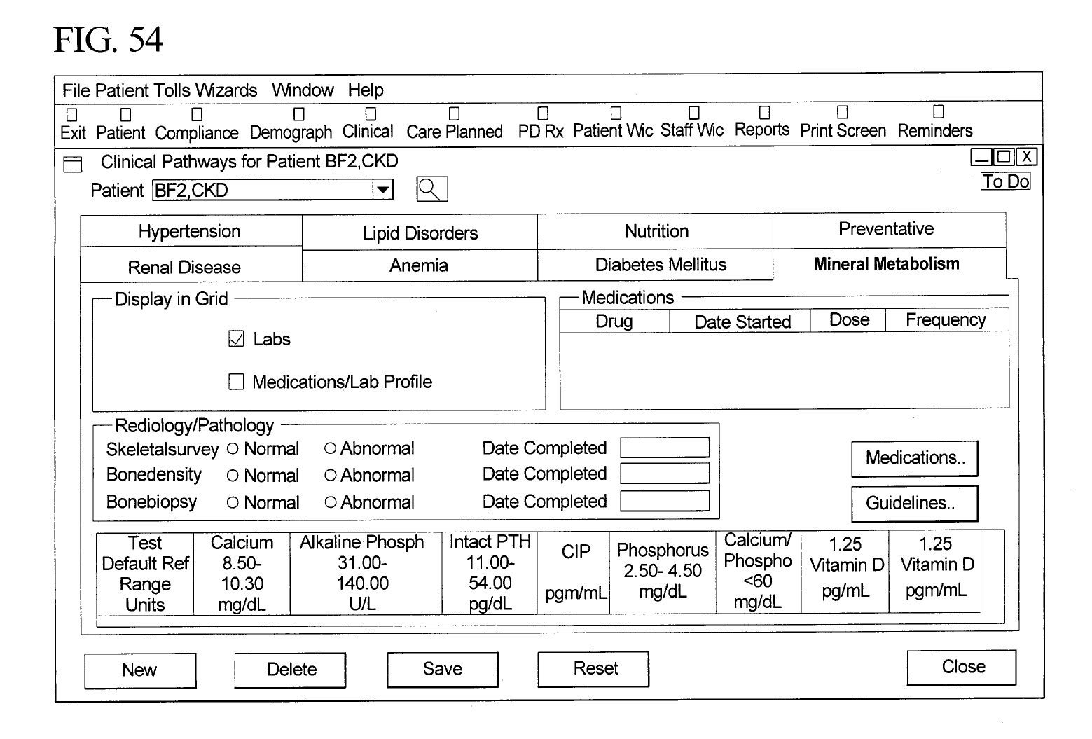

Referring now to FIG. 54, a mineral metabolism pathway is generally illustrated which includes a screen of imported information pertaining to the diagnosis and/or treatment of bone disease in a renal patient. Lab imports include calcium, phosphorus, parathyroid levels which must be maintained to decrease bone disease progression. Medication lists may be viewed in a side-by-side profile to view effectiveness of the treatment. The medication lists may be viewed as well as guidelines and/or sites pertaining to the treatment of bone disease in renal patients.

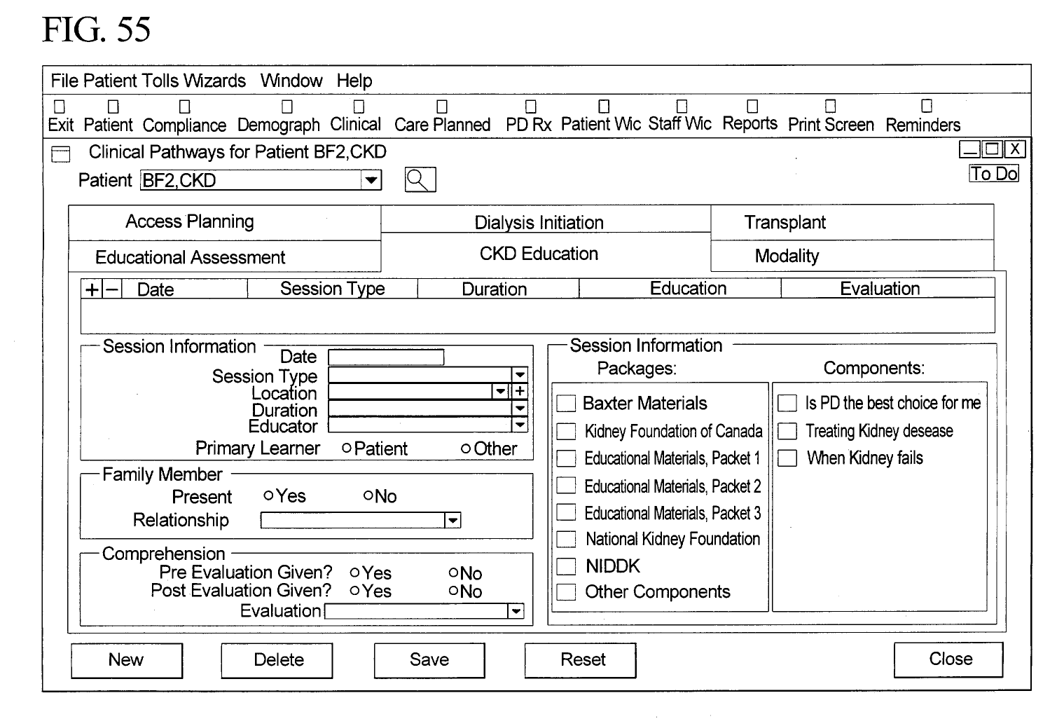

Referring now to FIG. 55, care pathways for education tracking are generally illustrated wherein the doctor or other user or medical professional may track delivery of education by time spent and/or type of session. In addition, parameters relating to the location, participants present, an individual versus group, type of educational materials dispensed, as well as family members and/or partner present may also be input. The screen further provides for tracking of pre-learning and post-learning assessment as a result of the training or education. The navigation link includes a print button that opens a pop-up dialogue allowing a user to select materials for printing. Under the materials discussed, items in each list are selected, a components list may populate with subordinate components and are shown as selected. The user may de-select individual components. Selecting a package removes the subordinate components from the list. Preferably, the grid is sorted in descending date order.

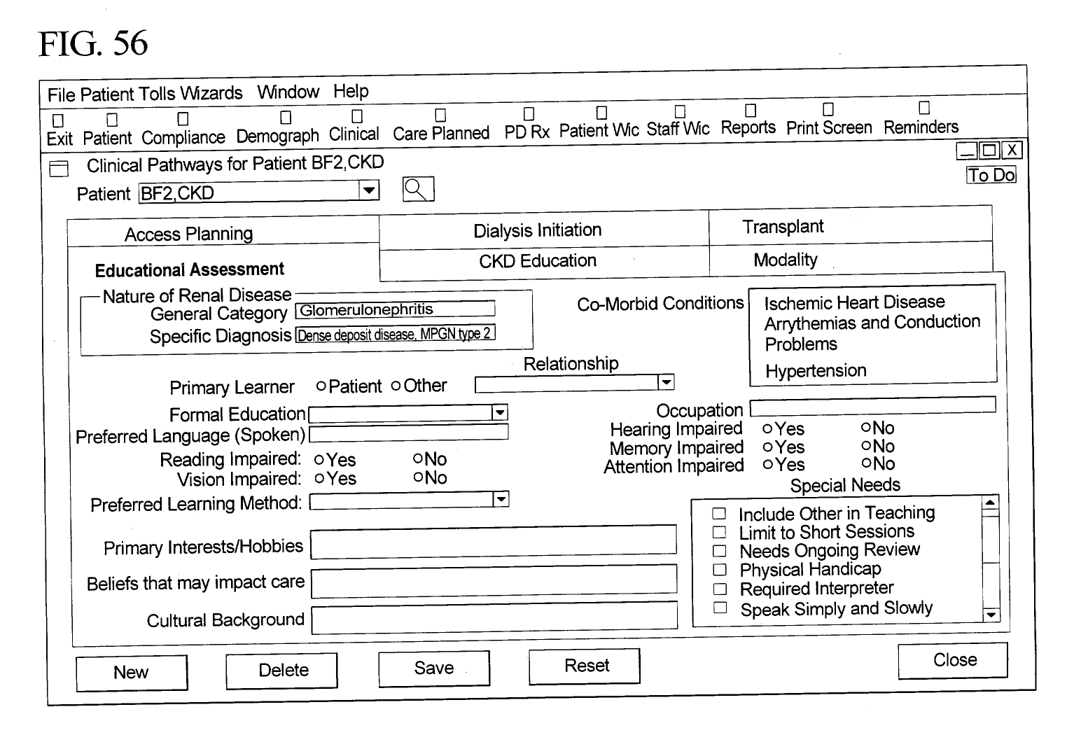

Referring to FIG. 56, a care pathway for educational assessment may be provided that provides information that allows an educator to tailor education towards the grade level of the patient, interests, disease stage, and/or physical deficiencies. The learning methods for the patients may be identified with free text fields within the educational assessment screen that allow the user to identify hobbies, interests and social or religious factors which may impact the education delivery. A number of tabs and/or sub-tabs may be provided in the screen including educational assessment, CKD education, modality planning including eligibility evaluation and modality choice, access planning, dialysis initiation and/or transplant workup. Personnel within a clinic may be restricted to various pathway tabs based on their role within the clinic.

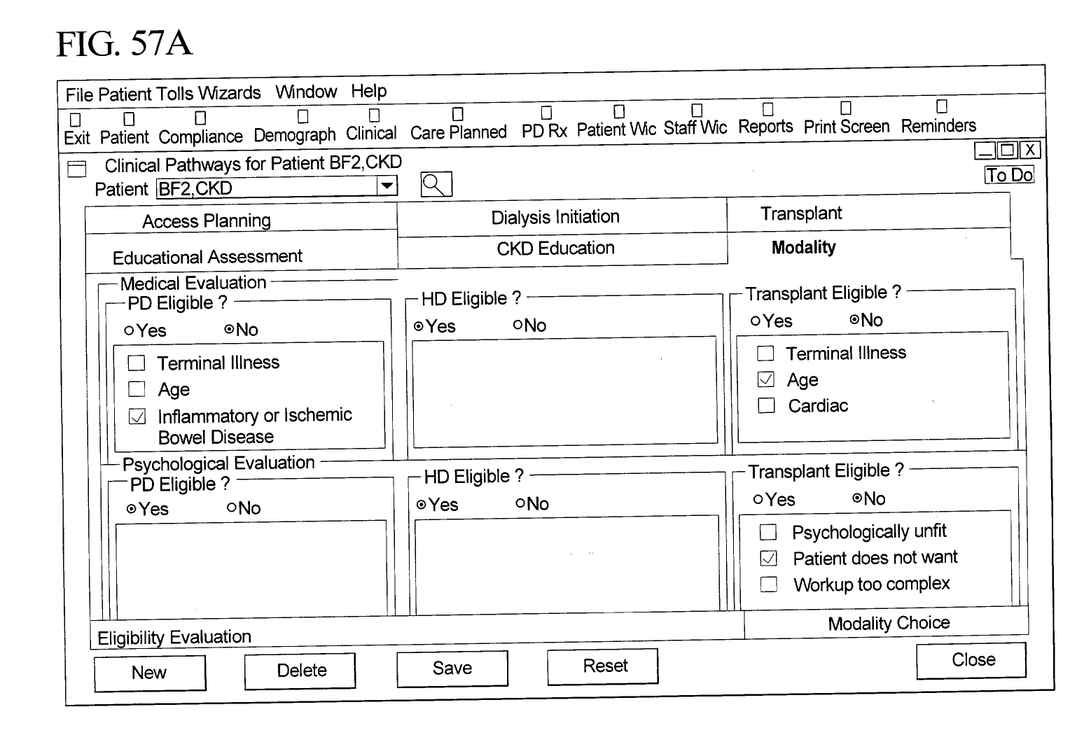

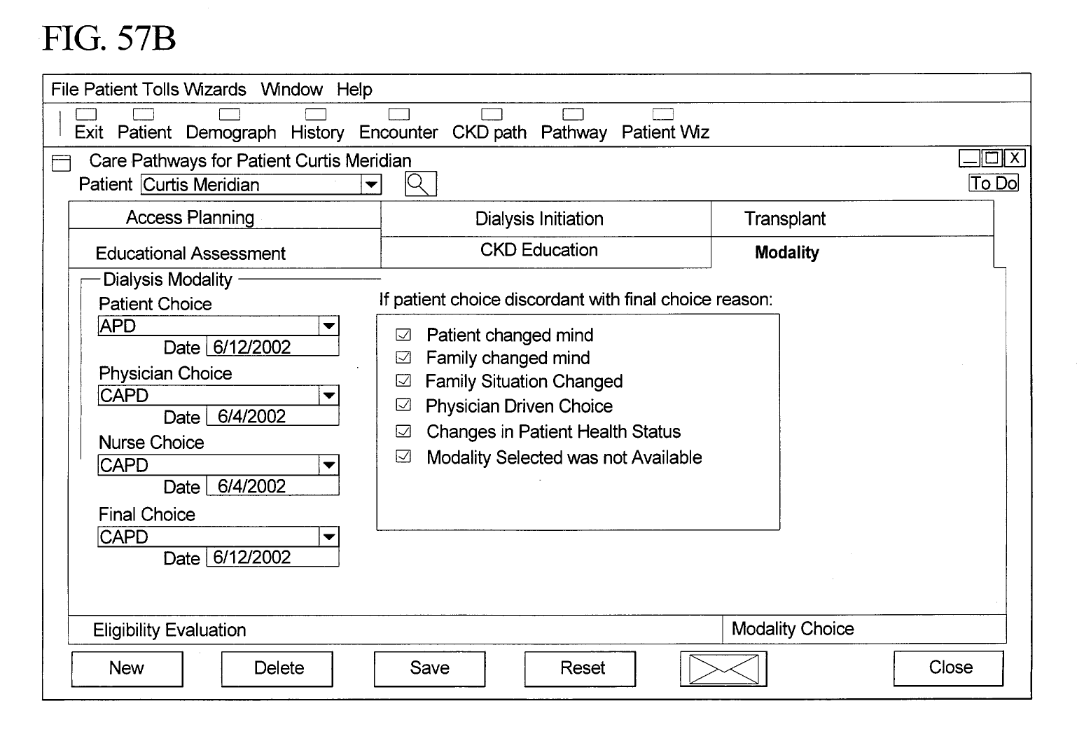

Referring to FIGS. 57(a) and 57(b), a care pathway for modality eligibility and/or planning may be provided via the screen shown in FIGS. 57(a) and 57(b). With respect to FIG. 57(a), the modality eligibility screen allows a clinician or educator to document whether the patient may be eligible for peritoneal dialysis (PD), hemodialysis (HD), or transplantation (T) from a medical and/or psycho-social perspective. Any particular category may be checked “no”, and one or more reasons for eligibility may be prompted by the modality eligibility screen. The information allows the user to monitor patients who may be eligible for therapies who may not be receiving them and/or identifying an issue leaving the particular patients ineligible for various therapies. FIG. 57(b) illustrates the modality choice following the eligibility evaluation conducted with respect to FIG. 57(a).

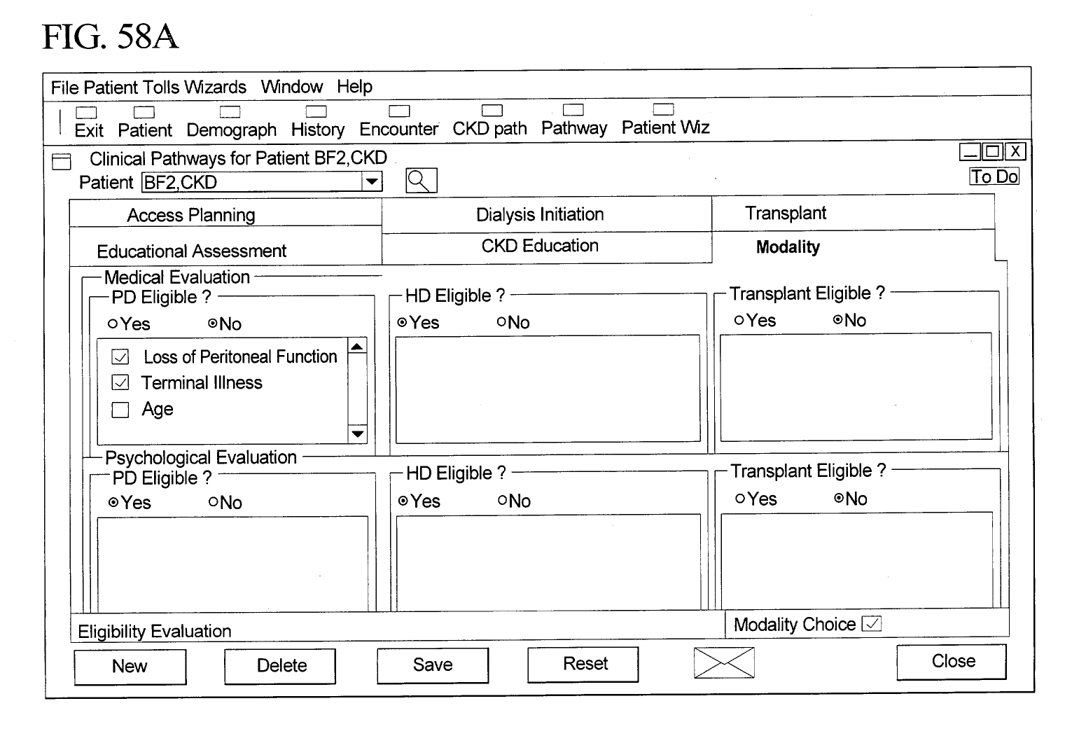

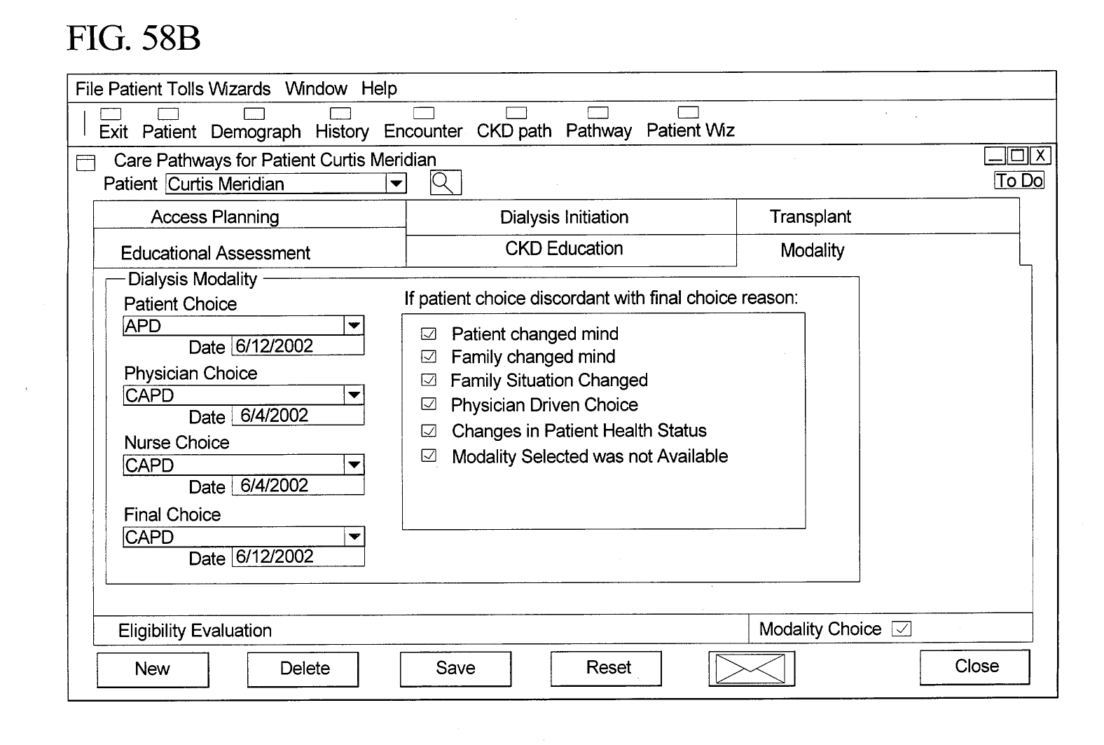

FIGS. 58(a) and 58(b) relate to modality choice including discordant reasons. The screens illustrated in FIGS. 58(a) and 58(b) regard modality choice which indicate the caregiver's opinion or opinions for which therapy should be chosen for the patient based on eligibility criteria or patient discussion. A patient, a nurse, a doctor, or other health care professional has made a choice, and the choice is noted. If the patient and health care choice is discrepant, the reason may be noted. Information may then reveal that the patient or medical professional has a bias or differing choice than the reason, or its occurrence may require determination.

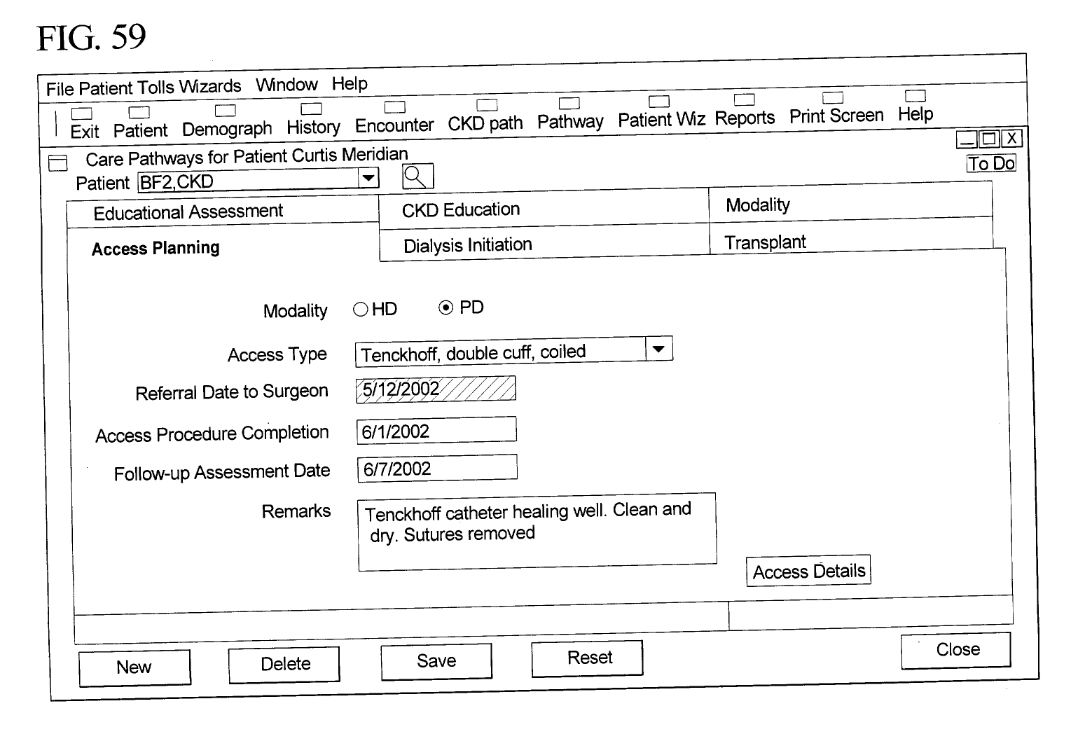

Referring to FIG. 59, an access planning screen may be provided to note the type of dialysis access chosen to be placed. A reference date to the surgeon, when the access is placed, and a follow-up appointment made, may be information provided on the screen. The access planning screen encourages monitoring of the patient for access placement and follows access placement. The text field notes results of patient placement following surgical access placement.

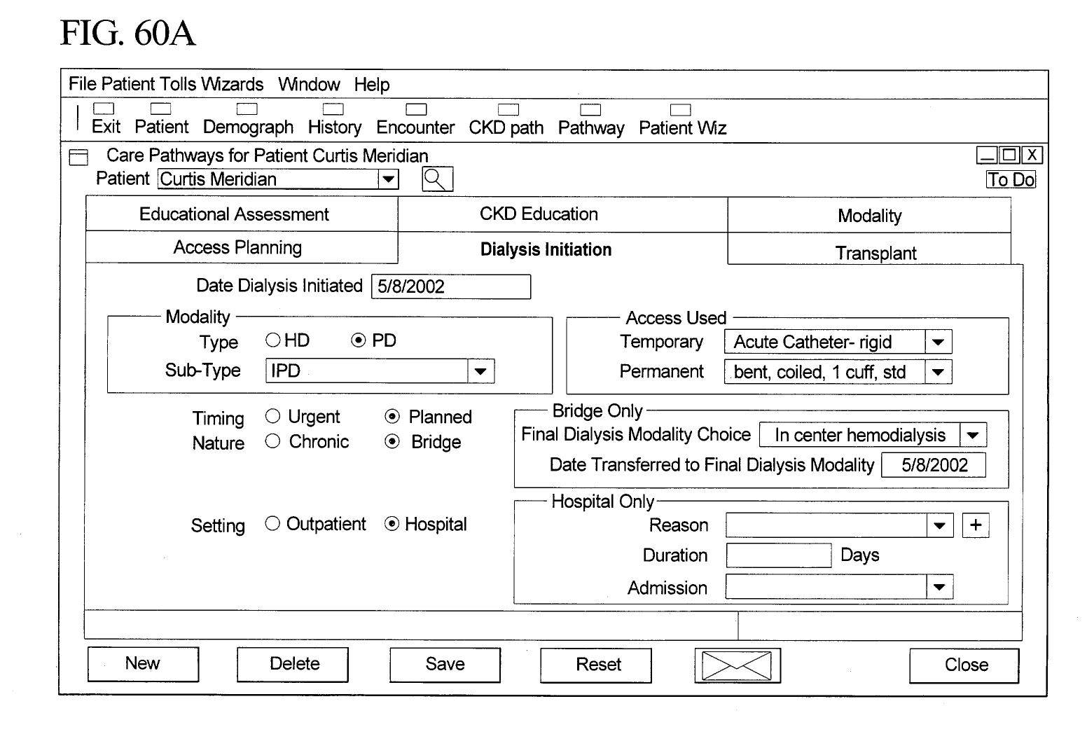

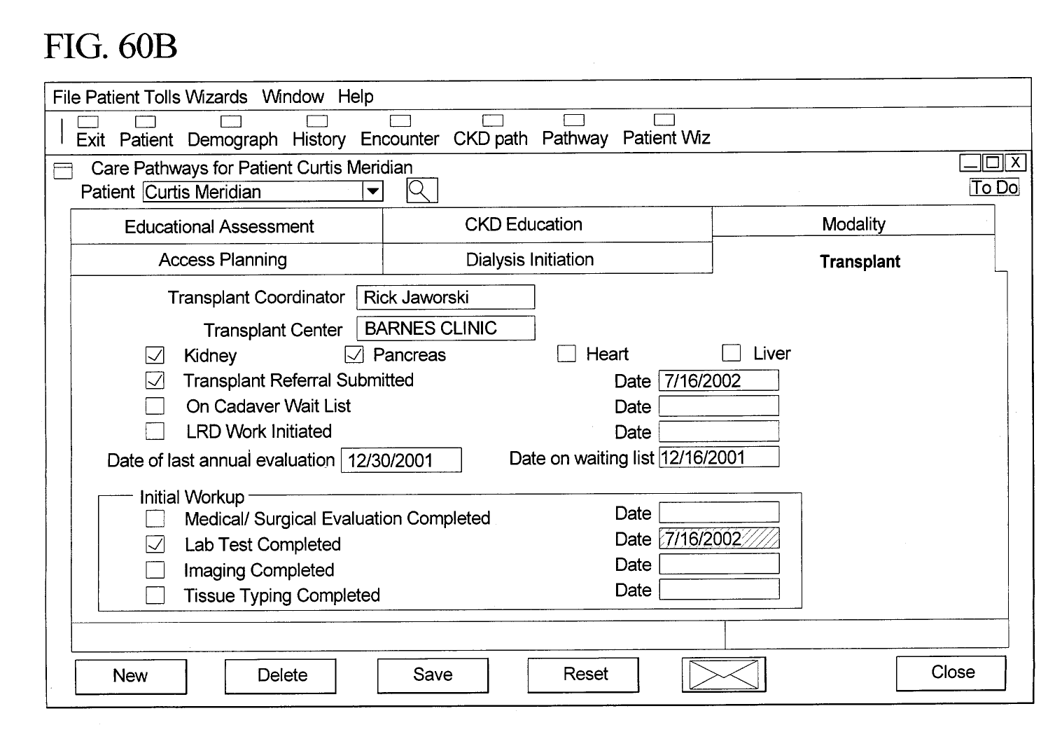

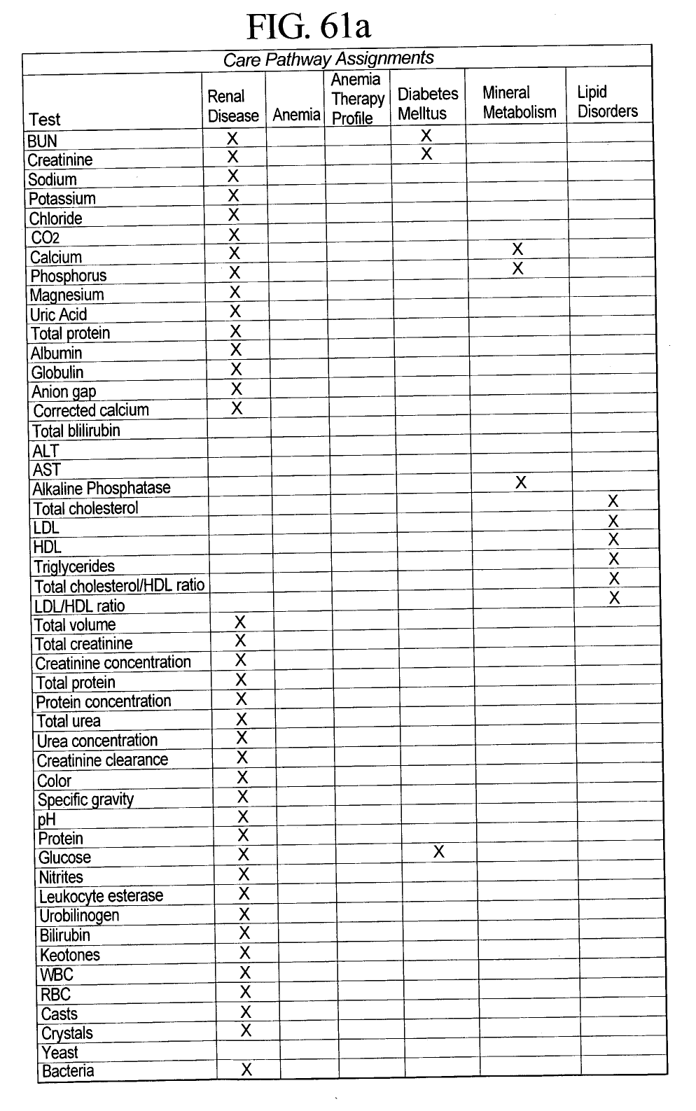

Referring now to FIGS. 60(a) and 60(b), dialysis initiation screens may be provided to track the type of dialysis access being placed and/or whether the access is a permanent type or temporary type. Preferably, access is placed soon enough to heal (permanent access) and tracking of where the access is placed (inpatient versus outpatient) and a place within the hospital where the patient was admitted. FIG. 60(a) relates to modality initiation within the care pathway, and FIG. 60(b) relates to transplant workup. Within the modality initiation, the sub-type depends on the modality type selected. Temporary and permanent access lists under the access used section depends on modality type. Further, a bridge-only panel is disabled if chronic is selected; and the hospital only panel is disabled if outpatient is selected. The final dialysis modality choice may be pre-populated based on the final choice made on the modality planning form. The user may be prompted if they attempt to change tabs without saving changes. Referring to FIG. 60(b), a transplant workup may be identified as complete after a submitted referral has been checked and the date entered. On cadaver wait list may be entered or LRD workup may be checked and date entered; or all initial workup fields checked and dates entered.

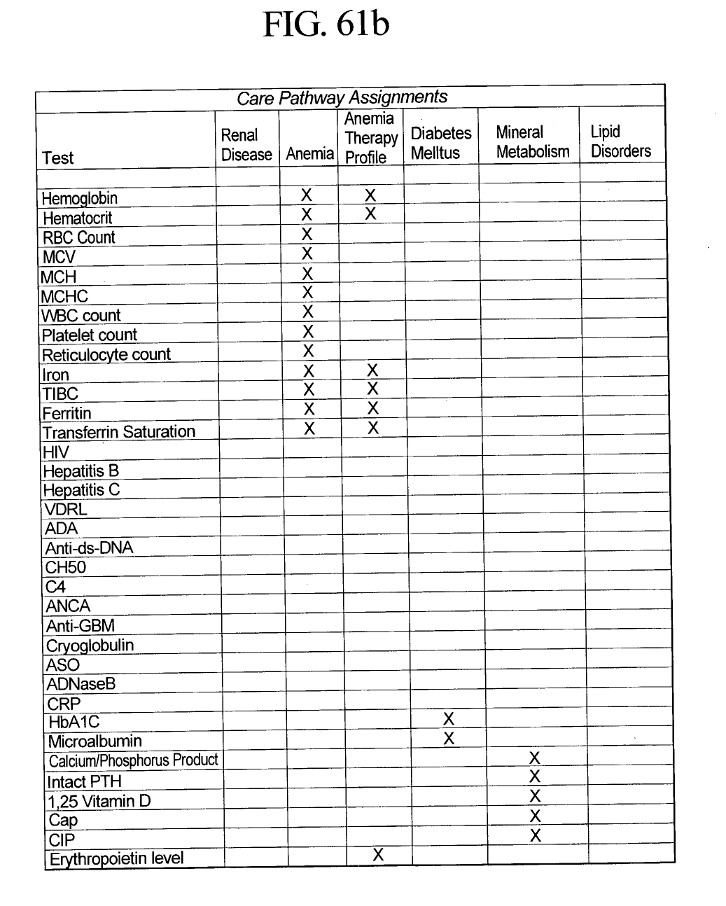

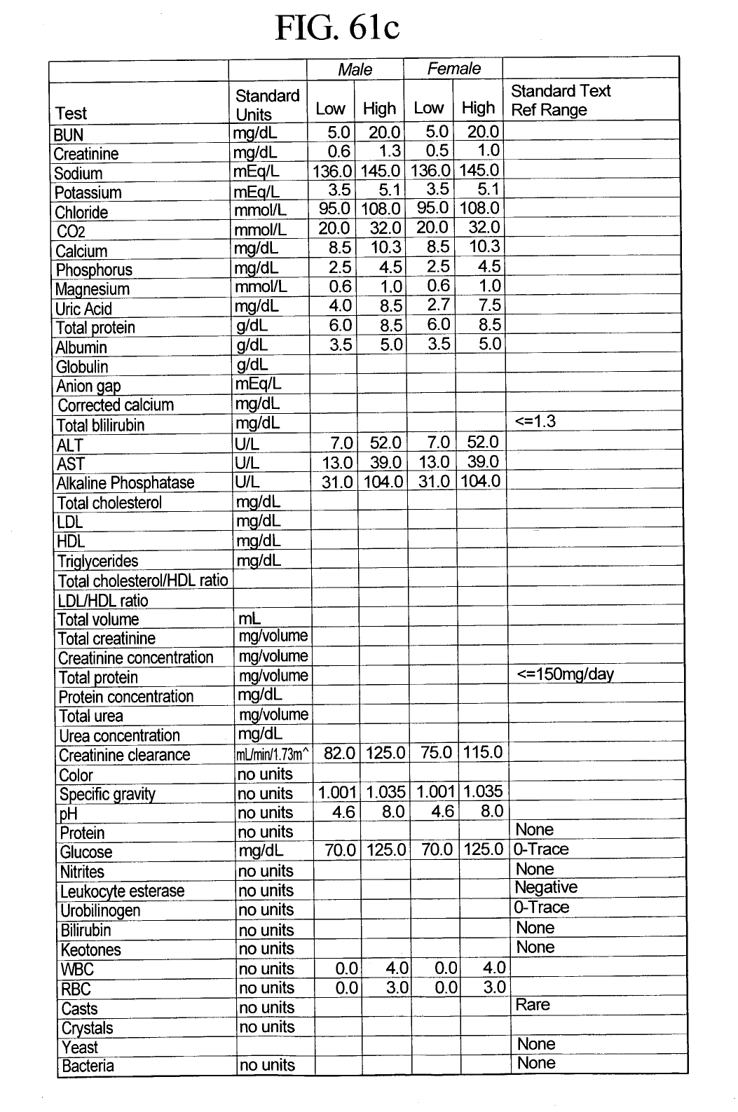

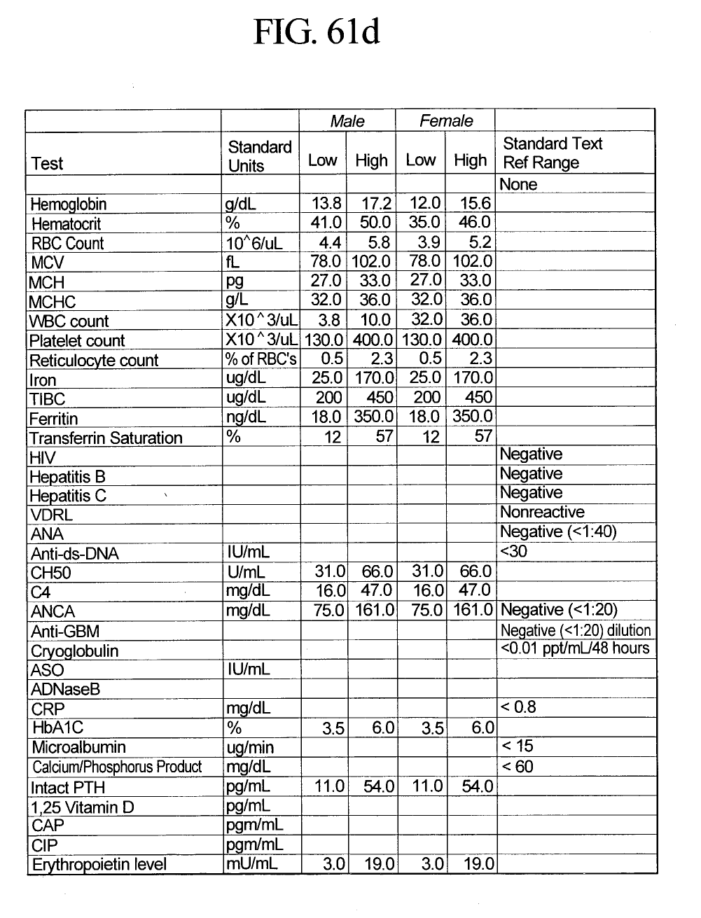

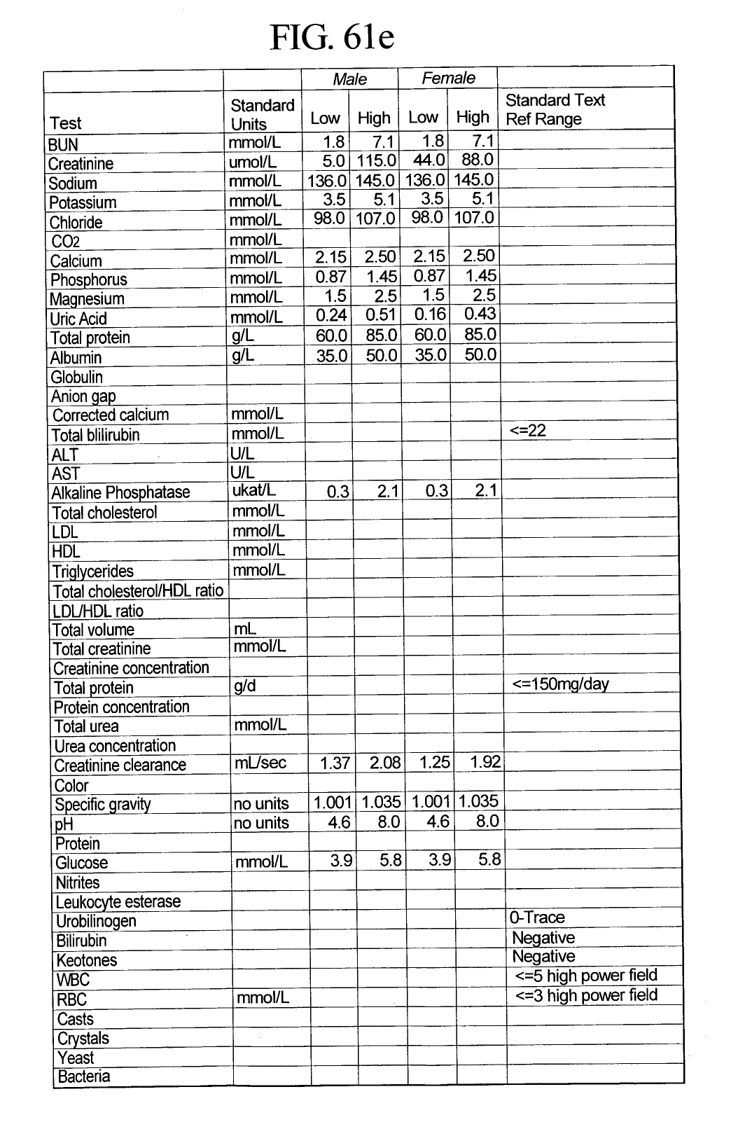

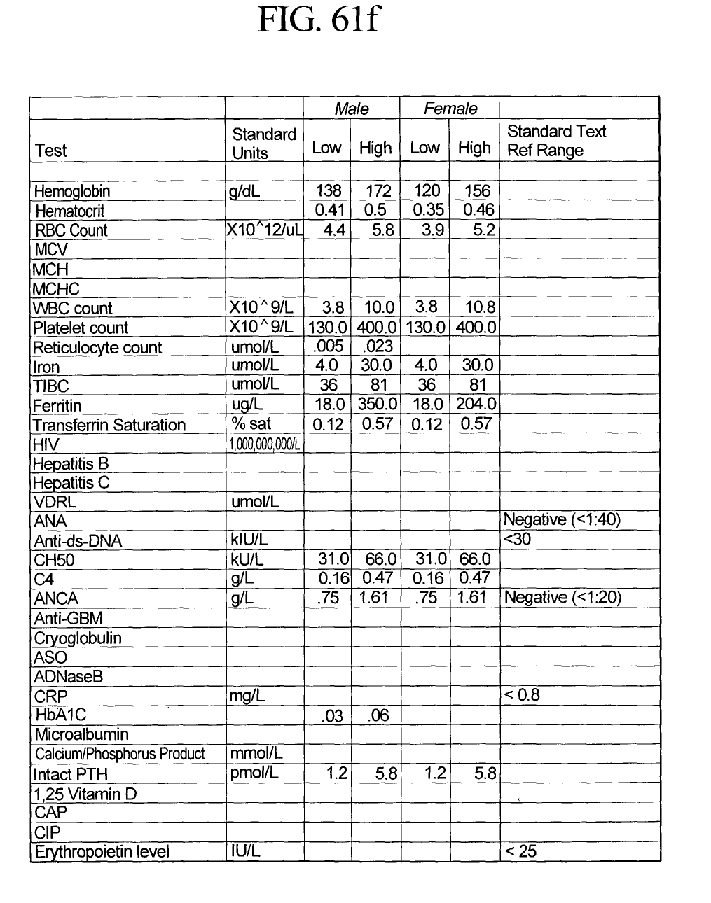

Referring now to FIGS. 61(a)-61(f), charts are illustrated defining various care pathway assignments based on various laboratory results. Laboratory results may then be fed into the pathway as identified in the charts shown in FIGS. 61(a)-61(f) automatically.

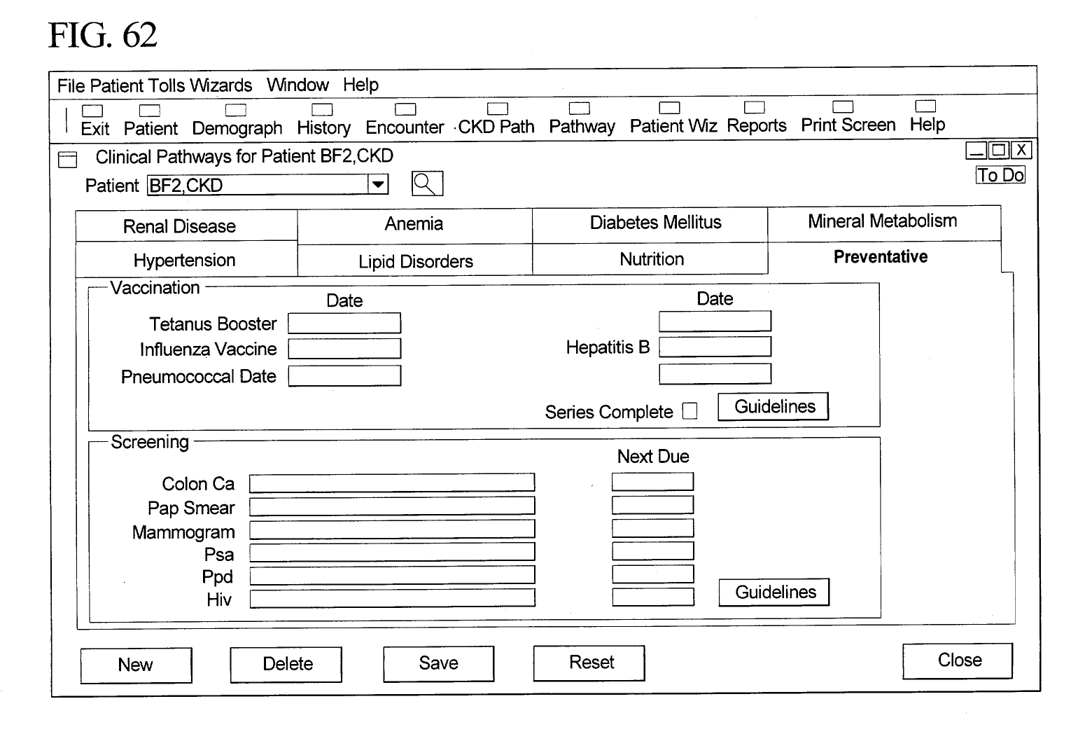

FIG. 62 illustrates a clinical pathway relating to preventative measures, for example, vaccinations and screenings. A date may be entered relating to each vaccination received, and screening dates may be entered for the next scheduled or necessary date to obtain a particular screening.

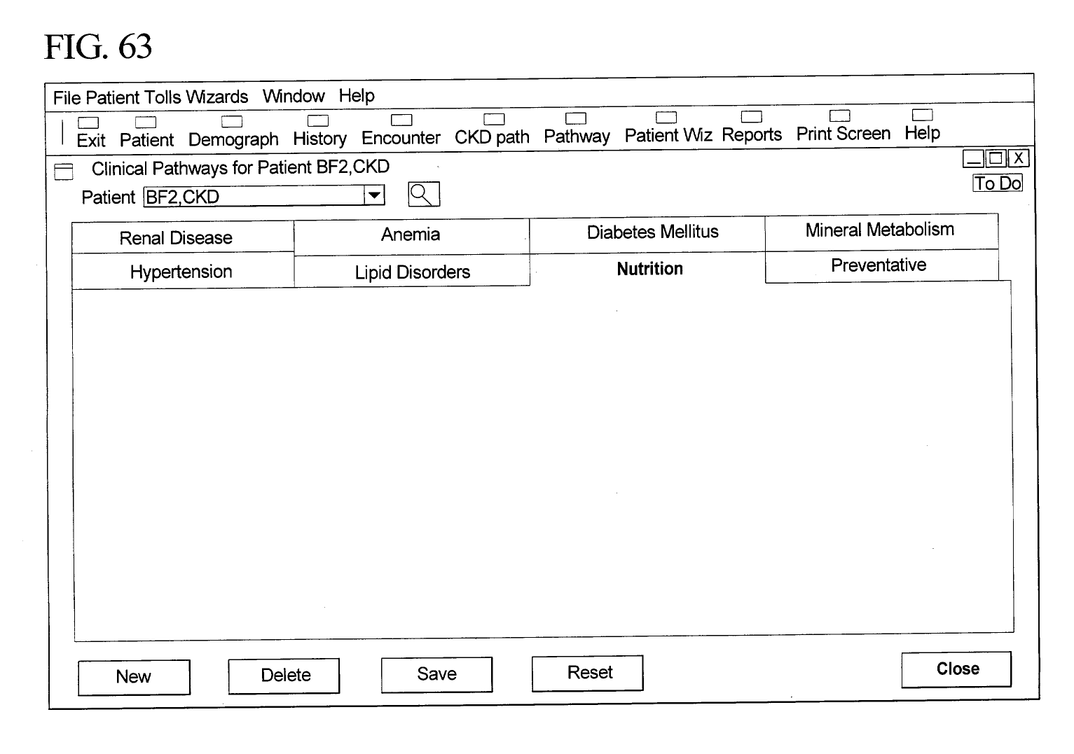

A nutrition pathway is illustrated in FIG. 63 which may include information based on past, current or future nutritional requirements.

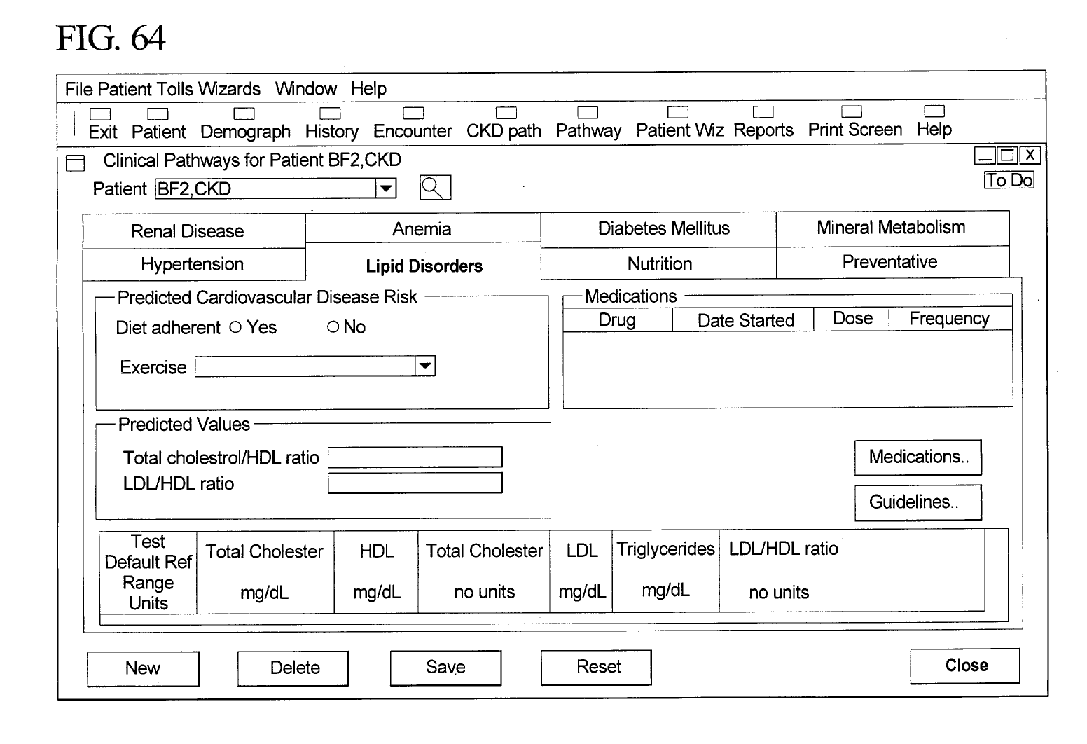

FIG. 64 illustrates a clinical pathway screen for lipid disorders including values for total cholesterol, HDL, LDL, triglycerides and/or LDL/HDL ratio. Imported information may be provided from the medications as previously discussed.

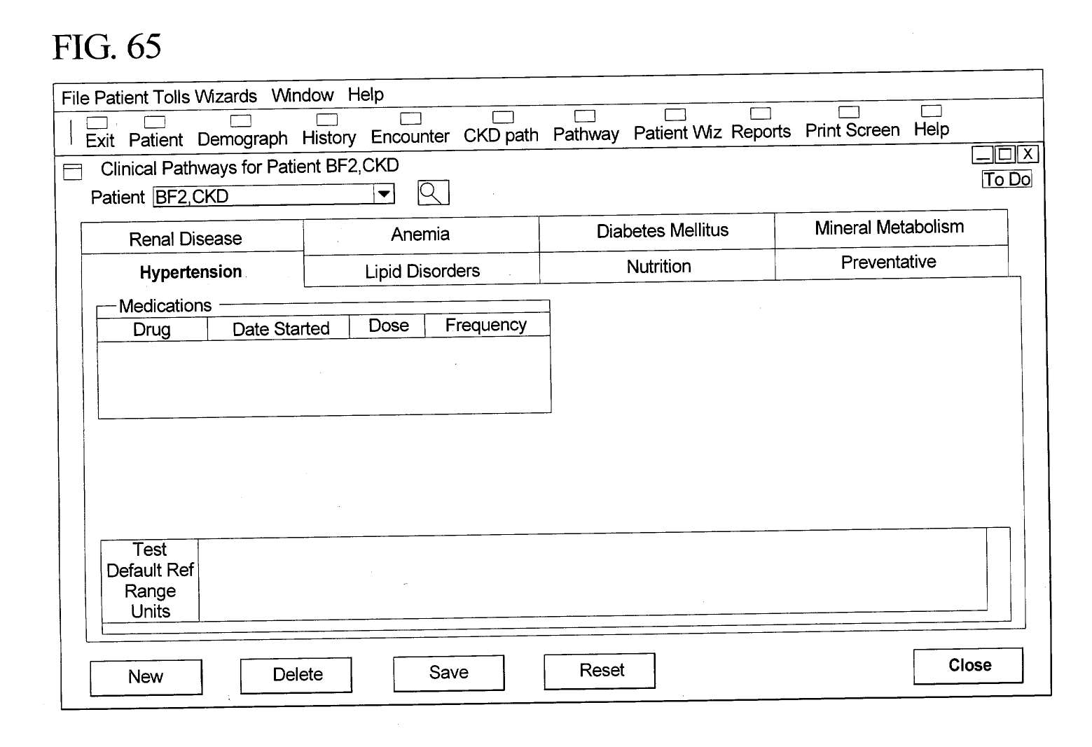

Referring to FIG. 65, a hypertension pathway may be provided which includes text information with respect to any condition related to hypertension as well as any imported or other information regarding medications.

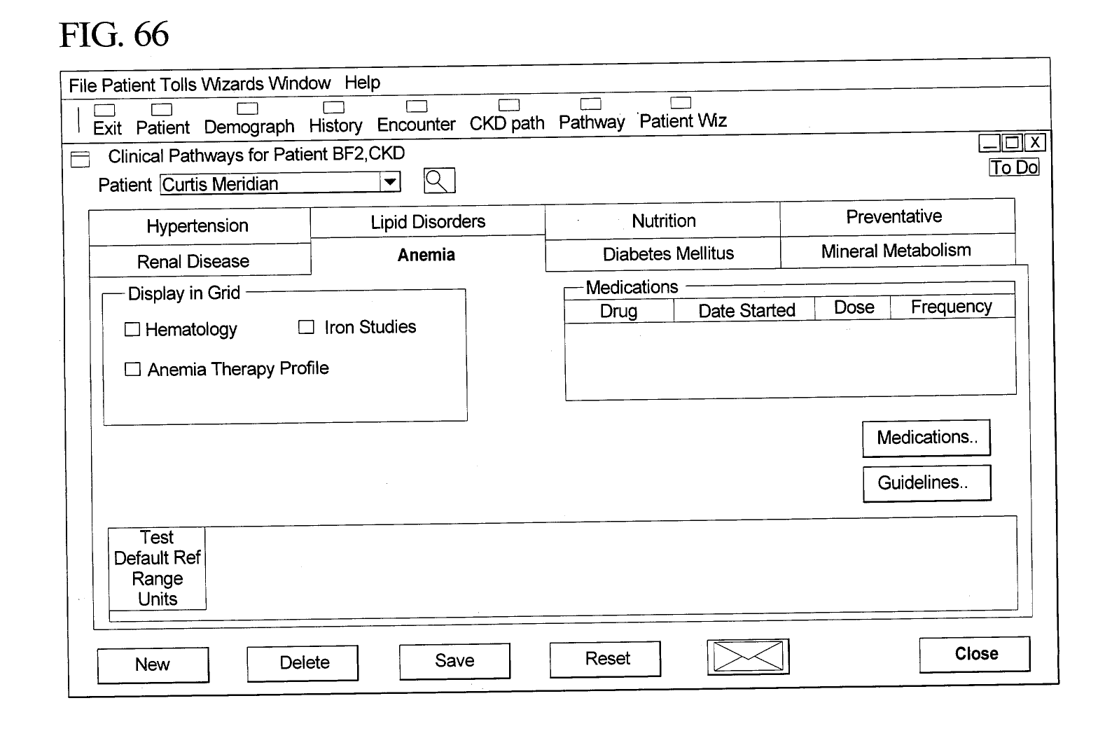

Referring now to FIG. 66, the anemia pathway is imported information from other areas of the software which may be pertinent to the diagnosis and/or treatment of anemia. Information may include lab values such as hematology and iron studies and medications used in the treatment of anemia in renal disease patients. Prescription of medications may be identified by clicking on medications. The guidelines pertinent to the treatment of anemia may also be seen as an appropriate website by clicking “guidelines.” The format of the screen encourages medical professionals to view all aspects of anemia that impact treatment and/or effectiveness of the treatment, such as low iron levels that may decrease effectiveness of erythroeocitic medication. Otherwise, the doctor may review whether blood levels are low while the erythroeocities which may be due to low iron. Various calculated fields may be provided, such as, for example, transferrin saturation, calculated transferrin and calculated TIBC. All units may be converted and preferably conventionally input as required to perform the calculations.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for a user to integrally track a history of a patient undergoing therapy for a disease wherein the disease has a plurality of stages and a plurality of therapies to treat the disease throughout the plurality of stages, the method comprising the steps of:
inputting information into a system regarding the patient; and
inputting information into the system regarding each of the plurality of therapies during each of the plurality of stages for the patient wherein the information is displayed on a plurality of display screens associated with the system.

2. The method of claim 1 further comprising the step of:
establishing a care team for the patient wherein the care team is associated with the patient throughout each of the plurality of stages.

3. The method of claim 1 wherein the disease is renal disease.

4. The method of claim 1 wherein the plurality of stages and the plurality of therapies correspond to at least one of chronic kidney disease, peritoneal dialysis, hemodialysis and transplant.

5. The method of claim 1 further comprising the step of:
remotely receiving the information regarding the patient.

6. The method of claim 1 further comprising the step of:
manipulating data on the plurality of display screens.

7. The method of claim 1 further comprising the step of:
automatically importing data from one of the plurality screens to another one of the plurality of display screens without manual entry to the other one of the plurality of display screens.

8. The method of claim 1 further comprising the step of:
defining a care pathway for the patient based on the information in the system.

9. The method of claim 1 further comprising the step of:
identifying medications for the required patient.

10. The method of claim 1 further comprising the step of:
identifying a history of medications of the patient.

11. The method of claim 1 further comprising the step of:
linking the system to a supply chain.

12. The method of claim 1 further comprising the step of:
linking the system to a prescription fulfillment center.

13. The method of claim 1 further comprising the step of:
linking the system to a laboratory wherein information from the laboratory is automatically imported to any one of the plurality of screens where the information is required.

14. The method of claim 1 further comprising the step of:
defining information regarding the plurality of stages and the plurality of therapies.

15. The method of claim 1 further comprising the step of:
inputting information regarding a center at which the patient receives therapy regarding the disease.

16. The method of claim 1 further comprising the step of:
identifying patient compliance with the plurality of therapies.

17. The method of claim 1 further comprising the step of:
automatically generating a report regarding the patient with the plurality of therapies.

18. The method of claim 1 further comprising the step of:
transferring the patient from a first medical professional to a second medical professional within the system where the history of the patient remains with the system for access by the second medical professional.

19. The method of claim 1 further comprising the step of:
receiving information into the system via wireless data transfer.

20. The method of claim 1 wherein the information includes clinical history of an event related to one of the plurality of stages of the disease.

21. The method of claim 1 further comprising the step of:
providing educational tracking to the patient through the system.

22. The method of claim 1 further comprising the step of:
standardizing a prescription with a template using a medication dictionary associated with the system.

23. The method of claim 1 further comprising the step of:
providing sorting capabilities with the information on the plurality of display screens.

24. The method of claim 1 further comprising the step of:
providing filtering capabilities with the information on the plurality of display screens.

25. The method of claim 1 further comprising the step of:
providing searching capabilities for the information associated with the plurality of display screens in the system.

26. The method of claim 1 further comprising the step of:
providing manipulating capabilities to move information on the display screen.

27. The method of claim 1 further comprising the step of:
providing reporting capabilities to hide information on the display screens.

28. The method of claim 1 further comprising the step of:
transferring information to the system via the internet.

29. The method of claim 28 further comprising the step of:
encrypting the information prior to transferring the information via the internet.

30. The method of claim 1 further comprising the step of:
transferring information to the system via a modem connection.

31. The method of claim 1 further comprising the step of:
remotely monitoring the patient in real-time.

32. The method of claim 1 further comprising the step of:
creating a prescription for the patient based on the therapy.

33. The method of claim 1 further comprising the step of:
selecting a therapy mode, a fill mode and an ordering physician for the patient to effect ordering of a prescription.

34. The method of claim 1 further comprising the step of:
importing information regarding a previous prescription before entry of a subsequent prescription.

35. The method of claim 1 further comprising the step of:
remotely receiving prescription information for the patient.

36. The method of claim 1 further comprising the step of:
remotely authorizing a prescription for the patient.

37. The method of claim 1 further comprising the step of:
digitally executing authorization for a prescription to the patient.

38. The method of claim 1 further comprising the step of:
remotely transferring a digitally authorized signature to a supply chain to effect a prescription for the patient.

39. The method of claim 1 further comprising the step of:
receiving an order for a prescription via the internet wherein the prescription is authorized by a digital signature.

40. The method of claim 1 further comprising the step of:
retrieving information via the internet regarding the patient and/or the medical professional at the supply chain.

41. The method of claim 1 further comprising the step of:
enrolling the patient at a supply chain to provide an interface between the patient and the supply chain regarding a prescription.

42. The method of claim 1 further comprising the step of:
defining care pathways for the patient wherein the care pathways relate to the stage of the disease.

43. The method of claim 42 wherein the care pathways are presented on a screen related to each of the care pathways wherein information from other screens is automatically imported to the screens appropriate to each of the care pathways.

44. The method of claim 1 wherein information in the care pathways includes lab values, medications and education as related to a specific care pathway.

45. The method of claim 1 further comprising the step of:
automatically generating a list of items requiring completion after entry of information into the system.

46. The method of claim 1 further comprising the step of:
automatically generating a list of items requiring completion during entry of information into the system.

47. The method of claim 1 further comprising the step of:
identifying a list of items particular to the patient requiring the user to advise the patient.

48. The method of claim 1 further comprising the step of:
identifying a list of items particular to the patient requiring the user to educate the patient based on the stage of the disease.

49. The method of claim 1 further comprising the step of:
generating an encounter summary of the patient based on the information entered for a specific date.

50. The method of claim 1 further comprising the step of:
generating an encounter summary of the patient based on information obtained at a patient visit.

51. The method of claim 1 further comprising the step of:
generating an encounter summary that is input into the system and automatically into the system in any of the other screens that require information related to information in the encounter summary.

52. The method of claim 1 further comprising the step of:
generating a renal disease pathway that includes information imported from the system which relates to renal disease.

53. The method of claim 52 further comprising the step of:
providing a hyperlink associated with the renal disease pathway.

54. The method of claim 52 further comprising the step of:
remotely receiving information to the renal disease pathway.

55. The method of claim 1 further comprising the step of:
generating a diabetes mellitus pathway that includes information imported from the system which relates to diagnosis and/or treatment of diabetes mellitus.

56. The method of claim 55 further comprising the step of:
entering information into the diabetes mellitus pathway relating to at least one of glucose monitoring, exercise, diet and foot care.

57. The method of claim 1 further comprising the step of:
generating a mineral metabolism pathway that includes information imported from the system which relates to diagnosis and/or treatment of bone disease.

58. The method of claim 57 further comprising the step of:
remotely receiving lab data including at least one of calcium level, phosphorus level and parathyroid level.

59. The method of claim 1 further comprising the step of:
tracking education of the patient in the system wherein information is imported from system to an education screen as the education relates to any of the plurality of stages of the diseases and/or the plurality of therapies.

60. The method of claim 59 wherein the education includes information related to at least one of time spent, type of session, location, participants and material distribution.

61. The method of claim 59 wherein the education provides tracking of at least one of pre-learning assessment and post-learning assessment.

62. The method of claim 1 further comprising the step of:
tailoring education based on an educational assessment input into the system.

63. The method of claim 62 wherein the educational assessment requires input of at least one of grade level of the patient, disease state, interests of the patient and physical deficiencies of the patient.

64. The method of claim 62 wherein the educational assessment requires input of at least one of hobbies, interests, social and religious information about the patient.

65. The method of claim 1 further comprising the step of:
evaluating eligibility of the patient for one of the plurality of therapies.

66. The method of claim 1 further comprising the step of:
providing a display screen to assist the user regarding modality eligibility of the patient.

67. The method of claim 65 wherein the plurality of therapies include peritoneal dialysis, hemodialysis and transplantation.

68. The method of claim 1 further comprising the step of:
evaluating modality eligibility of the patient from at least one of a medical perspective and a psychosocial perspective.

69. The method of claim 1 further comprising the step of:
monitoring the patient to identify whether the patient is eligible for one of the plurality of therapies.

70. The method of claim 1 further comprising the step of:
identifying a discrepancy between the therapy for which the patient is eligible and the therapy which the patient is undergoing.

71. The method of claim 1 further comprising the step of:
automatically identifying a bias after identifying a discrepancy in the therapy of the patient.

72. The method of claim 1 further comprising the step of:
identifying access of the patient to the therapy.

73. The method of claim 1 further comprising the step of:
identifying access of the patient based on at least one of the referral date to the surgeon, when the access is placed, and when a follow-up appointment is made.

74. The method of claim 1 further comprising the step of:
tracking dialysis initiation in the system.

75. The method of claim 74 wherein the dialysis initiation is based on at least one of the type of access.

76. The method of claim 74 wherein the dialysis initiation is tracked based on whether the access is inpatient or outpatient.

77. The method of claim 1 further comprising the step of:
identifying laboratory field pathways from laboratory results imported into screens related to care pathways assignments.

78. The method of claim 77 wherein the laboratory results are remotely imported into the appropriate laboratory field pathways for patient.

79. The method of claim 1 further comprising the step of:
generating a preventative pathway for the patient identifying at least one of vaccinations and clinical screenings of the patient.

80. The method of claim 1 further comprising the step of:
generating a nutrition pathway for the patient relating to nutritional requirements for the patient as the requirements relate to one of the plurality of therapies.

81. The method of claim 1 further comprising the step of:
generating a lipid disorder pathway for the patient wherein the lipid disorder pathway includes information related to cholesterol levels of the patient.

82. The method of claim 1 further comprising the step of:
generating a hypertension pathway for the patient wherein the hypertension pathway includes information related to hypertension characteristics of the patient.

83. The method of claim 1 further comprising the step of:
generating an anemia pathway with information imported from the system related to diagnosis and/or treatment of anemia.

84. The method of claim 83 further comprising the step of:
importing information from a laboratory wherein the information includes at least one of hematology, iron studies and medication used to treat anemia.

85. The method of claim 1 wherein the system receives input regarding a plurality of patients.

86. The method of claim 1 wherein the system receives input regarding a plurality of healthcare providers.

87. The method of claim 1 wherein the system receives input regarding a plurality of healthcare centers.

88. The method of claim 1 further comprising the step of:
transferring the information from the system to an authorized user.

89. The method of claim 1 further comprising the step of:
providing access to the information from the system by an authorized user.

90. The method of claim 1 further comprising the step of:
providing remote access to the information from the system.

91. The method of claim 1 further comprising the step of:
remotely identifying device connectivity for components of the system.

92. The method of claim 1 further comprising the step of:
providing remote diagnosis to a machine connected to the system.

93. The method of claim 1 further comprising the step of:
standardizing codes between the types of therapies.

94. The method of claim 1 further comprising the step of:
transferring the patient from the system based on at least one of the type of therapy and the stage of the disease.

95. The method of claim 1 further comprising the step of:
categorizing the laboratory results to identify routine laboratory tests and comparison of laboratory results.

96. An integrated system for providing information related to a patient having renal disease wherein the information is accessible by a user and further wherein the information is used to evaluate the patient, the system comprising:
input means for receiving the information about the patient and a clinical history of events related to the renal disease of the patient wherein the information is accessible by the user to evaluate the patient; and
disease modality means for identifying types of therapy available to the patient for treating the disease.

97. The integrated system of claim 96 wherein the input means receives information about the user.

98. The integrated system of claim 96 wherein the input means receives information about a center that treats the patient.

99. The integrated system of claim 96 wherein information regarding a plurality of patients is input.

100. The integrated system of claim 96 wherein the information regarding the patient is received from a remote location.

101. The integrated system of claim 96 further comprising:
an output device for displaying a screen with the information.

102. The integrated system of claim 96 wherein the information is received via the internet.

103. The integrated system of claim 96 wherein the information is encrypted.

104. The integrated system of claim 96 wherein the information is transmitted via a wireless device.

105. The integrated system of claim 96 wherein the information is transmitted from a machine located remotely from the input means.

106. The integrated system of claim 101 wherein the information on the screen is manipulated to a desired format by the user.

107. The integrated system of claim 101 further comprising:
multiple screens for display on the output device.

108. The integrated system of claim 107 wherein information from the multiple screens is automatically imported.

109. The integrated system of claim 96 further comprising:
an interface receiving the information from the input means to link the information to a supply chain.

110. The integrated system of claim 109 wherein the supply chain is a prescription fulfillment center.

111. The integrated system of claim 109 further comprising:
a laboratory for transmitting results from a remote location via the interface.

112. The integrated system of claim 96 wherein the types of therapy include at least one of hemodialysis, peritoneal dialysis and transplantation.

113. The integrated system of claim 96 further comprising:
an output means having a screen defining a care pathway wherein the care pathway relates to evaluation of the disease.

114. The integrated system of claim 96 further comprising:
output means having screens unique to each one of a plurality of care pathways wherein the care pathways relate to conditions to evaluate the disease.

115. The integrated system of claim 114 wherein the plurality of care pathways include at least one of renal disease, educational assessment, transplant workup, hypertension, CKD education and dialysis initiation.

116. The integrated system of claim 114 wherein the plurality of care pathways include at least one of lipid disorders, diabetes mellitus, modality, planning, nutrition and mineral metabolism.

117. The integrated system of claim 96 further comprising:
output means having screens to summarize a plurality of events at a clinical encounter.

118. The integrated system of claim 117 wherein the events include at least one of renal disease history, medications and allergies.

119. The integrated system of claim 96 further comprising:
a medication dictionary associated with the input means to automatically create a medication.

120. The integrated system of claim 96 further comprising:
list generating means to identify incomplete items requiring attention by the user.

121. A renal disease tracking system for patients undergoing treatment for renal disease and for users administering treatment to the patients, the system comprising:
information display means including information relating to the patients and to the users wherein the information is displayed on a plurality of screens; and
means for inputting additional information related to the types of treatment for the patients wherein the patients are tracked through stages of care for the renal disease.

122. The renal disease tracking system of claim 121 further comprising:
a clinical encounter screen associated with the information display means wherein the clinical encounter screen receives information input by the user about the patient.

123. The renal disease tracking system of claim 121 further comprising:
care pathway screens associated with the information display screen wherein the care pathway screens include information about the patients pertaining to chronic kidney disease.

124. The renal disease tracking system of claim 121 wherein one of the care pathway screens tracks information related to renal disease.

125. The renal disease tracking system of claim 121 wherein one of the care pathway screens tracks information related to hypertension.

126. The renal disease tracking system of claim 121 wherein one of the care pathway screens tracks information related to anemia.

127. The renal disease tracking system of claim 121 wherein one of the care pathway screens provides information related to chronic kidney disease education.

128. The renal disease tracking system of claim 121 wherein one of the care pathway screens provides information related to educated assessments.

129. The renal disease tracking system of claim 121 wherein one of the care pathway screens provides information related to dialysis initiation.

130. The renal disease tracking system of claim 121 wherein one of the care pathway screens provides information related to transplants.

131. The renal disease tracking system of claim 121 wherein one of the care pathway screens tracks information related to lipid disorders.

132. The renal disease tracking system of claim 121 wherein one of the care pathway screens tracks information related to diabetes mellitus.

133. The renal disease tracking system of claim 121 wherein one of the care pathway screens tracks information related to nutrition.

134. The renal disease tracking system of claim 121 wherein one of the care pathway screens tracks information related to mineral metabolism.

135. The renal disease tracking system of claim 121 wherein one of the care pathway screens provides information related to modality planning.

136. The renal disease tracking system of claim 121 wherein one of the care pathway screens provides information related to hospitalization.

137. The renal disease tracking system of claim 121 further comprising:
an interface for receiving and transmitting information and importing information into the plurality of screens.

138. The renal disease tracking system of claim 137 further comprising:
a supply chain connected to the interface.

139. The renal disease tracking system of claim 137 further comprising:
a prescription fulfillment means in communication with the interface to electronically receive a prescription order remote from the system.

140. The renal disease tracking system of claim 137 further comprising:
laboratory results input through the interface into the system.

141. The renal disease tracking system of claim 137 further comprising:
a machine remote from the system that transmits information via the interface to the system.

142. The renal disease tracking system of claim 141 wherein the machine is a home hemodialysis machine.

143. The renal disease tracking system of claim 137 wherein information is transferred to the system via the interface over the internet.

144. The renal disease tracking system of claim 137 wherein information is wirelessly transmitted to the system via the interface.

145. The renal disease tracking system of claim 121 wherein the plurality of screens include a screen to effect patient transfer.

146. The renal disease tracking system of claim 121 wherein the plurality of screens include a screen to effect physician transfer.

147. The renal disease tracking system of claim 121 wherein the plurality of screens include a screen to define a care team for the patient.

148. The renal disease tracking system of claim 121 wherein information from the plurality of screens is automatically imported between the screens without requiring separate entry.

149. The renal disease tracking system of claim 121 wherein the plurality of screens include a screen that initiates an automatically generated to-do list.

150. The renal disease tracking system of claim 121 wherein the plurality of screens includes an entry screen identifying access to components of the system.

151. The renal disease tracking system of claim 121 further comprising:
diagnosis codes for import to the screens for each of the stages of care for the renal disease.

152. The renal disease tracking system of claim 121 further comprising:
multiple centers providing care to the patients wherein the multiple centers are provided access to the information display means and the means for inputting.

153. The renal disease tracking system of claim 121 wherein the users have customized viewing and access rights to the system.
